(19) United States
(12) Patent Application Publication
(10) Pub. No.: US 2024/0399937 A1
(43) Pub. Date: Dec. 5, 2024

(54) VEHICLE SEAT

(71) Applicant: TS TECH CO., LTD., Asaka-shi, Saitama (JP)

(72) Inventors: Jinichi TANABE, Shioya-gun, Tochigi (JP); Takuya OZAKI, Shioya-gun, Tochigi (JP); Akira MIYOSHI, Shioya-gun, Tochigi (JP)

(21) Appl. No.: 18/702,116

(22) PCT Filed: Nov. 9, 2022
(86) PCT No.: PCT/JP2022/041649

§ 371 Date: Apr. 17, 2024

Related U.S. Application Data
(60) Provisional application No. 63/289,311, filed on Dec. 14, 2021.

(30) Foreign Application Priority Data
Mar. 10, 2022 (JP) 2022-036753
Mar. 10, 2022 (JP) 2022-036762
Mar. 14, 2022 (JP) 2022-038839
Mar. 21, 2022 (JP) 2022-044789
Nov. 2, 2022 (JP) 2022-176262

(51) Int. Cl. B60N 2/02; B60N 2/12

(52) U.S. Cl. CPC B60N 2/0276; B60N 2/0268; B60N 2/0278; B60N 2/12

(57) ABSTRACT

The vehicle seat includes a seat main body, a drive device for moving the seat main body, a sensor provided in the seat main body to detect approach and contact of an object, and a controller for stopping a movement of the seat main body caused by the drive device when approach or contact of an object is detected by the sensor. Thereby, the need for an occupant to confirm the presence of an object is eliminated when moving a seat main body of the vehicle seat.

### TECHNICAL FIELD

The present invention relates to a vehicle seat.

### BACKGROUND ART

Patent Document 1 discloses a vehicle seat which is configured to automatically move the seat back into a rearwardly tilted position so that the occupant can be relaxed.

### PRIOR ART DOCUMENT(S)

### Patent Document(s)

Patent Document 1: JP2020-131914A

### SUMMARY OF THE INVENTION

### Task to be Accomplished by the Invention

However, when an obstacle exists behind the vehicle seat, the user is required to determine if the vehicle seat could be moved or not.

In view of the above background, an object of the present invention is to provide a vehicle seat which eliminates the need for an occupant to confirm the presence of an object when moving a seat main body of the vehicle seat.

### Means to Accomplish the Task

In order to accomplish the above-mentioned task, the present invention provides a vehicle seat (2) comprising a seat main body (3), a drive device (6a) for moving the seat main body, a sensor (7a) provided in the seat main body to detect approach and contact of an object, and a controller (9) for stopping a movement of the seat main body caused by the drive device when approach or contact of an object is detected by the sensor.

According to this aspect of the vehicle seat, it is possible to eliminate the need for the occupant to confirm the presence of an object when moving the seat main body.

In this aspect of the present invention, preferably, the controller controls the drive device in such a manner that when the sensor detects that a distance to the object has come to be a predetermined first distance while the drive device is moving the seat main body, the controller reduces a moving speed of the seat main body caused by the drive device, and stops a movement of the seat main body when the sensor has detected that the distance to the object has come to be a second distance smaller than the first distance.

According to this aspect, the seat main body can be stopped before the object contacts the seat main body.

In this aspect of the present invention, preferably, the controller is configured to reduce a moving speed of the seat main body by the drive device when the sensor detects an approach of an object thereto while the drive device is moving the seat main body and stops a movement of the seat main body by the drive device when the sensor detects contact of the object thereto.

According to this aspect, the movement of the seat main body can be continued until the seat main body comes into contact with the object.

In this aspect of the present invention, preferably, the seat main body includes a skin (16) exposed to outside and having a detection light hole (16a) formed in a part thereof, and the sensor is provided on a back side of the skin so that the sensor emits detection light via the detection light hole and receives the detection light that is reflected by the object and has come back via the detection light hole to detect approach of the object.

According to this aspect, even though the proximity detection unit is provided on the back side of the skin, approach of an object can be detected in a reliable manner.

In this aspect of the present invention, preferably, the seat main body includes a skin (16) exposed to outside, and the sensor is positioned behind the skin so as to emit detection radio wave to the outside of the skin through the skin and receive the detection radio wave reflected by the object and coming back via the skin to detect approach of the object.

According to this aspect, the approach of an object can be detected without requiring a hole in the skin for the radio wave to pass through.

In this aspect of the present invention, preferably, the sensor includes a plurality of proximity detection units (17a) arranged in a row each configured to detect approach of an object, and a plurality of contact detection units (17b) provided integrally with the corresponding proximity detection units to detect contact of an object.

According to this aspect, each sensor is able to detect the approach and contact of the object over a wide range.

In this aspect of the present invention, preferably, the sensor includes a plurality of proximity detection units (17a) arranged in a single row each configured to detect approach of an object and a contact detection unit (17b) retaining the proximity detection units together and configured to detect contact of an object.

According to this aspect, the number of sensor assemblies can be reduced while widening the detection range of an object that is approaching or coming into contact.

In this aspect of the present invention, preferably, the seat main body includes a seat cushion (10), a seat back (11) provided pivotably in a rear part of the seat cushion and a headrest (12) provided at an upper part of the seat back, and the drive device (6a) is configured to move the seat cushion in a fore and aft direction while the sensor (7j) is provided in at least one of a lower part of the seat cushion, a rear end part of the seat cushion, and a rear part of the seat back, the controller being configured to stop a rearward movement of the seat cushion caused by the drive device when approach or contact of an object is detected by the sensor.

According to this aspect, in the vehicle seat, the need for the occupant to check an object behind the seat may be eliminated when moving the seat main body rearward.

In this aspect of the present invention, preferably, the seat main body includes a seat cushion (10), a seat back (11) provided pivotably in a rear part of the seat cushion and a headrest (12) provided at an upper part of the seat back, and the drive device (6c) is configured to rotate the seat cushion, the sensor (7b) is provided in at least one of a corner of the seat cushion, a side of the seat cushion and a shoulder part of the seat back, and the controller is configured to stop a rotational movement of the seat cushion caused by the drive device when approach or contact of an object is detected by the sensor.

According to this aspect, in the vehicle seat, the need for the occupant to check an object may be eliminated when rotating the seat main body.

In this aspect of the present invention, preferably, the seat main body includes a seat cushion (10), a seat back (11) provided pivotably in a rear part of the seat cushion and a headrest (12) provided in an upper part of the seat back, and the drive device (6b) is configured to pivot the seat back relative to the seat cushion, the sensor (7j) is provided in at least one of a lower part of the seat cushion, a rear end part of the seat cushion, a rear part of the seat back and a rear part of the headrest, and the controller is configured to stop a rearward movement of the seat back caused by the drive device when approach or contact of an object is detected by the sensor.

According to this aspect, in the vehicle seat, the need for the occupant to check an object may be eliminated when pivoting the seat back.

In this aspect of the present invention, preferably, the seat main body includes a seat cushion (10), a seat back (11) provided pivotably in a rear part of the seat cushion and a headrest (12) provided in an upper part of the seat back, and the drive device is configured to move the seat cushion laterally, the sensor (7c) is provided in at least one of a lower part of the seat cushion, a side part of the seat cushion, a side part of the seat back and a side part of the headrest, and the controller is configured to stop a lateral movement of the seat back caused by the drive device when approach or contact of an object is detected by the sensor.

According to this aspect, in the vehicle seat, the need for the occupant to check an object may be eliminated when moving the seat main body laterally.

JP2004-097654A discloses a seat with an audio output device. According to this seat, the mounting structure of the audio output device can be simplified.

However, in the seat disclosed in JP2004-097654A, the audio output device diffuses the sound inside the cabin. Therefore, the sound is transmitted even to occupants who do not need the sound. Therefore, in a vehicle, there is a task to transmit information to the occupants who need the information and not to transmit the information to the occupants who do not need the information.

In order to accomplish this task, the present invention provides a notification system for a vehicle which comprises an audio output device (112) provided in the vehicle for outputting information by sound: a direction changing device (115) for changing an output direction of the sound issuing from the audio output device; and a controller (118) for controlling the output direction of the audio output device such that the output direction of the audio output device is directed toward a selected seat when information intended for an occupant of the selected seat is to be transmitted by sound.

According to this aspect, the information can be transmitted to the occupant who needs the information, and not to the occupant who does not need the information.

In this aspect of the present invention, preferably, the controller controls the direction changing device so that when the audio output device outputs information regarding driving by sound, an audio output from the audio output device is directed to a driver's seat.

According to this aspect, information regarding driving can be reliably transmitted to the occupant seated in the driver's seat.

In this aspect of the present invention, preferably, the notification system for a vehicle further comprises a storage device (124) storing information regarding types of sound and seat identification information associated with the information regarding types of information, and the controller is configured to identify the type of information which is outputted from the audio output device according to the information stored in the storage device, determine the seat identification information associated with the identified type of information, and control the direction changing device so that the sound issued from the audio output device is directed toward the seat corresponding to the determined seat identification information.

According to this aspect, the information intended for the occupant who needs the information can be transmitted to this occupant, and not to the occupant who does not need the information in a reliable manner.

In this aspect of the present invention, preferably, the audio output device is positioned in a door (105) of the vehicle.

According to this aspect, necessary information can be reliably transmitted to the occupant near the door.

In this aspect of the present invention, preferably, the audio output device is positioned in the seat (102) of the vehicle.

According to this aspect, the information can be reliably transmitted to the occupant seated in the seat.

In this aspect of the present invention, preferably, the audio output device is positioned in a seat back (102B) of the seat.

According to this aspect, the information can be transmitted more reliably to the occupant seated in the seat.

In this aspect of the present invention, preferably, the audio output device is positioned in a headrest (102C) of the seat.

According to this aspect, the information can be transmitted more reliably to the occupant seated in the seat.

In this aspect of the present invention, preferably, the notification system further comprises an audio output wire harness (121) electrically connected to the audio output device and a direction changing wire harness (122) electrically connected to the direction changing device and bundled with the audio output wire harness (121).

According to this aspect, the work for electrically connecting the audio output device and the direction changing device to the controller can be facilitated.

To accomplish the task mentioned above, the present invention also provides a notification system for a vehicle comprising a seat (125) provided in a vehicle, a partition wall (126) surrounding the seat, a support device (127) supported by the partition wall, a plurality of audio output devices (128A, 128B) supported by the support device, a plurality of direction changing devices (129A, 129B) supported by the support device at positions on output sides of the respective audio output devices so as to change sound output directions of the audio output devices, and a controller (118) for controlling the direction changing devices so that the sound output from the audio output devices is directed to a head of an occupant seated in the seat.

According to this aspect, the audio output devices and the direction changing devices can be mounted in a stable manner while the number of necessary component parts is reduced, and a size reduction can be achieved at the same time.

In this aspect of the present invention, preferably, the notification system for a vehicle is positioned on a floor (101) of the vehicle and is provided with a direction changing device (115) for changing a transmission direction of vibration sound from the floor so that the sound transmission direction of the vibration sound from the floor is not directed to the vehicle seat.

According to this aspect, the occupant's discomfort can be reduced.

In this aspect of the present invention, preferably, the notification system for a vehicle comprises an ultrasonic output device (133A) provided on a seating surface of a seat back (104B) of a vehicle seat (104) to produce ultrasonic sound wave, a direction changing device (134A) provided on an output side of the ultrasonic output device for changing an output direction of the ultrasonic sound wave produced by the ultrasonic output device, and a controller (118) for controlling the direction changing device so as to direct the output direction of the ultrasonic sound wave produced by the ultrasonic output device to a part of a body of the occupant seated in the seat.

According to this aspect, the ultrasonic wave may be targeted to a prescribed part of the body of the occupant.

JP2022-000293A discloses a seat structure which allows virus droplet infection to be suppressed.

However, in the seat structure disclosed in JP 2022-000293A, the presence or absence of viruses cannot be determined. For this reason, it is not sufficient as a measure to prevent the occupant from being infected with the virus. Therefore, in a vehicle, there is a task to prevent the occupant from being infected with a virus.

To accomplish this task, the present invention provides a notification system for a vehicle, comprising a notification device (218, 219) for notifying information, a sensor (222A) provided in the vehicle for detecting viruses, and a controller (220) for notifying, upon detecting a virus with the notification device, information regarding detection of the virus.

According to this aspect, the occupant can be prevented from being infected with the virus in the vehicle.

In this aspect of the present invention, preferably, the sensor is provided on a steering wheel (213) of the vehicle.

According to this aspect, the occupant can be prevented from being infected with the virus in a reliable manner.

In this aspect of the present invention, preferably, the sensor is provided in an instrument panel (214) of the vehicle.

According to this aspect, the occupant can be prevented from being infected with the virus in a reliable manner.

In this aspect of the present invention, preferably, the sensor is provided in a door trim (227) of the vehicle.

According to this aspect, the occupant can be prevented from being infected with the virus in a reliable manner.

In this aspect of the present invention, preferably, the sensor is provided in a seat (202) of the vehicle.

According to this aspect, the occupant can be prevented from being infected with the virus in a reliable manner.

In this aspect of the present invention, preferably, the seat includes a seat cushion (207), a seat back (208) pivotably provided in a rear end part of the seat cushion and a headrest (209) provided in an upper part of the seat back, and the sensor is provided in the headrest.

According to this aspect, the occupant can be prevented from being infected with the virus in a reliable manner.

In this aspect of the present invention, preferably, the seat includes a skin (236) that is exposed to outside and has a virus detection hole (236A) formed in a part thereof, and the sensor is provided on a back side of the skin such that a virus that has moved from a front side to the back side of the skin through the virus detection hole may be detected.

According to this aspect, the virus can be reliably detected even if the sensor is provided on the back side of the skin.

In this aspect of the present invention, preferably, the notification system for a vehicle further comprises a duct (239) provided in the vehicle and having an inlet (239A) and an outlet (239B) and a blower (241) for creating a flow of air from the inlet to the outlet of the duct, wherein the sensor is provided inside the duct between the inlet and the outlet to detect a virus in the air flowing through the duct.

According to this aspect, viruses can be detected in a reliable manner.

In this aspect of the present invention, preferably, a filter (242) is provided inside the duct between the sensor and the outlet to trap viruses.

According to this aspect, the floating amount of viruses inside the cabin can be reduced.

In this aspect of the present invention, preferably, the sensor is detachably provided in the duct.

According to this aspect, the sensor is adapted to a kind of viruses that is currently spreading.

In this aspect of the present invention, preferably, a photocatalyst (244A) that can kill viruses is provided adjacent to the sensor.

According to this aspect, the floating amount of viruses inside the cabin can be reduced.

In this aspect of the present invention, preferably, the controller is configured to transmit information regarding virus detection to a terminal (221) located outside the vehicle.

According to this aspect, it is possible to notify a prospective vehicle user who owns the mobile terminal of the virus detection.

In this aspect of the present invention, preferably, the controller is configured to notify the mobile terminal of information regarding virus detection via a server device(S) located outside the vehicle.

According to this aspect, it is possible to identify the vehicle in which the virus has been detected.

In order to accomplish the task mentioned above, the present invention further provides a notification system for a vehicle comprising a notification device (218, 219) provided in the vehicle for notifying information, a duct (239) provided in the vehicle and having an inlet (239A) and an outlet (239B), a blower (241) provided in the duct for creating a flow of air from the inlet to the outlet thereof, a plurality of sensors (243C to 243E) configured to detect different kinds of viruses, and a controller (220) for causing the notification device to notify information on virus detection when any one of the sensors has detected a virus.

According to this aspect, various kinds of viruses can be detected.

JP2021-172729A discloses an interior material for a vehicle. This interior material demonstrates an excellent scratch resistance.

However, even the interior member disclosed in JP2021-172729A inevitably gets damaged over time when touched frequently by the occupants. Therefore, it is difficult to maintain the state of the design surface of the interior member. Thus, in a vehicle, there is a task to maintain the state of the design surface of the interior member.

In order to accomplish the task mentioned above, the present invention further provides an interior member for a vehicle, which includes a structure (325A) provided in the vehicle and having a surface at least partly formed of a self-healing resin.

According to this aspect, the state of the design surface of the interior member can be maintained.

In this aspect of the present invention, preferably, the structure has a substrate (339) made of a resin, and a coating (340) having a surface made of a self-healing resin different from the resin of the substrate and covering the surface of the substrate.

According to this aspect, the state of the design surface of the interior member can be maintained while the strength required for the interior member is afforded by the substrate.

In this aspect of the present invention, preferably, the structure is provided in a door trim (329) provided on an inboard side of a door (305) of the vehicle.

According to this aspect, the state of the design surface of the interior member at a location which is likely to be touched by the occupant can be maintained.

In this aspect of the present invention, preferably, the structure is provided around a door handle (330) in the door trim.

According to this aspect, it is possible to maintain the state of the design surface of the interior member at a location that is likely to be touched by the occupant's hand.

In this aspect of the present invention, preferably, the structure is provided around a switch (333) in the door trim.

According to this aspect, it is possible to maintain the state of the design surface of the interior member at a location that is likely to be touched by the occupant's hand.

In this aspect of the present invention, preferably, the structure is provided in a lower part of the door trim.

According to this aspect, it is possible to maintain the state of the design surface of the interior member at a location that is likely to be kicked by the occupant's feet.

In this aspect of the present invention, preferably, the structure is provided in an upper part of a door trim.

According to this aspect, it is possible to maintain the state of the design surface of the interior member at a location that is likely to be touched by the occupant's hand.

In this aspect of the present invention, preferably, the structure is provided on an ornament (331) in the door trim.

According to this aspect, it is possible to maintain the state of the design surface of the interior member at a location that is likely to be touched by the occupant's hand.

In this aspect of the present invention, preferably, the structure is provided on an armrest (332) in the door trim.

According to this aspect, it is possible to maintain the state of the design surface of the interior member at a location that is likely to be touched by the occupant's hand.

In this aspect of the present invention, preferably, the structure is provided in a door pocket (334) in the door trim.

According to this aspect, it is possible to maintain the state of the design surface of the interior member at a location that is likely to be touched by the occupant's hand.

In this aspect of the present invention, preferably, the structure is provided in an instrument panel (318) of the vehicle.

According to this aspect, it is possible to maintain the state of the design surface of the interior member at a location that is likely to be touched by the occupant's hand.

In this aspect of the present invention, preferably, the structure is provided in a steering wheel (317) of the vehicle.

According to this aspect, it is possible to maintain the state of the design surface of the interior member at a location that is likely to be touched by the occupant's hand.

In this aspect of the present invention, preferably, the structure is provided on a roof (304) of the vehicle.

According to this aspect, it is possible to maintain the state of the design surface of the interior member at a location that is likely to be touched by the occupant's hand.

In this aspect of the present invention, preferably, the structure is provided on a floor (301) of the vehicle.

According to this aspect, it is possible to maintain the state of the design surface of the interior member at the location where the occupant's feet are likely to touch.

In this aspect of the present invention, preferably, the structure is provided on a pillar (302, 303) of the vehicle.

According to this aspect, it is possible to maintain the state of the design surface of the interior member at a location that is likely to be touched by the occupant's hand.

In this aspect of the present invention, preferably, the structure is provided in a center console (319) of the vehicle.

According to this aspect, it is possible to maintain the state of the design surface of the interior member at a location that is likely to be touched by the occupant's hand.

In this aspect of the present invention, preferably, the structure is provided in a shift lever (320) of the vehicle.

According to this aspect, it is possible to maintain the state of the design surface of the interior member at a location that is likely to be touched by the occupant's hand.

In this aspect of the present invention, preferably, the structure is provided in a seat (306) of the vehicle.

According to this aspect, it is possible to maintain the state of the design surface of the interior member at a location that is likely to be touched by the occupant's hand.

In this aspect of the present invention, preferably, the structure is provided on a side cover (336) of the seat.

According to this aspect, it is possible to maintain the state of the design surface of the interior member at a location that is likely to be touched by the occupant's hand.

In this aspect of the present invention, preferably, the structure is provided on a recliner cover (337) of the seat.

According to this aspect, it is possible to maintain the state of the design surface of the interior member at a location that is likely to be touched by the occupant's hand.

JP2017-178129A discloses a vehicle seat fitted with a seat heater. The seat heater includes a heater unit, an air blower positioned so as to correspond to the heater unit, and a controller for controlling output of the heater unit and the air blower.

The pad material of the seat cushion and seat back of the vehicle seat is provided with a plurality of air holes formed on the surface thereof and air passages communicating with the air holes. The seat cushion and seat back are configured to blow air from the seat surface toward the occupant through the air holes and the skin by the operation of the blower.

JP2020-195429A discloses a seat capable of efficiently delivering fragrance to the seated occupant. The seat is provided with an air outlet and an air inlet formed in an seat upper part including the seat back and the headrest, at least one blower for creating an airflow directed from the air outlet to the air inlet in the upper part of the seat, and a fragrance emitter configured to add fragrance to the air blown out from the air outlet.

In order to provide a temperature environment that suits the seated occupant, it is conceivable to provide an air conditioner for cooling and heating for each seat. However, providing an air conditioner for each seat increases power requirements. Therefore, there is a need to develop a technology that allows cool air or warm air to be delivered to the occupant of the seat in an efficient manner. Thus, there is a task to provide a seat that allows air to be blown to the seat occupant in an efficient manner.

To accomplish this task, the present invention provides a seat (401) comprising a seat lower part (412) including a seat cushion (405), a seat upper part (411) located above the seat cushion and including a seat back (406) and a headrest (407), a pair of air holes (425, 445) provided in the upper and lower seat parts, respectively, an air pusher (419) blowing air from one of the air holes, an air puller (419) drawing air into another of the air holes, the air blowing out from the one air hole is directed to the other air hole. According to this aspect, it is possible to create a favorable airflow between the seat upper part and the seat lower part, so that the air can be blow to the seat occupant in an efficient manner.

In this aspect of the present invention, preferably, the one and the other of the air holes are opposed to each other.

According to this aspect, a favorable airflow from one of the air holes to the other can be created.

In this aspect of the present invention, preferably, at least one of the air holes is provided with a louver (463) for adjusting a direction of airflow.

According to this aspect, the direction of airflow at the air hole can be adjusted by the louver. Therefore, it is possible to favorably generate an airflow from one of the air holes to the other.

In this aspect of the present invention, preferably, the air hole provided in the seat upper part is located on an upper side part of a surface of the seat back, and the air hole provided in the seat lower part is located in a front part of an upper surface of the seat cushion.

According to this aspect, the body of the seated occupant is prevented from blocking the flow of air between the air holes.

In this aspect of the present invention, preferably, the air holes are provided on one side part of the seat upper part and another side part of the seat lower part, respectively, so that an airflow (F1-F4) crossing a central line (O) in front view is generated.

According to this aspect, since an air current that straddles the seated occupant is generated, the air can be directed to the seated occupant in a favorable manner.

In this aspect of the present invention, preferably, the air holes are provided in a pair on either side of each of the seat upper part and the seat upper part, so that diagonal airflows (F1, F2, F3, F4) are generated in front view.

According to this aspect, since two air flows are generated that straddle the seated occupant in the diagonal directions, air can be blown to the seated occupant in a favorable manner.

In this aspect of the present invention, preferably, the air hole is provided on one side of each of the seat upper par and the seat lower part, so that an airflow (F11-F14) in parallel with a central line in front view is generated.

According to this aspect, since the airflow is generated along a side of the seated occupant, it is possible to effectively blow the air to the seated occupant.

In this aspect of the present invention, preferably, a pair of air holes are provided on either side of each of the seat upper part and the seat lower part, so that airflows (F11, F12, F13, F14) parallel to the center line in front view are generated.

According to this aspect, since the air flows are generated along the left and right sides of the seated occupant, it is possible to effectively blow the air to the seated occupant.

In this aspect of the present invention, preferably, the seat lower part includes an ottoman (459).

According to this aspect, an airflow can be generated at the feet of the seat occupant.

In this aspect of the present invention, preferably, the seat further includes a fan (419) provided at each of the air holes, and a controller (450) for controlling operation of the fan such that air is blown out from and drawn into the corresponding air holes.

According to this aspect, by controlling the operation of the fan, it is possible to switch between supplying air and drawing air for each air hole.

In this aspect of the present invention, preferably, the seat further includes an air conditioning unit (455) that performs at least one of heating and cooling of the air blown from the corresponding air hole.

According to this aspect, the air blown to the seated occupant can be either warmed or cooled as desired.

In this aspect of the present invention, preferably, the air conditioning unit is provided in the seat upper part and includes a heater (421) for heating the air blown from the corresponding air hole.

According to this aspect, warm air can be blown downward from the seat upper part. Thereby, the warmed air is prevented from stagnating in the upper part of the cabin so that heating efficiency can be improved.

In this aspect of the present invention, preferably, the air conditioning unit is provided in the seat upper part and includes a cooler (441) for cooling the air blown from the corresponding air hole.

According to this aspect, cool air can be blown upward from the seat upper part. Thereby, the cooled air is prevented from stagnating in the lower part of the cabin so that heating efficiency can be improved.

In this aspect of the present invention, preferably, the seat further comprises a seat occupant sensor (470) that detects a state of a seated occupant and a controller (450) for controlling at least one of the air pusher, the air puller and the air conditioning unit according to a detection result of the seat occupant sensor.

According to this aspect, the air can be blown according to the state of the seated occupant.

In this aspect of the present invention, preferably, the seat further comprises a seat state sensor (462) that detects a state of at least one of the seat upper part and the seat lower part, and a controller (450) that controls operation of at least one of the air pusher, the air puller and the air conditioning unit according to a detection result of the seat state sensor.

According to this aspect, the air can be blown according to the state of the seat.

### Effect of the Invention

In order to accomplish the above-mentioned task, the present invention provides a vehicle seat (2) comprising a seat main body (3), a drive device (6a) for moving the seat main body, a sensor (7a) provided in the seat main body to detect approach and contact of an object, and a controller (9) for stopping a movement of the seat main body caused by the drive device when approach or contact of an object is detected by the sensor.

According to this aspect of the vehicle seat, it is possible to eliminate the need for the occupant to confirm the presence of an object when moving the seat main body.

In this aspect of the present invention, preferably, the controller controls the drive device in such a manner that when the sensor detects that a distance to the object has come to be a predetermined first distance while the drive device is moving the seat main body, the controller reduces a moving speed of the seat main body caused by the drive device, and stops a movement of the seat main body when the sensor has detected that the distance to the object has come to be a second distance smaller than the first distance.

According to this aspect, the seat main body can be stopped before the object contacts the seat main body.

In this aspect of the present invention, preferably, the controller is configured to reduce a moving speed of the seat main body by the drive device when the sensor detects an approach of an object thereto while the drive device is moving the seat main body and stops a movement of the seat main body by the drive device when the sensor detects contact of the object thereto.

According to this aspect, the movement of the seat main body can be continued until the seat main body comes into contact with the object.

In this aspect of the present invention, preferably, the seat main body includes a skin (16) exposed to outside and having a detection light hole (16a) formed in a part thereof, and the sensor is provided on a back side of the skin so that the sensor emits detection light via the detection light hole and receives the detection light that is reflected by the object and has come back via the detection light hole to detect approach of the object.

According to this aspect, even though the proximity detection unit is provided on the back side of the skin, approach of an object can be detected in a reliable manner.

In this aspect of the present invention, preferably, the seat main body includes a skin (16) exposed to outside, and the sensor is positioned behind the skin so as to emit detection radio wave to the outside of the skin through the skin and receive the detection radio wave reflected by the object and coming back via the skin to detect approach of the object.

According to this aspect, the approach of an object can be detected without requiring a hole in the skin for the radio wave to pass through.

In this aspect of the present invention, preferably, the sensor includes a plurality of proximity detection units (17a) arranged in a row each configured to detect approach of an object, and a plurality of contact detection units (17b) provided integrally with the corresponding proximity detection units to detect contact of an object.

According to this aspect, each sensor is able to detect the approach and contact of the object over a wide range.

In this aspect of the present invention, preferably, the sensor includes a plurality of proximity detection units (17a) arranged in a single row each configured to detect approach of an object and a contact detection unit (17b) retaining the proximity detection units together and configured to detect contact of an object.

According to this aspect, the number of sensor assemblies can be reduced while widening the detection range of an object that is approaching or coming into contact.

In this aspect of the present invention, preferably, the seat main body includes a seat cushion (10), a seat back (11) provided pivotably in a rear part of the seat cushion and a headrest (12) provided at an upper part of the seat back, and the drive device (6a) is configured to move the seat cushion in a fore and aft direction while the sensor (7j) is provided in at least one of a lower part of the seat cushion, a rear end part of the seat cushion, and a rear part of the seat back, the controller being configured to stop a rearward movement of the seat cushion caused by the drive device when approach or contact of an object is detected by the sensor.

According to this aspect, in the vehicle seat, the need for the occupant to check an object behind the seat may be eliminated when moving the seat main body rearward.

In this aspect of the present invention, preferably, the seat main body includes a seat cushion (10), a seat back (11) provided pivotably in a rear part of the seat cushion and a headrest (12) provided at an upper part of the seat back, wherein the drive device (6c) is configured to rotate the seat cushion, the sensor (7b) is provided in at least one of a corner of the seat cushion, a side of the seat cushion and a shoulder part of the seat back, and the controller is configured to stop a rotational movement of the seat cushion caused by the drive device when approach or contact of an object is detected by the sensor.

According to this aspect, in the vehicle seat, the need for the occupant to check an object may be eliminated when rotating the seat main body.

In this aspect of the present invention, preferably, the seat main body includes a seat cushion (10), a seat back (11) provided pivotably in a rear part of the seat cushion and a headrest (12) provided in an upper part of the seat back, and the drive device (6b) is configured to pivot the seat back relative to the seat cushion, the sensor (7j) is provided in at least one of a lower part of the seat cushion, a rear end part of the seat cushion, a rear part of the seat back and a rear part of the headrest, and the controller is configured to stop a rearward movement of the seat back caused by the drive device when approach or contact of an object is detected by the sensor.

According to this aspect, in the vehicle seat, the need for the occupant to check an object may be eliminated when pivoting the seat back.

In this aspect of the present invention, preferably, the seat main body includes a seat cushion (10), a seat back (11) provided pivotably in a rear part of the seat cushion and a headrest (12) provided in an upper part of the seat back, and the drive device is configured to move the seat cushion laterally, the sensor (7c) is provided in at least one of a lower part of the seat cushion, a side part of the seat cushion, a side part of the seat back and a side part of the headrest, and the controller is configured to stop a lateral movement of the seat back caused by the drive device when approach or contact of an object is detected by the sensor.

According to this aspect, in the vehicle seat, the need for the occupant to check an object may be eliminated when moving the seat main body laterally.

In order to accomplish this task, the present invention provides a notification system for a vehicle which comprises an audio output device (112) provided in the vehicle for outputting information by sound: a direction changing device (115) for changing an output direction of the sound issuing from the audio output device; and a controller (118) for controlling the output direction of the audio output device such that the output direction of the audio output device is directed toward a selected seat when information intended for an occupant of the selected seat is to be transmitted by sound.

According to this aspect, the information can be transmitted to the occupant who needs the information, and not to the occupant who does not need the information.

In this aspect of the present invention, preferably, the controller controls the direction changing device so that when the audio output device outputs information regarding driving by sound, an audio output from the audio output device is directed to a driver's seat.

According to this aspect, information regarding driving can be reliably transmitted to the occupant seated in the driver's seat.

In this aspect of the present invention, preferably, the notification system for a vehicle further comprises a storage device (124) storing information regarding types of sound and seat identification information associated with the information regarding types of information, and the controller is configured to identify the type of information which is outputted from the audio output device according to the information stored in the storage device, determine the seat identification information associated with the identified type of information, and control the direction changing device so that the sound issued from the audio output device is directed toward the seat corresponding to the determined seat identification information.

According to this aspect, the information intended for the occupant who needs the information can be transmitted to this occupant, and not to the occupant who does not need the information in a reliable manner.

In this aspect of the present invention, preferably, the audio output device is positioned in a door (105) of the vehicle.

According to this aspect, necessary information can be reliably transmitted to the occupant near the door.

In this aspect of the present invention, preferably, the audio output device is positioned in the seat (102) of the vehicle.

According to this aspect, the information can be reliably transmitted to the occupant seated in the seat.

In this aspect of the present invention, preferably, the audio output device is positioned in a seat back (102B) of the seat.

According to this aspect, the information can be transmitted more reliably to the occupant seated in the seat.

In this aspect of the present invention, preferably, the audio output device is positioned in a headrest (102C) of the seat.

According to this aspect, the information can be transmitted more reliably to the occupant seated in the seat.

In this aspect of the present invention, preferably, the notification system further comprises an audio output wire harness (121) electrically connected to the audio output device and a direction changing wire harness (122) electrically connected to the direction changing device and bundled with the audio output wire harness (121).

According to this aspect, the work for electrically connecting the audio output device and the direction changing device to the controller can be facilitated.

To accomplish the task mentioned above, the present invention also provides a notification system for a vehicle comprising a seat (125) provided in a vehicle, a partition wall (126) surrounding the seat, a support device (127) supported by the partition wall, a plurality of audio output devices (128A, 128B) supported by the support device, a plurality of direction changing devices (129A, 129B) supported by the support device at positions on output sides of the respective audio output devices so as to change sound output directions of the audio output devices, and a controller (118) for controlling the direction changing devices so that the sound output from the audio output devices is directed to a head of an occupant seated in the seat.

According to this aspect, the audio output devices and the direction changing devices can be mounted in a stable manner while the number of necessary component parts is reduced, and a size reduction can be achieved at the same time.

In this aspect of the present invention, preferably, the notification system for a vehicle is positioned on a floor (101) of the vehicle and is provided with a direction changing device (115) for changing a transmission direction of vibration sound from the floor so that the sound transmission direction of the vibration sound from the floor is not directed to the vehicle seat.

According to this aspect, the occupant's discomfort can be reduced.

In this aspect of the present invention, preferably, the notification system for a vehicle comprises an ultrasonic output device (133A) provided on a seating surface of a seat back (104B) of a vehicle seat (104) to produce ultrasonic sound wave, a direction changing device (134A) provided on an output side of the ultrasonic output device for changing an output direction of the ultrasonic sound wave produced by the ultrasonic output device, and a controller (118) for controlling the direction changing device so as to direct the output direction of the ultrasonic sound wave produced by the ultrasonic output device to a part of a body of the occupant seated in the seat.

According to this aspect, the ultrasonic wave may be targeted to a prescribed part of the body of the occupant.

To accomplish this task, the present invention provides a notification system for a vehicle, comprising a notification device (218, 219) for notifying information, a sensor (222A) provided in the vehicle for detecting viruses, and a controller (220) for notifying, upon detecting a virus with the notification device, information regarding detection of the virus.

According to this aspect, the occupant can be prevented from being infected with the virus in the vehicle.

In this aspect of the present invention, preferably, the sensor is provided on a steering wheel (213) of the vehicle.

According to this aspect, the occupant can be prevented from being infected with the virus in a reliable manner.

In this aspect of the present invention, preferably, the sensor is provided in an instrument panel (214) of the vehicle.

According to this aspect, the occupant can be prevented from being infected with the virus in a reliable manner.

In this aspect of the present invention, preferably, the sensor is provided in a door trim (227) of the vehicle.

According to this aspect, the occupant can be prevented from being infected with the virus in a reliable manner.

In this aspect of the present invention, preferably, the sensor is provided in a seat (202) of the vehicle.

According to this aspect, the occupant can be prevented from being infected with the virus in a reliable manner.

In this aspect of the present invention, preferably, the seat includes a seat cushion (207), a seat back (208) pivotably provided in a rear end part of the seat cushion and a headrest (209) provided in an upper part of the seat back, and the sensor is provided in the headrest.

According to this aspect, the occupant can be prevented from being infected with the virus in a reliable manner.

In this aspect of the present invention, preferably, the seat includes a skin (236) that is exposed to outside and has a virus detection hole (236A) formed in a part thereof, and the sensor is provided on a back side of the skin such that a virus that has moved from a front side to the back side of the skin through the virus detection hole may be detected.

According to this aspect, the virus can be reliably detected even if the sensor is provided on the back side of the skin.

In this aspect of the present invention, preferably, the notification system for a vehicle further comprises a duct (239) provided in the vehicle and having an inlet (239A) and an outlet (239B) and a blower (241) for creating a flow of air from the inlet to the outlet of the duct, wherein the sensor is provided inside the duct between the inlet and the outlet to detect a virus in the air flowing through the duct.

According to this aspect, viruses can be detected in a reliable manner.

In this aspect of the present invention, preferably, a filter (242) is provided inside the duct between the sensor and the outlet to trap viruses.

According to this aspect, the floating amount of viruses inside the cabin can be reduced.

In this aspect of the present invention, preferably, the sensor is detachably provided in the duct.

According to this aspect, the sensor is adapted to a kind of viruses that is currently spreading.

In this aspect of the present invention, preferably, a photocatalyst (244A) that can kill viruses is provided adjacent to the sensor.

According to this aspect, the floating amount of viruses inside the cabin can be reduced.

In this aspect of the present invention, preferably, the controller is configured to transmit information regarding virus detection to a terminal (221) located outside the vehicle.

According to this aspect, it is possible to notify a prospective vehicle user who owns the mobile terminal of the virus detection.

In this aspect of the present invention, preferably, the controller is configured to notify the mobile terminal of information regarding virus detection via a server device(S) located outside the vehicle.

According to this aspect, it is possible to identify the vehicle in which the virus has been detected.

In order to accomplish the task mentioned above, the present invention further provides a notification system for a vehicle comprising a notification device (218, 219) provided in the vehicle for notifying information, a duct (239) provided in the vehicle and having an inlet (239A) and an outlet (239B), a blower (241) provided in the duct for creating a flow of air from the inlet to the outlet thereof, a plurality of sensors (243C to 243E) configured to detect different kinds of viruses, and a controller (220) for causing the notification device to notify information on virus detection when any one of the sensors has detected a virus.

According to this aspect, various kinds of viruses can be detected.

In order to accomplish the task mentioned above, the present invention further provides an interior member for a vehicle, which includes a structure (325A) provided in the vehicle and having a surface at least partly formed of a self-healing resin. According to this aspect, the state of the design surface of the interior member can be maintained.

In this aspect of the present invention, preferably, the structure has a substrate (339) made of a resin, and a coating (340) having a surface made of a self-healing resin different from the resin of the substrate and covering the surface of the substrate.

According to this aspect, the state of the design surface of the interior member can be maintained while the strength required for the interior member is afforded by the substrate.

In this aspect of the present invention, preferably, the structure is provided in a door trim (329) provided on an inboard side of a door (305) of the vehicle.

According to this aspect, the state of the design surface of the interior member at a location which is likely to be touched by the occupant can be maintained.

In this aspect of the present invention, preferably, the structure is provided around a door handle (330) in the door trim.

According to this aspect, it is possible to maintain the state of the design surface of the interior member at a location that is likely to be touched by the occupant's hand.

In this aspect of the present invention, preferably, the structure is provided around a switch (333) in the door trim.

According to this aspect, it is possible to maintain the state of the design surface of the interior member at a location that is likely to be touched by the occupant's hand.

In this aspect of the present invention, preferably, the structure is provided in a lower part of the door trim.

According to this aspect, it is possible to maintain the state of the design surface of the interior member at a location that is likely to be kicked by the occupant's feet.

In this aspect of the present invention, preferably, the structure is provided in an upper part of a door trim.

According to this aspect, it is possible to maintain the state of the design surface of the interior member at a location that is likely to be touched by the occupant's hand.

In this aspect of the present invention, preferably, the structure is provided on an ornament (331) in the door trim.

According to this aspect, it is possible to maintain the state of the design surface of the interior member at a location that is likely to be touched by the occupant's hand.

In this aspect of the present invention, preferably, the structure is provided on an armrest (332) in the door trim.

According to this aspect, it is possible to maintain the state of the design surface of the interior member at a location that is likely to be touched by the occupant's hand.

In this aspect of the present invention, preferably, the structure is provided in a door pocket (334) in the door trim.

According to this aspect, it is possible to maintain the state of the design surface of the interior member at a location that is likely to be touched by the occupant's hand.

In this aspect of the present invention, preferably, the structure is provided in an instrument panel (318) of the vehicle.

According to this aspect, it is possible to maintain the state of the design surface of the interior member at a location that is likely to be touched by the occupant's hand.

In this aspect of the present invention, preferably, the structure is provided in a steering wheel (317) of the vehicle.

According to this aspect, it is possible to maintain the state of the design surface of the interior member at a location that is likely to be touched by the occupant's hand.

In this aspect of the present invention, preferably, the structure is provided on a roof (304) of the vehicle.

According to this aspect, it is possible to maintain the state of the design surface of the interior member at a location that is likely to be touched by the occupant's hand.

In this aspect of the present invention, preferably, the structure is provided on a floor (301) of the vehicle.

According to this aspect, it is possible to maintain the state of the design surface of the interior member at the location where the occupant's feet are likely to touch.

In this aspect of the present invention, preferably, the structure is provided on a pillar (302, 303) of the vehicle.

According to this aspect, it is possible to maintain the state of the design surface of the interior member at a location that is likely to be touched by the occupant's hand.

In this aspect of the present invention, preferably, the structure is provided in a center console (319) of the vehicle.

According to this aspect, it is possible to maintain the state of the design surface of the interior member at a location that is likely to be touched by the occupant's hand.

In this aspect of the present invention, preferably, the structure is provided in a shift lever (320) of the vehicle.

According to this aspect, it is possible to maintain the state of the design surface of the interior member at a location that is likely to be touched by the occupant's hand.

In this aspect of the present invention, preferably, the structure is provided in a seat (306) of the vehicle.

According to this aspect, it is possible to maintain the state of the design surface of the interior member at a location that is likely to be touched by the occupant's hand.

In this aspect of the present invention, preferably, the structure is provided on a side cover (336) of the seat.

According to this aspect, it is possible to maintain the state of the design surface of the interior member at a location that is likely to be touched by the occupant's hand.

In this aspect of the present invention, preferably, the structure is provided on a recliner cover (337) of the seat.

According to this aspect, it is possible to maintain the state of the design surface of the interior member at a location that is likely to be touched by the occupant's hand.

To accomplish this task, the present invention provides a seat (401) comprising a seat lower part (412) including a seat cushion (405), a seat upper part (411) located above the seat cushion and including a seat back (406) and a headrest (407), a pair of air holes (425, 445) provided in the upper and lower seat parts, respectively, an air pusher (419) blowing air from one of the air holes, an air puller (419) drawing air into another of the air holes, the air blowing out from the one air hole is directed to the other air hole. According to this aspect, it is possible to create a favorable airflow between the seat upper part and the seat lower part, so that the air can be blow to the seat occupant in an efficient manner.

In this aspect of the present invention, preferably, the one and the other of the air holes are opposed to each other.

According to this aspect, a favorable airflow from one of the air holes to the other can be created.

In this aspect of the present invention, preferably, at least one of the air holes is provided with a louver (463) for adjusting a direction of airflow.

According to this aspect, the direction of airflow at the air hole can be adjusted by the louver. Therefore, it is possible to favorably generate an airflow from one of the air holes to the other.

In this aspect of the present invention, preferably, the air hole provided in the seat upper part is located on an upper side part of a surface of the seat back, and the air hole provided in the seat lower part is located in a front part of an upper surface of the seat cushion.

According to this aspect, the body of the seated occupant is prevented from blocking the flow of air between the air holes.

In this aspect of the present invention, preferably, the air holes are provided on one side part of the seat upper part and another side part of the seat lower part, respectively, so that an airflow (F1-F4) crossing a central line (O) in front view is generated.

According to this aspect, since an air current that straddles the seated occupant is generated, the air can be directed to the seated occupant in a favorable manner.

In this aspect of the present invention, preferably, the air holes are provided in a pair on either side of each of the seat upper part and the seat upper part, so that diagonal airflows (F1, F2, F3, F4) are generated in front view.

According to this aspect, since two air flows are generated that straddle the seated occupant in the diagonal directions, air can be blown to the seated occupant in a favorable manner.

In this aspect of the present invention, preferably, the air hole is provided on one side of each of the seat upper par and the seat lower part, so that an airflow (F11-F14) in parallel with a central line in front view is generated.

According to this aspect, since the airflow is generated along a side of the seated occupant, it is possible to effectively blow the air to the seated occupant.

In this aspect of the present invention, preferably, a pair of air holes are provided on either side of each of the seat upper part and the seat lower part, so that airflows (F11, F12, F13, F14) parallel to the center line in front view are generated.

According to this aspect, since the air flows are generated along the left and right sides of the seated occupant, it is possible to effectively blow the air to the seated occupant.

In this aspect of the present invention, preferably, the seat lower part includes an ottoman (459).

According to this aspect, an airflow can be generated at the feet of the seat occupant.

In this aspect of the present invention, preferably, the seat further includes a fan (419) provided at each of the air holes, and a controller (450) for controlling operation of the fan such that air is blown out from and drawn into the corresponding air holes.

According to this aspect, by controlling the operation of the fan, it is possible to switch between supplying air and drawing air for each air hole.

In this aspect of the present invention, preferably, the seat further includes an air conditioning unit (455) that performs at least one of heating and cooling of the air blown from the corresponding air hole.

According to this aspect, the air blown to the seated occupant can be either warmed or cooled as desired.

In this aspect of the present invention, preferably, the air conditioning unit is provided in the seat upper part and includes a heater (421) for heating the air blown from the corresponding air hole.

According to this aspect, warm air can be blown downward from the seat upper part. Thereby, the warmed air is prevented from stagnating in the upper part of the cabin so that heating efficiency can be improved.

In this aspect of the present invention, preferably, the air conditioning unit is provided in the seat upper part and includes a cooler (441) for cooling the air blown from the corresponding air hole.

According to this aspect, cool air can be blown upward from the seat upper part. Thereby, the cooled air is prevented from stagnating in the lower part of the cabin so that heating efficiency can be improved.

In this aspect of the present invention, preferably, the seat further comprises a seat occupant sensor (470) that detects a state of a seated occupant and a controller (450) for controlling at least one of the air pusher, the air puller and the air conditioning unit according to a detection result of the seat occupant sensor.

According to this aspect, the air can be blown according to the state of the seated occupant.

In this aspect of the present invention, preferably, the seat further comprises a seat state sensor (462) that detects a state of at least one of the seat upper part and the seat lower part, and a controller (450) that controls operation of at least one of the air pusher, the air puller and the air conditioning unit according to a detection result of the seat state sensor.

According to this aspect, the air can be blown according to the state of the seat.

### BRIEF DESCRIPTION OF THE DRAWINGS

FIG. 1 is a perspective view of a front part of a vehicle seat according to a first embodiment of the present invention;

FIG. 2 is a perspective view of a rear part of the vehicle seat:

FIG. 3 is a longitudinal sectional view of the vehicle seat:

FIG. 4 is a cross sectional view of an example of a sensor;

FIG. 5 is a block diagram of a control object of a controller;

FIG. 6 is a cross sectional view of a first modified embodiment of the sensor;

FIG. 7 is a cross sectional view of a second modified embodiment of the sensor;

FIG. 8 is a cross sectional view of a third modified embodiment of the sensor;

FIG. 9 is a cross sectional view of a fourth modified embodiment of the sensor;

FIG. 10 is a perspective view of a cabin of a vehicle to which the vehicle notification system according to a second to a fifth embodiment of the present invention;

FIG. 11 is a longitudinal sectional view of the door;

FIG. 12 is a block diagram of the notification system;

FIG. 13 is a longitudinal section view of the seat;

FIG. 14 is a perspective view of the seat;

FIG. 15 is a longitudinal section view of an essential part of the seat;

FIG. 16 is a perspective view of the seat;

FIG. 17 is a perspective view of a cabin of a vehicle to which the vehicle notification system according to a sixth and a seventh embodiment of the present invention;

FIG. 18 is a perspective view of the door on the driver's seat side;

FIG. 19 is a perspective view of a front part of the vehicle seat;

FIG. 20 is a perspective view of a rear part of the vehicle seat;

FIG. 21 is a cross sectional view of a first example of the sensor;

FIG. 22 is a cross sectional view of a second example of the sensor;

FIG. 23 is a cross sectional view of a third example of the sensor;

FIG. 24 is a block diagram illustrating the control process of the display device and the audio output device;

FIG. 25 is a perspective view of a front part of the vehicle seat;

FIG. 26 is a cross sectional view of the headrest;

FIG. 27 is a perspective of the cabin of a vehicle to which the interior member according to an eighth embodiment of the present invention;

FIG. 28 is a front view of the door on the side of the driver's seat;

FIG. 29 is a perspective view of a front part of the seat;

FIG. 30 is a longitudinal sectional view of the structure;

FIG. 31 is a perspective view of the seat according to a ninth embodiment of the present invention;

FIG. 32 is a perspective view of the seat partly in section taken long line XXXII-XXXII of FIG. 32:

FIG. 33 is a side view of the seat according to the ninth embodiment;

FIG. 34 is a block diagram of an airflow generating unit;

FIG. 35 is a perspective view showing (A) the airflow during a cooling process and (B) the airflow during a warming process;

FIG. 36 is a front view showing (A) the airflow during a cooling process and

(B) the airflow during a warming process;

FIG. 37 is a perspective view of a modification of the seat of the ninth embodiment;

FIG. 38 is a perspective view of another modification of the seat of the ninth embodiment:

FIG. 39 is a perspective view of yet another modification of the seat of the ninth embodiment;

FIG. 40 shows modifications of the seat of the ninth embodiment (A) where a pair of air holes are provided on different sides of the seat back and seat cushion and (B) where an air hole is provided centrally in a front part of the seat cushion;

FIG. 41 shows another modification of the seat of the ninth embodiment that generates air flows in parallel with the center line of the seat are generated (A) at the time of warming and (B) at the time of cooling;

FIG. 42 is a side view of the seat according to a tenth embodiment;

FIG. 43 is a side view of the seat according to an eleventh embodiment; and

FIG. 44 shows (A) a modification of the seat of the eleventh embodiment to show the positions of the pressure sensors in perspective view and (B) an enlarged sectional view taken along line XLIVB-XLIVB of (A).

### DETAILED DESCRIPTION OF THE PREFERRED EMBODIMENT(S)

### <<Vehicle Seat>>

Embodiments of the vehicle seat according to the present invention as applied to automobile seats will be described in the following with reference to the appended drawings.

### First Embodiment

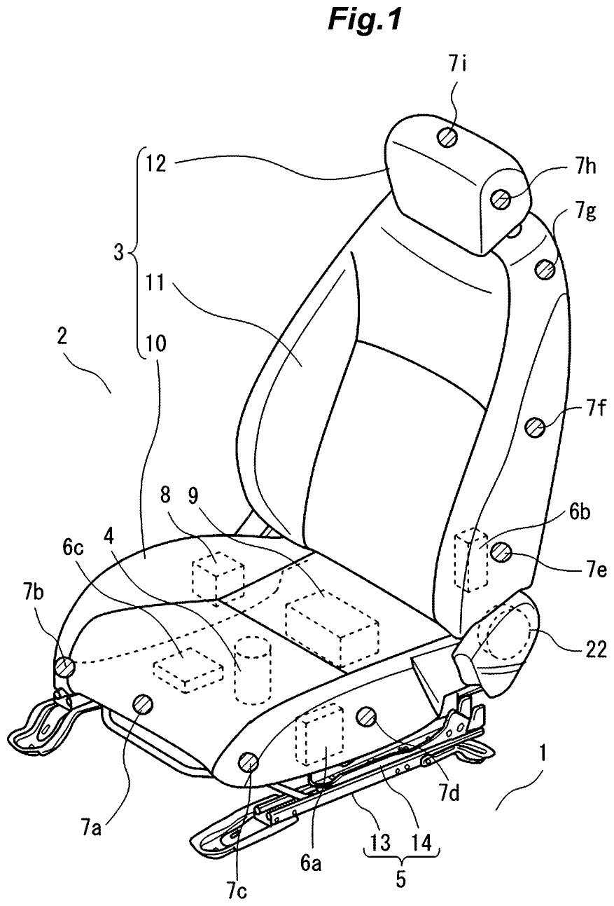

As shown in FIGS. 1 to 3, a floor 1 defines a floor surface of a vehicle. A seat 2 is provided on the floor 1. The seat 2 includes a seat main body 3, a rotation device 4, a slide device 5, a plurality of drive devices 6a-6c, a plurality of sensors 7a-7n, an operation input device 8, and a controller 9.

The seat main body 3 includes a seat cushion 10, a seat back 11 and a headrest 12. The seat cushion 10 has a seat surface. The seat back 11 is provided at the rear end part of the seat cushion 10. The headrest 12 is provided at the upper end of the seat back 11.

The slide device 5 includes a pair of lower rails 13 and a pair of upper rails 14. The lower rails 13 are placed on the floor 1 with the longitudinal directions thereof extending in the fore and aft direction of the floor 1. The upper rails 14 are provided on the lower surface of the seat cushion 10 with the longitudinal directions thereof extending in the fore and aft direction of the floor 1. The upper rails 14 are guided in the fore and aft direction by the corresponding lower rails 13.

The rotation device 4 is provided between the upper rails 14 of the slide device 5 and the seat cushion 10. The rotation device 4 supports the seat cushion 10 so as to be rotatable about the vertical axis with respect to the upper rails 14.

The seat back 11 is pivotably supported by the seat cushion 10 via a reclining device 22. The reclining device 22 can retain the seat back 11 at any desired angle with respect to the seat cushion 10.

For example, the fore and aft drive device 6a is provided under the seat cushion 10. The fore and aft drive device 6a drives the slide device 5 to move the seat cushion 10 in the longitudinal direction. The fore and aft drive device 6a is provided between the lower rails 13 and the upper rails 14 so as to move the upper rails 14 with respect to the lower rails 13. The fore and aft drive device 6a may be, for example, a ball screw mechanism driven by an electric motor. For example, the reclining drive device 6b has an electric motor and is provided on the seat back 11. The reclining drive device 6b drives the reclining device 22 so as to rotate the seat back 11 with respect to the seat cushion 10. For example, the rotation drive device 6c has an electric motor and is provided under the seat cushion 10. The rotation drive device 6c drives the rotation device 4 so as to rotate the seat cushion 10 with respect to the upper rails 14.

As shown in FIG. 1, a sensor 7a is provided in a central part of the front end of the seat cushion 10. Another sensor 7b is provided in the right corner part of the front end of the seat cushion 10. Yet another sensor 7c is provided in a left corner part of the front end of the seat cushion 10. Yet another sensor 7d is provided in a lower part of the left side of the seat cushion 10. Yet another sensor 7e is provided in a lower part of the left side surface of the seat back 11. Yet another sensor 7f is provided in a central part of the left side of the seat back 11. Yet another sensor 7g is provided on a left shoulder part of the seat back 11. Yet another sensor 7h is provided in a central part of the left side of the headrest 12. Yet another sensor 7i is provided in a central part of the top side of the headrest 12.

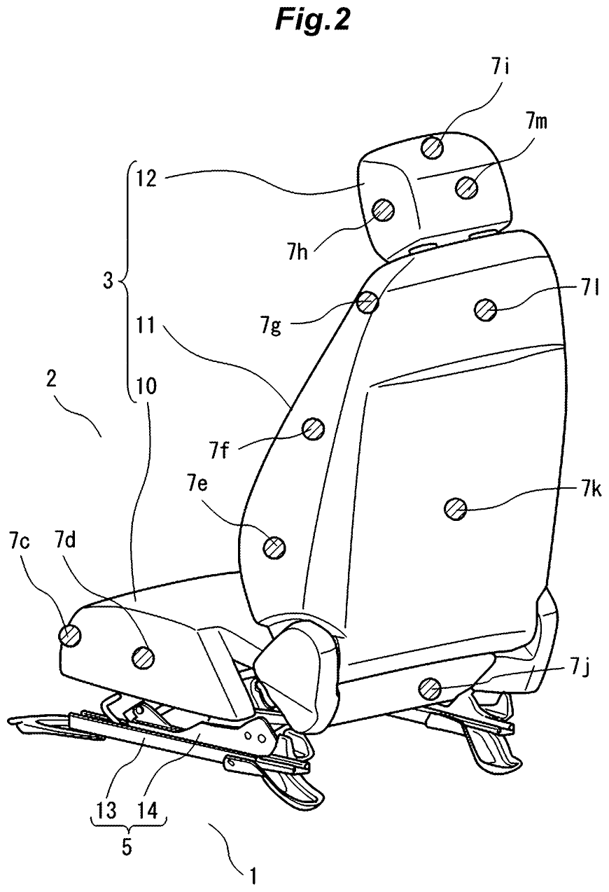

As shown in FIG. 2, yet another sensor 7j is provided in a central part of the rear end of the seat cushion 10. Yet another sensor 7k is provided in a central part of the rear side of the seat back 11. Yet another sensor 7l is provided in an upper part of the rear side of the seat back 11. Yet another sensor 7m is provided in a central part of the rear end of the headrest 12.

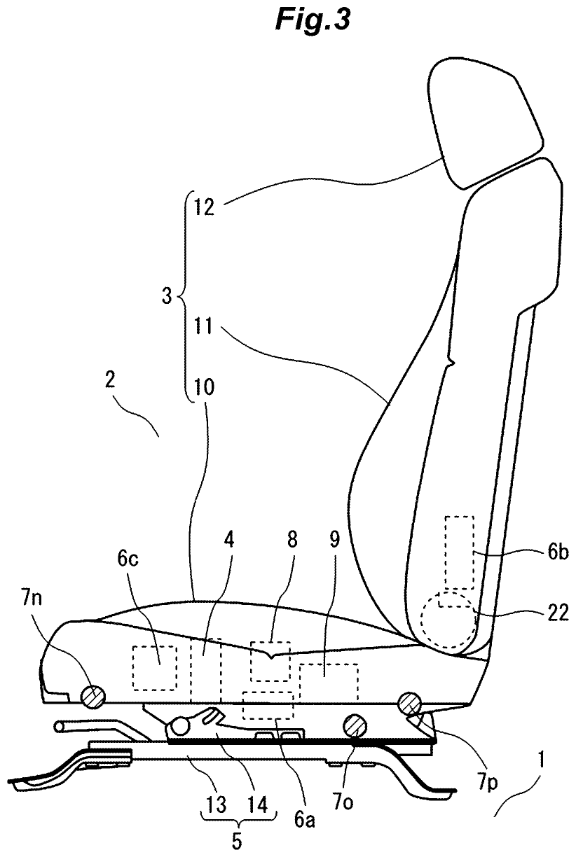

As shown in FIG. 3, yet another sensor 7n is provided in front part of the lower surface of the seat cushion 10. Yet another sensor 70 is provided in a rear part of the lower surface of the seat cushion 10. Yet another sensor 7p is provided in a rear part of the lower surface of the seat cushion 10.

As shown in FIGS. 1 to 3, the operation input device 8 is provided on the right side of the seat cushion 10.

The controller 9 is provided under the seat cushion 10. The controller 9 is electrically connected to the drive devices 6a to 6c, the sensors 7a to 7n, and the operation input device 8. The sensors 7a-7n detect the proximity and contact of an object.

For example, the occupant may operate the operation input device 8 to operate one of the drive devices 6a to 6c. As a result, the seat main body 3 starts moving in a way corresponding to the operated drive device 6a to 6c. At this time, the sensors 7a to 7p start detection operations. If one of the sensors 7a to 7p detects the approach or contact of an object such as an obstacle or another occupant while the drive device 6a to 6c is moving the seat main body 3, the controller 9 stops the movement of the seat main body 3 which is caused by the corresponding drive device 6a to 6c.

For example, when one of the drive devices 6a to 6c is moving the seat main body 3, and one of the sensors 7a to 7p detects that the distance to the object has come to be a first distance. Then, the controller 9 reduces the moving speed of the seat main body 3 by the drive device 6a to 6c. Thereafter, when the sensor 7a to 7p detects that the distance to the object has come to be a second distance shorter than the first distance, the controller 9 stops the movement of the seat main body 3 by the drive device 6a to 6c. The first distance and the second distance may be appropriately selected. For example, the first distance may be set to 100 mm, and the second distance may be set to 50 mm.

In this embodiment, the operation input device 8 is provided with switches (not shown in the drawings) corresponding to the drive devices 6a to 6c. When one of the switches of the operation input device 8 receives an operation input, the controller 9 selects the corresponding drive device 6a to 6c. Then, the controller 9 sets the drive amount per unit time for the corresponding drive device 6a to 6c based on the minimum value of the distances to the object detected by the sensors 7j to 7p, and causes the corresponding drive device 6a to 6c to be driven so as to move the seat main body 3 in a manner consistent with the operation input. At this time, the seat main body 3 moves at a movement amount per unit time (or a movement speed) corresponding to the set drive amount per unit time.

The movement here can include, for example, a translational displacement of the seat main body 3 in the fore and aft direction, a rotational displacement about an axis extending in the vertical direction, and a reclining movement of the seat back 11 with respect to the seat cushion 10. Thus, the amount of movement may include, for example, the amount of movement of the seat main body 3 in the fore and aft direction, the rotation angle, and the reclining angle. Further, when a contact is detected by one of the sensors 7j to 7p, the controller 9 determines that the distance between the seat main body 3 and the object is zero.

In this embodiment, when the minimum value of the distance to the object is greater than the first distance, the controller 9 sets the drive amount of the drive devices 6a to 6c so as to correspond to the input to the first drive amount. As a result, the seat main body 3 moves at the first moving speed. When the minimum value of the distance to the object is equal to or less than the first distance and greater than the second distance, the controller 9 sets the drive amount of the drive devices 6a to 6c so as to correspond to the input to the second drive amount. As a result, the seat main body 3 moves at the second moving speed corresponding to the second drive amount. Here, the second drive amount is set to be smaller than the first drive amount. Therefore, the second moving speed is smaller than the first moving speed. When the minimum value of the distance to the object is equal to or less than the second distance, the controller 9 sets the drive amount of the drive devices 6a to 6c corresponding to the input to a zero drive amount. As a result, the seat main body 3 is brought to a stationary state.

For example, when any one of the sensors 7a to 7p detects the approach of an object while one of the drive devices 6a to 6c is moving the seat main body 3, the controller 9 lowers the moving speed of the seat main body 3 caused by the corresponding drive device. Thereafter, when any one of the sensors 7a to 7p detects contact with the object, the controller 9 stops the movement of the seat main body 3 by the corresponding drive device.

In a first example, when one of the sensors 7j to 7p detects the approach or contact of an object while the fore and aft drive device 6a is moving the seat cushion 10 rearward, the controller 9 stops the rearward movement of the seat back 11 by the fore and aft drive device 6a. In a second example, when one of the sensors 7b to 7h detects the approaches or contact of an object while the rotation drive device 6c is rotating the seat cushion 10, the controller 9 stops the rotation of the seat cushion 10 by the rotation drive device 6c. In a third example, when a one of the sensors 7j to 7p detects the approach or contact of an object while the reclining drive device 6b is reclining the seat back 11 rearward, the controller 9 stops the rearward reclining of the seat back 11 by the reclining drive device 6b.

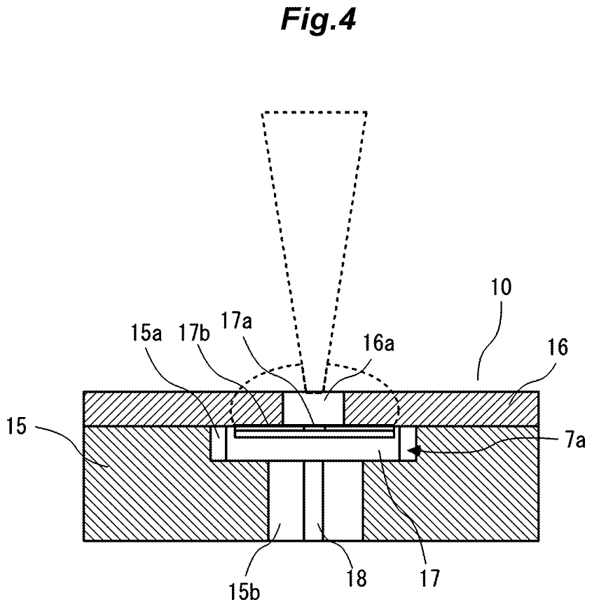

Next, a specific example of the sensor 7a will be described in the following with reference to FIG. 4. As shown in FIG. 4, the seat cushion 10 includes a pad 15 and a skin 16. The pad 15 is made of an elastic cushioning material such as polyurethane foam. The pad 15 is provided with a recess 15a and a wire harness hole 15b. The recess 15a is formed in a part of the surface of the pad 15. The wire harness hole 15b is formed so as to communicate with a bottom end of the recess 15a. The skin 16 is made of synthetic leather, cloth, or the like. The skin 16 covers the surface of the pad 15. The skin 16 is exposed to the outside. The skin 16 is provided with a detection light hole 16a. The detection light hole 16a is formed so as to penetrate a part of the skin 16. The detection light hole 16a is formed so as to communicate with the recess 15a of the pad 15.

The sensor 7a includes a sensor main body 17 and a wire harness 18. The sensor main body 17 includes a proximity detection unit 17a and a contact detection unit 17b. For example, the proximity detection unit 17a is a ToF (Time of Flight) sensor. The proximity detection unit 17a is provided in a central part of the surface of the sensor main body 17. For example, the contact detection unit 17b is a capacitance sensor. The contact detection unit 17b has an electrode which surrounds the proximity detection unit 17a on the surface of the sensor main body 17.

The sensor main body 17 is housed in the recess 15a of the pad 15 so that the detection light axis of the proximity detection unit 17a overlaps with the detection light hole 16a of the skin 16. One end of the wire harness 18 is connected to the rear surface of the sensor main body 17. The wire harness 18 is electrically connected to the proximity detection unit 17a and the contact detection unit 17b. The wire harness 18 is housed on the bottom side of the pad 15 along the wire harness hole 15b. The other end of the wire harness 18 is electrically connected to the power source of the vehicle. The wire harness 18 supplies power to the proximity detection unit 17a and the contact detection unit 17b.

The proximity detection unit 17a emits detection light such as infrared light to the outside through the detection light hole 16a of the skin 16. At this time, the proximity detection unit 17a intermittently emits pulses of detection light. The proximity detection unit 17a receives the detection light returned through the hole after the detection light is reflected by the object. The proximity detection unit 17a detects the approach of an object by measuring the distance to the object based on the time until the detection light returns. The contact detection unit 17b detects contact of an object based on changes in the capacitance thereof.

The detection range of the proximity detection unit 17a is about 300 mm in the forward direction. However, when the distance to the object is several tens of millimeters, the detection sensitivity of the proximity detection unit 17a is low. The contact detection unit 17b detects an object as being in contact when in this region. In this way, the sensor main body 17 detects objects on different principles. As a result, the reliability of object detection is improved.

Note that the other sensors 7b to 7p also have a similar configuration as the sensor 7a.

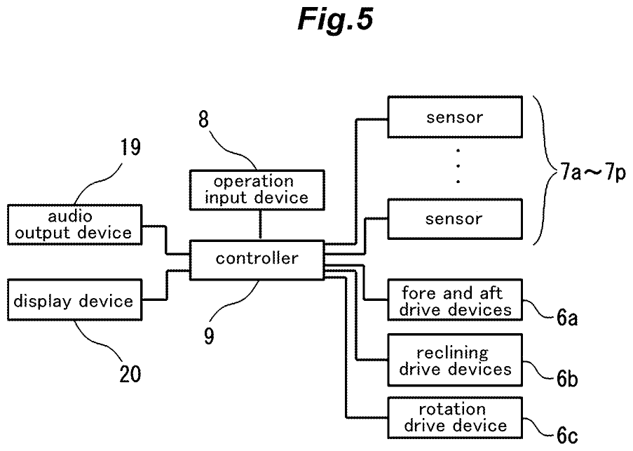

Control objects of the controller 9 will be described in the following with reference to FIG. 5. In FIG. 5, an audio output device 19 is a device that outputs audio in the cabin. For example, the audio output device 19 is a device that provides voice guidance or the like in a car navigation system. The display device 20 is a device that displays an image or the like in the cabin. For example, the display device 20 is a device that displays a map or the like in a car navigation system. The audio output device 19 and the display device 20 are electrically connected to the controller 9 directly or indirectly.

When one of the sensors 7a to 7p detects the approach or contact of an object while one of the drive devices 6a to 6c is moving the seat main body 3, the controller 9 causes the audio output device 19 or the display device 20 to notify the approach or contact of an object to the seat main body 3.

For example, when one of the sensors 7a to 7p detects that the distance to the object has reached a first distance (which is predetermined) while one of the drive devices 6a to 6c is moving the seat main body 3, the controller 9 causes the audio output device 19 or the display device 20 to notify the approach of the seat main body 3 to the object. Thereafter, when one of the sensors 7a to 7p detects that the distance to the object has reached a second distance which is shorter than the first distance, the controller 9 causes the audio output device 19 or the display device 20 to notify that the movement of the seat main body 3 has ceased.

For example, when one of the sensors 7a to 7p detects the approach of an object while one of the drive devices 6a to 6c is moving the seat main body 3, the controller 9 causes the audio output device 19 or the display device 20 to notify the approach of the seat main body 3 to the object. When one of the sensors 7a to 7p detects contact of the object, the controller 9 causes the audio output device 19 or the display device 20 to notify that the movement of the seat main body 3 has ceased.

In the first example, when one of the of sensors 7j to 7p detects the approach or contact of an object while the fore and aft drive device 6a is moving the seat cushion 10 rearward, the controller 9 causes the audio output device 19 or the display device 20 to notify the approach or contact of the object. In the second example, when one of the sensors 7b to 7h detects the approach or contact of an object while the rotation drive device 6c is rotating the seat cushion 10, the controller 9 causes the audio output device 19 or the display device 20 to the approach or contact of the object. In the third example, when one of the sensors 7j to 7p detects the approach or contact of an object while the reclining drive device 6b is reclining the seat back 11 rearward, the controller 9 causes the audio output device 19 or the display device 20 to notify the approach of the seat back 11 to the object.

According to the vehicle seat described above, when one of the sensors 7a to 7p detects the approach or contact of an object while one of the drive devices 6a to 6c moving the seat main body 3, the controller 9 stops the movement of the seat main body 3 by the corresponding drive device 6a to 6c. Therefore, in this vehicle seat, the occupant is not required to look for the object when moving the seat main body 3.

For example, when one of the sensors 7a to 7p detects that the distance to the object has reached a (predetermined) first distance while one of the drive devices 6a to 6c is moving the seat main body 3, the controller 9 reduces the moving speed of the seat main body 3 by the drive devices 6a to 6c. Then, when one of the of sensors 7a to 7p detects that the distance to the object has reached a second distance which is shorter than the first distance, the controller 9 stops the movement of the seat main body 3 by the corresponding drive device 6a to 6c. Therefore, the seat main body 3 can be stopped before the object contacts the seat main body 3.

For example, when one of the sensors 7a to 7p detects the approach of an object while one of the drive devices 6a to 6c is moving the seat main body 3, the controller 9 reduces the moving speed of the seat main body 3 caused by the corresponding drive device 6a to 6c. Thereafter, when one of the sensors 7a to 7p detects contact with an object, the controller 9 stops the movement of the seat main body 3 by the drive device. Therefore, the movement of the seat main body 3 can be continued until the seat main body 3 comes into contact with an object.

The proximity detection unit 17a emits detection light to the outside through the detection light hole 16a of the skin 16. The proximity detection unit 17a receives the detection light reflected by the object and returned via the detection light hole 16a. Therefore, even if the proximity detection unit 17a is provided on the back side of the skin 16, the approach of the object can be reliably detected.

The proximity detection unit 17a may also use ultrasonic sound. In this case, ultrasonic sound wave may be emitted to the outside through the detection light hole 16a of the skin 16. The proximity detection unit 17a may receive the ultrasonic sound wave reflected by the object and returned via the detection light hole 16a. Also in this case, even if the proximity detection unit 17a is provided on the back side of the skin 16, the approach of the object can be reliably detected.

In the first example, when one of the sensors 7j to 7p detects the approach or contact of an object while the fore and aft drive device 6a is moving the seat cushion 10 rearward, the controller 9 stops the rearward movement of the seat back 11 by the fore and aft drive device 6a. Therefore, in this vehicle seat, the occupant is not required to look for the object when moving the seat main body 3 rearward.

In the second example, when one of the sensors 7b to 7h detects the approach or contact of an object while the rotation drive device 6c is rotating the seat cushion 10, the controller 9 stops the rotation of the seat cushion 10 by the rotation drive device 6c. Therefore, in this vehicle seat, the occupant is not required to look for the object when the seat main body 3 is being rotated.

In the third example, when one of the sensors 7j to 7p detects the approach or contact of an object while the reclining drive device 6b is reclining the seat back 11 rearward, the controller 9 stops the rearward reclining of the seat back 11 by the reclining drive device 6b. Therefore, in this vehicle seat, the occupant is not required to look for the object when reclining the seat back 11.

As another specific example, when one of the sensors 7c to 7g detects the approach or contact of an object while the drive device is moving the seat cushion 10 in the lateral direction, the controller 9 stops the lateral movement of the seat cushion 10 by the drive device. The lateral movement of the seat cushion 10 may be accomplished by a device similar to the slide device 5. Therefore, in this vehicle seat also, the occupant is not required to look for the object when moving the seat main body 3 in the lateral direction.

Also, electric power may also be wirelessly supplied to the sensors 7a to 7p. In this case, the wire harness 18 will not be required.

Also, the detection states of the sensors 7a to 7p may be maintained at all times. In this case, the approach and contact of an object can be detected before the seat main body 3 starts moving. If the approach or contact of an object is detected before the movement of the seat main body 3 is started, the movement of the seat main body 3 may be prohibited from being started.

Further, even when an object suddenly comes into the object proximity detection range of the sensors 7a to 7p for outside the detection range, the contact of the object may be detected by the contact detection unit 17b, and the movement of the seat main body 3 may be promptly stopped.

Further, the controller 9 may determine if the object is moving or not based on the moving speed of the seat main body 3 and a time change in the distance to the object detected by the sensor 7a to 7p. When the object is moving, the controller 9 may stop the movement of the seat main body 3. In this case, contact between another occupant or the like and the seat main body 3 can be more reliably prevented.

For example, the controller 9 acquires the relative distance from the seat main body 3 to the object after a predetermined time based on the detection results of the sensors 7a to 7p. After that, the controller 9 sets the moving speed to zero when the minimum value of the relative distance between the seat main body 3 and the object after elapsing of a predetermined time period is equal to or less than the second distance. When the minimum value is equal to or less than the first distance and greater than the second distance, the movement speed may be set to the second speed. When the minimum value is greater than the first distance, the movement speed may be set to the first speed.

Also, a fail-safe feature may be added to the movement control of the seat main body 3. Specifically, when a failure such as wire breakage is detected in any one of the drive devices 6a to 6c or in any of the sensors 7a to 7p, the movement control of the seat main body 3 based on the detection results of the sensors 7a to 7p may be stopped. In this case, the movement of the seat main body 3 may be stopped.

Also, the sensors 7a to 7p may be provided on the surface of the skin 16. In this case, the optical surfaces of the sensors 7a to 7p can be cleaned with ease.

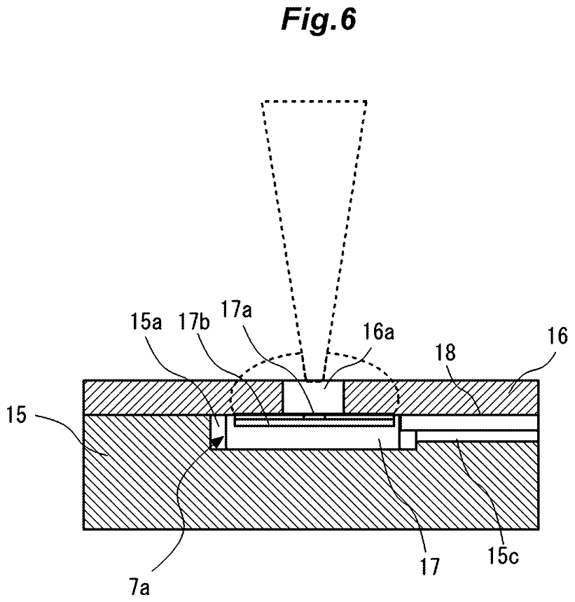

Next, a first modification of the sensor 7a will be described in the following with reference to FIG. 6. Parts corresponding to those in FIG. 4 are denoted with the same reference numerals, and description of similar parts will be simplified or omitted as appropriate in the following description. In the pad 15 shown in FIG. 6, a wire harness groove 15c is formed on the surface side of the pad 15. The wire harness groove 15c is formed so as to communicate with one side of the recess 15a. One end of the wire harness 18 is connected to a side surface of the sensor main body 17. The wire harness 18 is accommodated in and along the wire harness hole 15b on the surface side of the pad 15. It should be noted that the sensors 7b to 7p also have a similar configuration as the sensor 7a.

According to the first modification described above, the wire harness 18 is housed in and along the wire harness hole 15b on the surface side of the pad 15. Therefore, the wire harness 18 can be easily routed when mounting the sensor 7a and the like in the recess 15a of the pad 15.

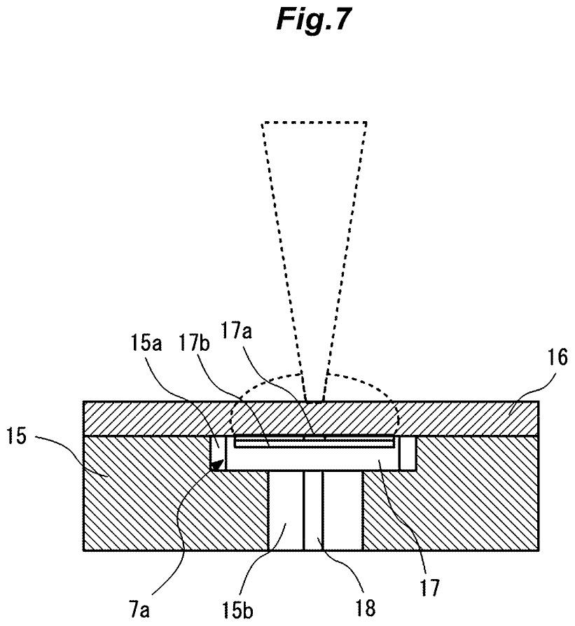

Next, a second modification of the sensor 7a will be described in the following with reference to FIG. 7. Parts corresponding to those in FIG. 4 are denoted with the same reference numerals, and description of similar parts will be simplified or omitted as appropriate in the following description. In the second modification, the sensor 7a emits detection radio wave to the outside of the skin 16 through the skin 16. The sensor 7a detects the approach of an object by receiving the detection radio wave that has been reflected by the object and returned thereto via the skin 16. Note that the other sensors 7b to 7p also have a similar configuration as the sensor 7a.

According to the second modification described above, the sensor 7a (and the others) emits detection radio wave to the outside of the skin 16 through the skin 16. The sensor 7a receives the detection radio wave that has been reflected by the object and returned thereto via the skin 16. Therefore, it is possible to detect the approach of an object without forming a detection radio wave hole (a hole for passing the detection radio wave) in the skin 16.

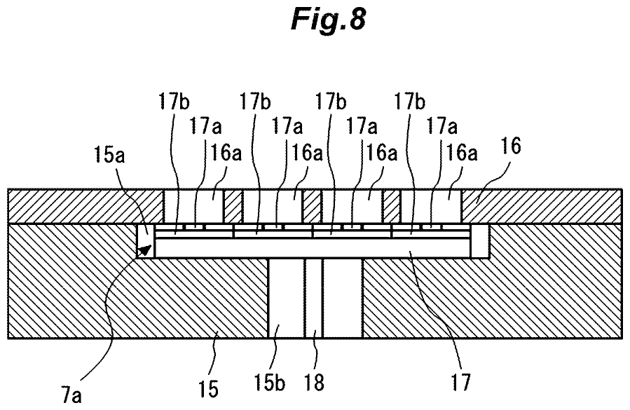

Next, a third modification of the sensor 7a will be described in the following with reference to FIG. 8. Parts corresponding to those in FIG. 4 are denoted with the same reference numerals, and description of similar parts will be simplified or omitted as appropriate in the following description. In the third modification, the detection light holes 16a are arranged in a row. The sensor main body 17 includes a plurality of proximity detection units 17a and a plurality of contact detection units 17b. The proximity detection units 17a are arranged in a row. The proximity detection units 17a are arranged so as to correspond to the detection light holes 16a, respectively. The proximity detection units 17a are each configured to detect the approach of an object. The contact detection units 17b are provided integrally with the respective proximity detection units 17a. The contact detection units 17b are each configured to detect the contact of an object. Note that the sensors 7b to 7p also have a similar configuration as the sensor 7a.

According to the third modification described above, the proximity detection units 17a are arranged in a row. The contact detection units 17b are provided integrally with the respective proximity detection units 17a. Therefore, the detection range for the approach and contact of an object can be widened.

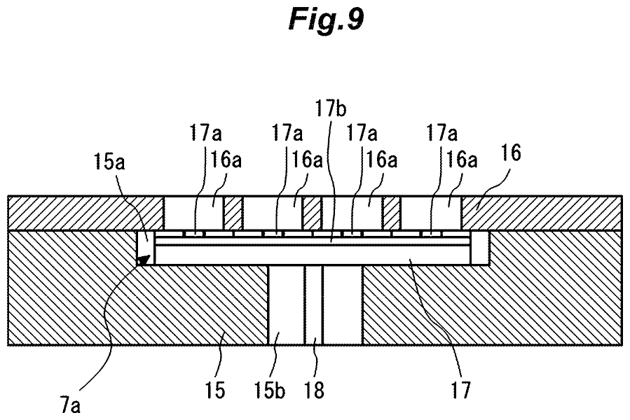

Next, a fourth modification of the sensor 7a will be described in the following with reference to FIG. 9. Parts corresponding to those in FIG. 4 are denoted with the same reference numerals, and description of similar parts will be simplified or omitted as appropriate in the following description. In the fourth modification, the sensor main body 17 includes a plurality of proximity detection units 17a and a single contact detection unit 17b. The proximity detection units 17a are arranged in a row. The proximity detection units 17a are each configured to detect the approach of an object. The contact detection unit 17b collectively retains the proximity detection units 17a. The contact detection unit 17b detects the contact of an object. Note that the other sensors 7b to 7p also have a similar configuration as the sensor 7a.

According to the fourth modification described above, the contact detection unit 17b collectively retains the proximity detection units 17a. Therefore, it is possible to reduce the number of contact detection units 17b as compared with the third modification while retaining the advantage of widening the detection range of the approach and contact of an object.

The present invention is not limited to the first embodiment and the first to fourth modifications described above, but can be modified in various ways. For example, in the third modification and the fourth modification, the proximity detection units 17a may detect an object by using detection radio wave. In this case, the approach of the object can be detected without providing detection radio wave holes.

When the seat main body 3 is provided with a seating sensor for detecting the seating of an occupant, the controller 9 may be configured to set the movement speed and movement mode of the seat main body 3 based on the detection result of the seating sensor. The seating sensor may consist of a pressure sensor having a detection surface installed on the seat cushion 10, or any other per se known sensor such as a membrane switch.

For example, when the operation input device 8 has received an operation input instructing a forward/backward movement, the controller 9 may determine the presence or absence of a seat occupant by using the seating sensor. When it is determined that there is a seated occupant, the controller 9 may set the moving speed lower than the moving speed set when there is no seated occupant when driving the fore and aft drive device 6a to move the seat main body 3 in the fore and aft direction.

The sensors 7a to 7p may be positioned in a place which tends to be affected by the seated occupant such as the front end of the seat cushion 10. In such a case, the controller 9 may detect the approach of an object to the seat main body 3 based on the detection results of the sensors 7b to 7p other than the sensor 7a located at a position susceptible to the influence of the seated occupant (the sensor 7a which is located at the front end of the seat cushion 10).

In addition, the controller 9 may change the first distance and the second distance according to the presence or absence of a seated occupant. More specifically, when the controller 9 determines that there is an occupant seated in the seat, the first distance and the second distance may be set longer than when there is no occupant seated in the seat. As a result, the seat main body 3 is decelerated and stopped at a greater distance from the object when there is a seated occupant than when there is no seated occupant. Thereby, the safety of the seat 2 is enhanced.

### <<Vehicle Notification System>

Next, an embodiment in which the vehicle notification system according to the present invention is applied to a vehicle will be described in the following with reference to the appended drawings.

### Second Embodiment

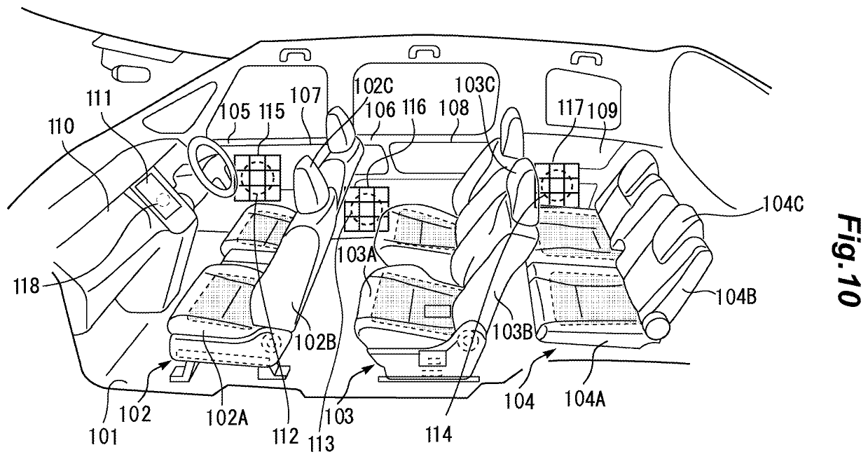

As shown in FIG. 10, in a vehicle, a floor 101 defines the floor surface of the vehicle. A pair of front seats 102 are arranged laterally next to each other in a front part of the cabin as first row seats. A pair of middle seats 103 are arranged laterally next to each other in a middle part of the cabin as second row seats. The rear seat 104 extends laterally in a rear part of the cabin as third row seats.

Each front seat 102 includes a seat cushion 102A, a seat back 102B and a headrest 102C. The seat cushion 102A is provided on the floor 101. The seat back 102B is provided at the rear end of the seat cushion 102A. The headrest 102C is provided at the upper end of the seat back 102B.

Each middle seat 103 includes a seat cushion 103A, a seat back 103B and a headrest 103C. The seat cushion 103A is provided on the floor 101. The seat back 103B is provided at the rear end of the seat cushion 103A. The headrest 103C is provided at the upper end of the seat back 103B.

The rear seat 104 includes a pair of seat cushions 104A, a pair of seat backs 104B, and a pair of headrests 104C. Each seat cushion 104A is provided on the floor 101. Each seat back 104B is provided at the rear end of the corresponding seat cushion 104A. The headrest 104C is provided at the upper end of the corresponding seat back 104B.

A front door 105 is provided on each outboard side of the front seats 102 so as to be opened and closed. A rear door 106 is provided on each outboard side of the middle seats 103 so as to be opened and closed.

A front door trim 107 is provided on the inner side of each front door 105. A rear door trim 108 is provided on the inner side of each rear door 106. A rear side trim 109 is provided on the wall surface of the cabin on each outboard side of the rear seats 104.

An instrument panel 110 is provided in front of the front seats 102. A display device 111 is provided in a laterally central part of the instrument panel 110.

A first audio output device 112 is provided in a lower part of each front door trim 107. The first audio output device 112 has the function of outputting information by audio to the interior of the cabin. A second audio output device 113 is provided in a lower part of each rear door trim 108. The second audio output device 113 has the function of outputting information by audio to the interior of the cabin. A third audio output device 114 is provided in a lower part of each rear side trim 109. The third audio output device 114 has the function of outputting information as audio to the interior of the cabin.

A first direction changing device 115 is provided adjacent to the audio output end of the first audio output device 112. The first direction changing device 115 has the function of changing the output direction of the sound issuing from the first audio output device 112. A second direction changing device 116 is provided adjacent to the audio output end of the second audio output device 113. The second direction changing device 116 has a function of changing the output direction of the sound issuing from the second audio output device 113. A third direction changing device 117 is provided adjacent to the audio output end of the third audio output device 114. The third direction changing device 117 has the function of changing the output direction of the sound issuing from the third audio output device 114.

The controller 118 is housed in the instrument panel 110 behind the display device 111. The controller 118 is configured to control the display device 111, the first audio output devices 112, the second audio output devices 113, the third audio output devices 114, the first direction changing devices 115, the second direction changing devices 116, and the third direction changing devices 117.

For example, the controller 118 is configured to control the first audio output devices 112, the second audio output devices 113, the third audio output devices 114, the first direction changing devices 115, the second direction changing devices 116 and the third direction changing devices 117 so that information for an occupant seated in a specific seat is outputted as an audio only in the direction of this particular seat.

For example, the controller 118 is configured to control the first audio output devices 112 and the first direction changing devices 115 so that the information intended for the occupants in the front row seats is outputted by audio only in the direction of the first row seats. At this time, the controller 118 does not cause the second audio output devices 113 and the third audio output devices 114 to output the information.

For example, the controller 118 is configured to control the second audio output devices 113 and the second direction changing devices 116 so that the information intended for the occupants in the second row seats is outputted by audio only in the direction of the second row seats. At this time, the controller 118 does not cause the first audio output device 112 and the third audio output device 114 to output the information.

For example, the controller 118 is configured to control the third audio output devices 114 and the third direction changing devices 117 so that the information intended for the occupants in the third row seats is outputted by audio only in the direction of the third row seats. At this time, the controller 118 does not cause the first audio output devices 112 and the second audio output devices 113 to output the information.

For example, the controller 118 is configured to control the first audio output devices 112 and the first direction changing devices 115 so that the information regarding the driving of the vehicle is directed only to the driver's seat. At this time, the controller 118 controls the first direction changing devices 115 so that the information may be directed to the headrest 102C of the right front seat 102.

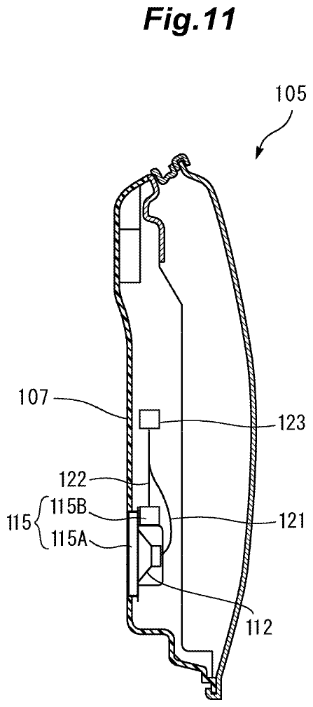

As shown in FIG. 11, each first direction changing device 115 comprises a direction changing unit 115A and a drive unit 115B. Although details are not shown, the direction changing unit 115A is provided with a plurality of sound passage holes. The drive unit 115B has the function of changing the output direction of the audio and changing the spreading of the sound emitted from the first audio output device 112 by changing the direction of the sound passage holes.

One end of an audio output wire harness 121 is electrically connected to the first audio output device 112. One end of a direction changing wire harness 122 is electrically connected to the drive unit 115B of the first direction changing device 115. The audio output wire harness 121 and the direction changing wire harness 122 are bundled together on the back side of the front door trim 107. An audio connector 123 is electrically connected to the other end of the audio output wire harness 121 and the other end of the direction changing wire harness 122. Although details are not shown, the audio connector 123 is electrically connected to the controller 118 via a control connector, a control wire harness, and the like.

The second direction changing devices 116 and the third direction changing devices 117 also have the same structure as the first direction changing devices 115.

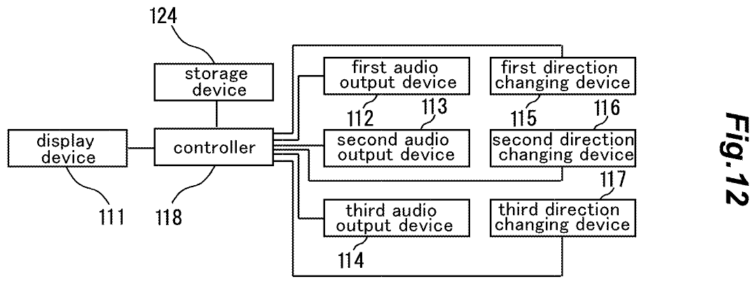

As shown in FIG. 12, a storage device 124 is electrically connected to the controller 118. The storage device 124 stores various pieces of information. For example, the storage device 124 stores the information indicating the type of audio and the identification information of the seat in association with each other.

The controller 118 determines the type of information to be outputted by audio based on the information stored in the storage device 124. The controller 118 determines the identification information in the storage device 124 that is associated with the information indicating the type.

For example, when the identification information is the identification information of the first row seat, the controller 118 controls the first direction changing device 115 such that the output direction of the sound of the first audio output device 112 is directed toward the first row seat.

For example, when the identification information is the identification information of the second row seat, the controller 118 controls the second direction changing device 116 such that the output direction of the sound of the second audio output device 113 is directed toward the first row seat.

For example, when the identification information is the identification information of the third row seat, the controller 118 controls the third direction changing device 117 such that the output direction of the sound of the third audio output device 114 is directed toward the third row seat.

According to the second embodiment described above, when the first audio output device 112 or the like is to output information to the occupant seated in a specific seat by audio, the controller 118 controls the first direction changing device 115 or the like such that the audio issuing from the first audio output device 112 or the like is directed to the specific seat. Therefore, the information is transmitted to the occupant who needs the information and the information is not transmitted to the occupants who do not need the information. As a result, the discomfort to the occupants who do not need the information can be prevented.

In particular, when the first audio output device 112 outputs information about driving by voice, the controller 118 controls the first direction changing device 115 so that the output direction of the audio of the first audio output device 112 is directed to the driver's seat. Therefore, information regarding driving can be transmitted to the occupant seated in the driver's seat in a reliable manner. For example, if the output direction of voice guidance information of a car navigation system, information about the approach of other vehicles, etc. is directed toward the driver's seat, information that assists driving can be transmitted to the occupant seated in the driver's seat in a reliable manner.

When the first audio output device 112 or the like outputs information irrelevant to driving, such as music or telephone messages, the controller 118 may control the first direction changing device 115 or the like so that the output direction of the audio from the first audio output device 112 or the like is set to the assistant's seat or other passenger seats. In this case, the transmission of information that may interfere with driving is prevented from being directed to the occupant in the driver's seat.

Also, the controller 118 determines the type of information outputted by the first audio output device 112 based on the information stored in the storage device 124. The controller 118 determines the identification information associated with the information indicating the type of information stored in the storage device 124. The controller 118 controls the first direction changing device 115 so that the audio output direction of the first audio output device 112 is set to the seat corresponding to the identification information. Therefore, the information can be transmitted to the occupants who need the information in a reliable manner, and the information is prevented from being transmitted to the occupants who do not need the information.

At this time, the information indicating the type of audio and the identification information of the seat may be associated with each other via application software of a mobile terminal such as a smartphone. In this case, information can be transmitted to occupants who need the information and is prevented from being transmitted to occupants who do not need the information in a more reliable manner.

The first audio output device 112 is provided in the front door 105. The second audio output device 113 is provided in the rear door 106. Therefore, necessary information can be reliably transmitted to the occupants near the front door 105 and the rear door 106.

Also, the audio output wire harness 121 and the direction changing wire harness 122 are bundled. Therefore, the work for electrically connecting the first audio output device 112 and the first direction changing device 115 to the controller 118 can be easily performed.

A direction changing device similar to the first direction changing device 115 or the like may be provided on the floor 101. In this case, the transmission direction of the vibration sound from the floor 101 may be changed so that the transmission direction of the vibration sound from the floor 101 does not coincide with any seat while the vehicle is traveling. In this case, the occupant's discomfort can be minimized.

Also, the structure of the first direction changing device 115 and the like is not limited to the structure of the second embodiment. For example, in the first direction changing device 115 or the like, a louver may be used to change the audio output direction.

Further, when a failure of the first audio output device 112 or the like and the first direction changing device 115 or the like is detected, the operation of the failed first direction changing device 115 or the like may be stopped. In such a case, information transmission may be continued by the audio output devices and the direction changing devices in which no failure has been detected. Thereby, a highly versatile notification system can be realized.

### Third Embodiment

In the third embodiment, parts corresponding to those in the second embodiment are denoted with the same reference numerals, and description of similar parts will be simplified or omitted as appropriate in the following description.

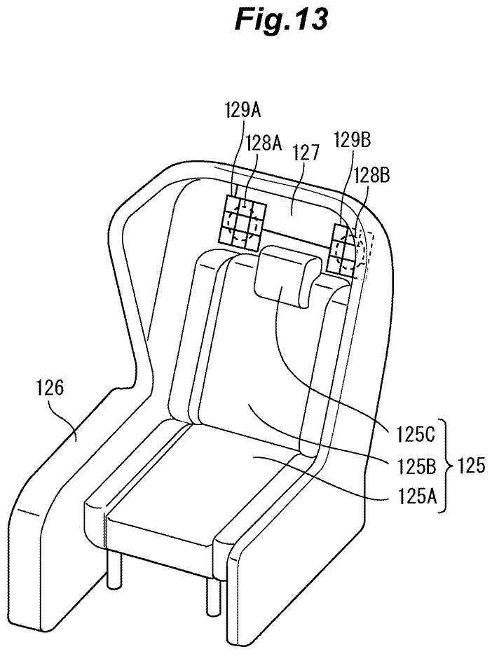

As shown in FIG. 13, the seat 125 includes a seat cushion 125A, a seat back 125B and a headrest 125C similarly to the front seat 102 of FIG. 10.

A partition wall 126 surrounds the seat 125. A support device 127 is supported on an upper part of the partition wall 126 above the headrest 125C.

A plurality of audio output devices 128A, 128B are supported by the support device 127. More specifically, one of the audio output devices 128A is supported by the support device 127 above and on the right side of the headrest 125C. The other audio output device 128B is supported by the support device 127 above and on the left side of the headrest 125C.

A plurality of direction changing devices 129A, 129B are supported by the support device 127. The direction changing devices 129A and 129B are each provided on the audio output side of the corresponding audio output device 128A and 128B. More specifically, the direction changing device 129A is provided on the audio output side of the audio output device 128A. The direction changing device 129B is provided on the audio output side of the audio output device 128B. The direction changing devices 129A, 129B have the function of changing the output direction of the sound of the respective audio output devices 128A, 128B.

Although not shown in the drawings, when the audio output devices 128A and 128B output information to the occupant seated on the seat 125 by audio, the controller 118 causes the audio output devices 128A and 128B to output audio in the direction of the seat. The direction changing devices 129A, 129B are controlled so as to direct the audio issuing from the audio output devices 128A and 128B to the head of the occupant seated in the seat 125. More specifically, the controller 118 controls the direction changing devices 129A and 129B so that the direction of the sound output from the audio output devices 128A and 128B is directed to the headrest 125C.

According to the third embodiment described above, the audio output devices 128A, 128B and the direction changing devices 129A, 129B are supported by the support device 127. Therefore, not only the audio output devices 128A, 128B can be mounted in a stable manner, but also the number of component parts can be reduced and a compact arrangement can be achieved with regard to the audio output devices 128A, 128B and the direction changing devices 129A, 129B.

### Fourth Embodiment

In the fourth embodiment, parts corresponding to those in the second embodiment are denoted with the same reference numerals, and description of similar parts will be simplified or omitted as appropriate in the following description.

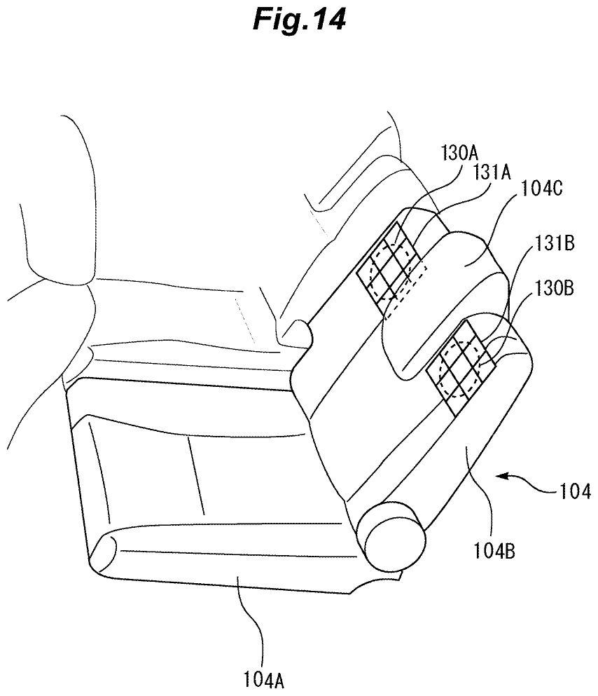

As shown in FIG. 14, a plurality of audio output devices 130A, 130B are provided on the seat back 104B of the rear seat 104. More specifically, one of the audio output devices 130A is provided on the upper right side of the seating surface of the seat back 104B. The other audio output device 130B is provided on the upper left side of the seating surface of the seat back 104B.

A plurality of direction changing devices 131A and 131B are provided on the audio output sides of the audio output devices 130A and 130B, respectively. More specifically, one of the direction changing devices 131A is provided on the audio output side of the audio output device 130A. The other direction changing device 131B is provided on the audio output side of the audio output device 130B.

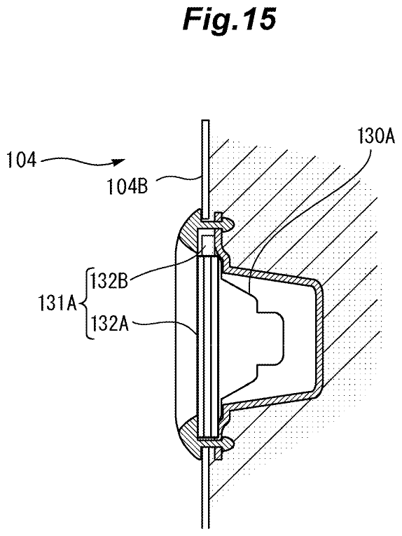

As shown in FIG. 15, the direction changing device 131A is similar in structure to the first direction changing device 115 shown in FIG. 11. More specifically, the direction changing device 131A includes a direction changing unit 132A and a drive unit 132B. Although not shown in the drawings, the direction changing unit 132A is provided with a plurality of sound passage holes. The drive unit 132B has the function to change the output direction and spread of the audio emitted from the audio output device 130A by changing the directions of the sound passage holes.

The direction changing device 131B also has a similar structure as the direction changing device 131A.

According to the fourth embodiment described above, the audio output device 130A and the like are provided in the rear seat 104. More specifically, the audio output device 130A and the like are provided in the seat back 104B. Therefore, the information can be reliably transmitted to the occupant seated in the rear seat 104.

In addition, the audio output device 130A or the like may also be provided in the headrest 104C. In this case, the sound output direction can be adjusted at a position closer to the occupant's head. As a result, information can be more reliably transmitted to the occupant seated in the rear seat 104.

### Fifth Embodiment

In the fifth embodiment, parts corresponding to those in the fourth embodiment are denoted with the same reference numerals, and description of similar parts will be simplified or omitted as appropriate in the following description.

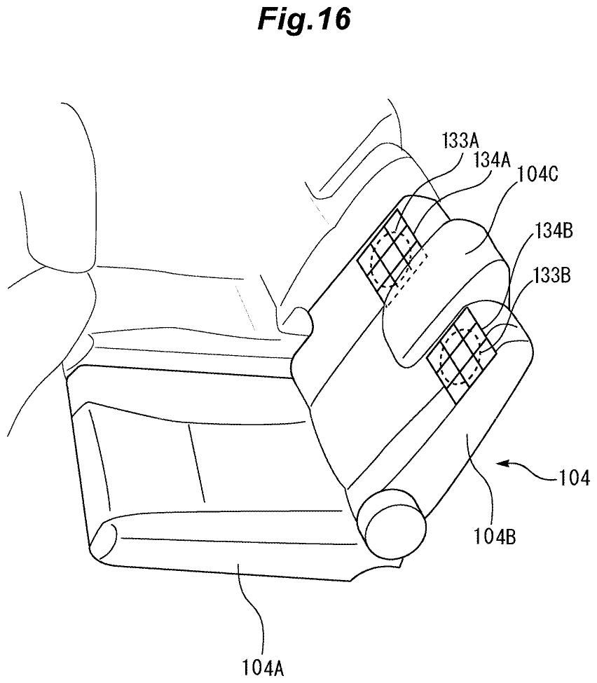

As shown in FIG. 16, a plurality of ultrasonic wave output devices 133A, 133B are provided on the seat back 104B. More specifically, one of the ultrasonic wave output devices 133A is provided on the upper right side of the seating surface of the seat back 104B. The other ultrasonic wave output device 133B is provided on the upper left side of the seating surface of the seat back 104B.

A plurality of direction changing devices 134A and 134B are provided on the ultrasonic output sides of the ultrasonic wave output devices 133A and 133B, respectively. More specifically, one of the direction changing devices 134A is provided on the ultrasonic wave output side of the ultrasonic wave output device 133A. The other direction changing device 134B is provided on the ultrasonic wave output side of the ultrasonic wave output device 133A.

Although not shown in the drawings, the controller 118 controls the ultrasonic wave output devices 133A and 133B so that the output direction of the ultrasonic wave from the ultrasonic wave output devices 133A and 133B is directed to a part of the body of the occupant seated in the seat back 104B.

According to the fifth embodiment described above, the ultrasonic wave output devices 133A and 133B are provided on the seat back 104B. Therefore, ultrasonic wave can be applied to the occupant's neck, shoulders, etc., by the ultrasonic wave output devices 133A and 133B. At this time, the ultrasonic wave strikes a localized part of the occupant's body, and the spreading of ultrasonic wave can be avoided. As a result, the ultrasonic waves can be impinged on a part of the occupant's body without being attenuated.

The vehicle notification system according to the present invention has been described in terms of specific embodiments, but the present invention can be widely modified without being limited to the second to fifth embodiments described above. For example, the first audio output device 112 or the like and the first direction changing device 115 or the like may be provided on the seat cushion 104A, the instrument panel 110, the rear tray, or the roof. Also, the first audio output device 112 or the like and the first direction changing device 115 or the like may be provided in a vehicle other than an automobile, for example. The first audio output device 112 and the like and the first direction changing device 115 and the like may also be provided inside a building. For example, the first audio output device 112 and the like and the first direction changing device 115 and the like may also be provided outdoors.

### <<Vehicle Notification System>>

Next, an embodiment in which the vehicle notification system according to the present invention is applied to an automobile will be described in the following with reference to the drawings.

### Sixth Embodiment

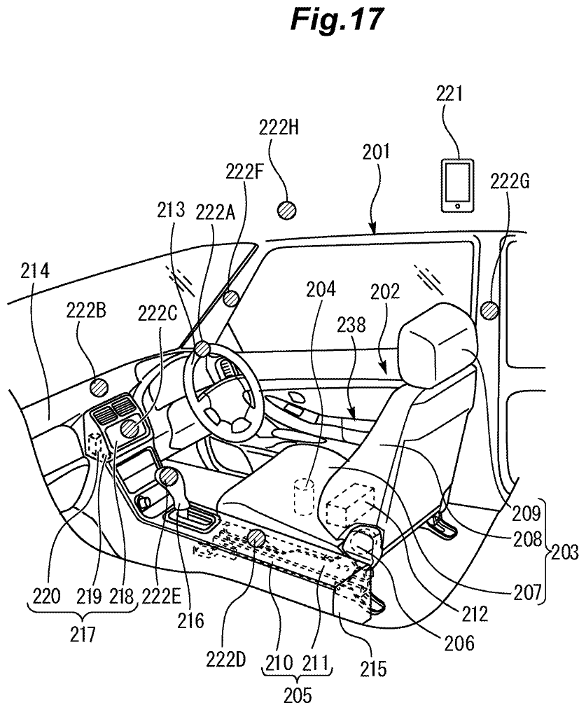

In FIG. 17, a door 201 on the driver's seat side is mounted on the right side of the front part of the vehicle so as to be opened and closed. The driver's seat 202 is provided on the right side of the front part of the cabin. The seat 202 includes a seat main body 203, a rotation device 204, a slide device 205 and a reclining device 206.

The seat main body 203 includes a seat cushion 207, a seat back 208 and a headrest 209. The seat back 208 is provided in a rear part of the seat cushion 207. The headrest 209 is provided on an upper part of the seat back 208.

The slide device 205 includes a pair of lower rails 210 and a pair of upper rails 211. The lower rails 210 extend in the fore and aft direction. The upper rails 211 are provided on the lower surface of the seat cushion 207 and extend in the fore and aft direction. The upper rails 211 are guided by the respective lower rails 210 in the fore and aft direction.

The rotation device 204 is provided between the upper rail 211 of the slide device 205 and the seat cushion 207. The rotation device 204 supports the seat cushion 207 so as to be rotatable around a vertical axis with respect to the upper rail 211.

The reclining device 206 connects the rear part of the seat cushion 207 and the lower part of the seat back 208 to each other. The reclining device 206 supports the seat back 208 with respect to the seat cushion 207 so as to be rotatable around a horizontal axis. The reclining device 206 can retain the seat back 208 at any desired angle with respect to the seat cushion 207.

The seat controller 212 is provided with a lower part the seat cushion 207. The seat controller 212 has the function of controlling the operation of the seat main body 203.

A steering wheel 213 is provided in front of the seat 202 on the right side of the front part of the vehicle compartment. An instrument panel 214 is provided in a front part of the cabin. A center console 215 is provided on the left side of the seat 202 in the vehicle cabin. A shift lever 216 is provided in a front part of the center console 215.

A navigation system 217 is housed in the instrument panel 214. The navigation system 217 includes a display device 218, audio output device 219 and navigation controller 220.

The display device 218 has the function of displaying information as a notification device. The audio output device 219 has the function of outputting information by audio as a notification device. The navigation controller 220 has the function of controlling the display device 218 and the audio output device 219.

For example, the navigation controller 220 receives positioning signals such as GPS (Global Positioning System) signals using artificial satellites to detect the current position of the vehicle. The navigation controller 220 searches for a route from the current position to a destination. The navigation controller 220 causes the display device 218 to display information about the route from the current position to the destination, and causes the audio output device 219 to output the relevant information by speech.

For example, the navigation controller 220 transmits and receives information to and from a mobile terminal 221 such as a smartphone via short-range wireless communication such as Bluetooth (registered trademark).

A sensor 222A is provided on the steering wheel 213 at a position avoiding the airbag housing and the switches. For example, the sensor 222A is provided in an upper part of the steering wheel 213. A sensor 222B is provided on the instrument panel 214 at a position that avoids the airbag storage compartment and the air conditioning outlet. For example, the sensor 222B is provided in a laterally central part of the instrument panel 214. A sensor 222C is provided on the display device 218. A sensor 222D is provided in a central part of the upper surface of the center console 215. A sensor 222E is provided at the grip portion of the shift lever 216. A sensor 222F is provided on the front pillar. A sensor 222G is provided on the center pillar. A sensor 222H is provided on the roof. These sensors 222A-222H are provided with the function to detect viruses.

The sensors 222A to 222H may consist of per se known sensors. The sensors 222A to 222H may be semiconductor sensors, for example, and may be configured to detect viruses by detecting changes in electrical properties caused by the binding of viruses to the surface of a semiconductor device. In the sensors 222A-222H, a substance that binds to a specific virus spike protein may be formed on the surface of the semiconductor. Thereby, specific viruses may be selectively detected.

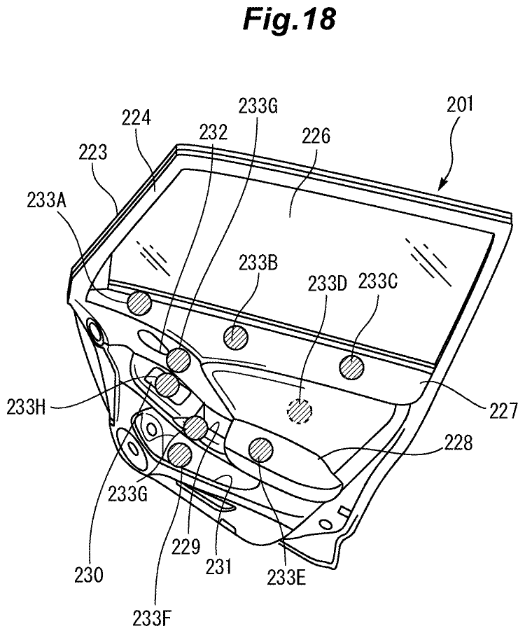

In FIG. 18, an outer panel 223 defines the outer surface of the door 201. The upper part of the outer panel 223 is open. An inner panel 224 is provided on the cabin side of the outer panel 223. An upper part of the inner panel 224 is open. A window glass sheet 226 is provided between the outer panel 223 and inner panel 224. The window glass sheet 226 is configured so as to open and close the opening defined by the outer panel 223 and the inner panel 224. A door trim 227 is provided on the interior side of the inner panel 224. The door trim 227 defines a side surface of the cabin.

An armrest 228 is provided in a vertically middle part of the door trim 227. The armrest 228 protrudes from the door trim 227 toward the cabin. The armrest 228 extends along the fore and aft direction. The door handle 229 is formed in a central part of the armrest 228 with respect to the longitudinal direction. A touch panel 230 is provided on the upper surface of a front part of the armrest 228. The touch panel 230 is used when moving up and down the window glass sheet 226.

A door pocket 231 is provided in the door trim 227. The door pocket 231 is located under the armrest 228. The door pocket 231 has an opening facing upward. A door lock unit 232 is provided in an upper front part of the door trim 227. The door lock unit 232 is exposed to the cabin side.

A plurality of sensors 233A-233H are provided at various locations on the door trim 227. These sensors 233A-233H have the function of detecting viruses.

The sensor 233A is provided in an upper front part of door trim 227. The sensor 233B is provided in an upper central part of the door trim 227. The sensor 233C is provided in an upper rear part of the door trim 227. The sensor 233D is provided inside the door trim 227. The sensor 233E is provided in an upper rear part of the armrest 228. The sensor 233F is provided inside the door pocket 231. The sensor 233G is provided on the door handle 229. The sensor 233H is provided on the touch panel 230.

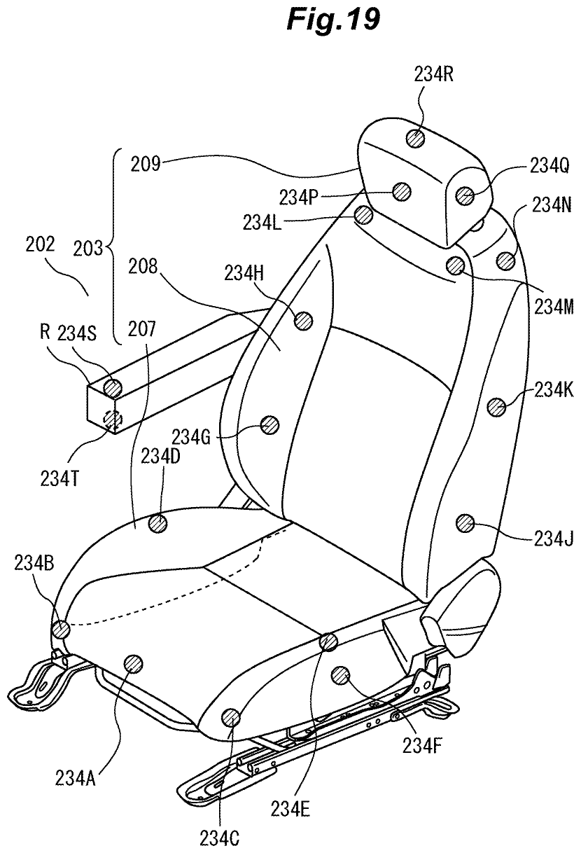

As shown in FIG. 19, the seat main body 203 is provided with an armrest R. The armrest R is provided on the right side of the seat back 208.

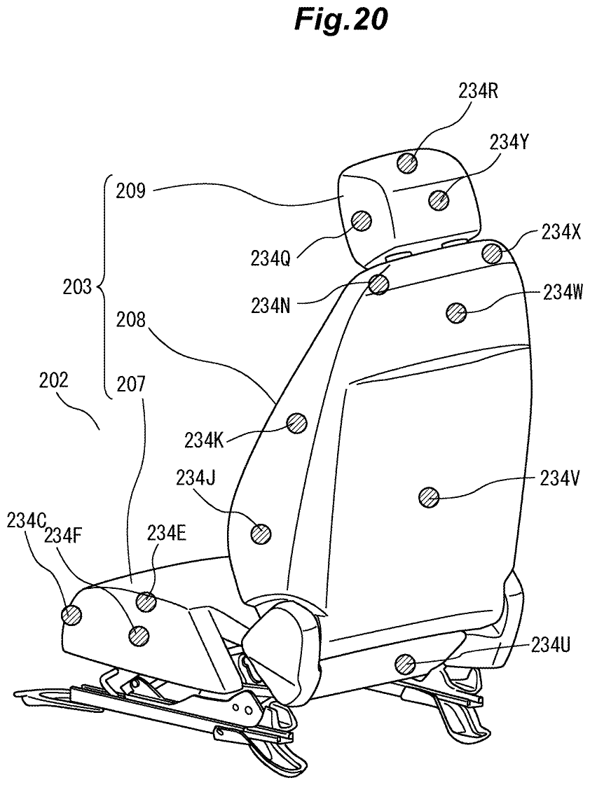

As shown in FIGS. 19 and 20, a plurality of sensors 234A-234Y are provided at various locations on the seat main body 203. These sensors 234A-234Y have the function of detecting viruses.

The sensor 234A is provided in a central part of the front end surface of the seat cushion 207. The sensor 234B is provided at the right corner of the front end surface of the seat cushion 207. The sensor 234C is provided at the left corner of the front end surface of the seat cushion 207. The sensor 234D is provided on the upper surface of the right shoulder part of the seat cushion 207. The sensor 234E is provided on the upper surface of the left shoulder part of the seat cushion 207. The sensor 234F is provided on the outer surface of the left shoulder part of the seat cushion 207.

The sensor 234G is provided in a lower part of the inner surface of the right shoulder part of the seat back 208. The sensor 234H is provided in an upper part of the inner surface of the right shoulder part of the seat back 208. The sensor 234J is provided in a lower part of the outer surface of the left shoulder part of the seat back 208. The sensor 234K is provided on the upper portion of the outer surface of the left shoulder part of the seat back 208. The sensor 234L is provided at the upper left corner part of the seating portion of the seat back 208. The sensor 234M is provided at the upper right part of the seating portion of the seat back 208. The sensor 234N is provided on the left shoulder part of the seat back 208.

The sensor 234P is provided in a central part of the front surface of the headrest 209. The sensor 234Q is provided in a central part of the left side surface of the headrest 209. The sensor 234R is provided in a central part of the upper surface of the headrest 209.

The sensor 234S is provided on the upper surface of a front end part of the armrest R. The sensor 234T is provided on the lower surface of the front end part of the armrest R.

The sensor 234U is provided in a central part of the rear end surface of the seat cushion 207. The sensor 234V is provided in a central part of the back surface of the seat back 208. The sensor 234W is provided in an upper part of the back surface of the seat back 208. The sensor 234X is provided on a left shoulder part of the seat back 208. The sensor 234Y is provided in a central part of the back surface of the headrest 209.

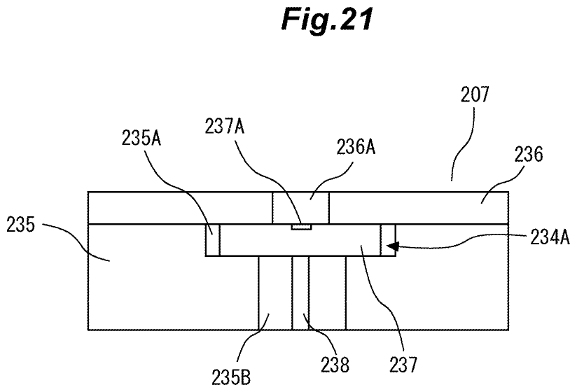

Next, a first example of the sensor 234A will be described by referring to FIG. 21. As shown in FIG. 21, the seat cushion 207 includes a pad 235 and a skin 236. The pad 235 is made of an elastic cushioning material such as polyurethane foam. The pad 235 includes a recess 235A and a wire harness hole 235B. The recess 235A is formed in a part of the surface of the pad 235. The wire harness hole 235B is formed so as to communicate with the bottom side of the recess 235A. The skin 236 is made of synthetic leather, cloth, or the like. The skin 236 covers the surface of the pad 235. The skin 236 is exposed to the outside. The skin 236 is provided with a virus detection hole 236A. The virus detection hole 236A is formed so as to penetrate a part of the skin 236. The virus detection hole 236A is formed so as to communicate with the recess 235A of the pad 235.

The sensor 234A includes a sensor main body 237 and a wire harness 238. The sensor main body 237 includes a detection unit 237A. The sensor main body 237 is accommodated in the recess 235A so that the detection unit 237A overlaps with the virus detection hole 236A of the skin 236. One end of the wire harness 238 is connected to the rear surface of the sensor main body 237. The wire harness 238 is electrically connected to the detection unit 237A. The wire harness 238 is housed in a bottom part of the pad 235 along the wire harness hole 235B. The other end of the wire harness 238 is electrically connected to the power supply of the vehicle. The wire harness 238 supplies electric power to the detection unit 237A.

The detection unit 237A detects viruses that migrate from the front side of the skin 236 toward the back side of the skin 236 via the virus detection hole 236A.

Note that the sensors 234B to 234Y also have a similar configuration as the sensor 234A.

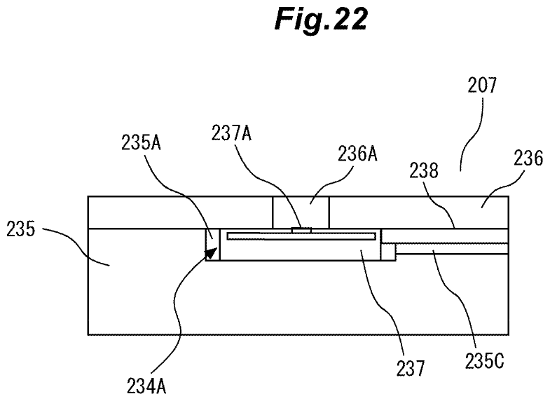

Next, a second example of the sensor 234A will be described in the following with reference to FIG. 22. In FIG. 22, parts corresponding to those in FIG. 21 are denoted with the same reference numerals, and description of similar parts will be simplified or omitted as appropriate in the following description. In the pad 235 shown in FIG. 22, the wire harness groove 235C is formed on the surface side of the pad 235. The wire harness groove 235C is formed so as to communicate with one side of the recess 235A. One end of the wire harness 238 is connected to a side surface of the sensor main body 237. The wire harness 238 is housed in and along the wire harness hole 235B on the surface side of the pad 235. Note that the sensors 234B to 234Y also have a similar configuration as the sensor 234A.

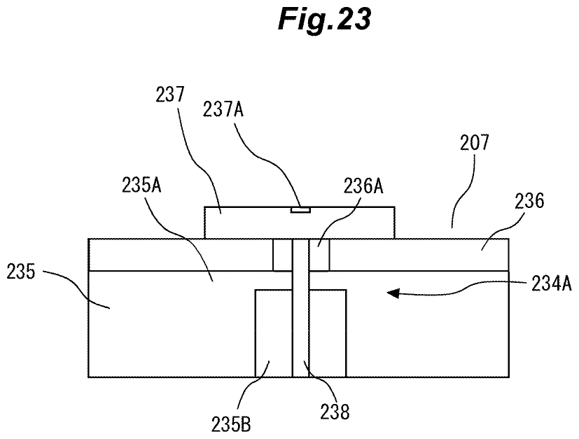

Next, a third example of the sensor 234A will be described with reference to FIG. 23. In FIG. 23, parts corresponding to those in FIG. 21 are denoted with the same reference numerals, and description of similar parts will be simplified or omitted as appropriate in the following description. In FIG. 23, the sensor main body 237 is positioned on the surface side of the skin 236. A virus detection hole 236A is used as a housing for one end of the wire harness 238. Note that the sensors 234B to 234Y also have a similar configuration as the sensor 234A.

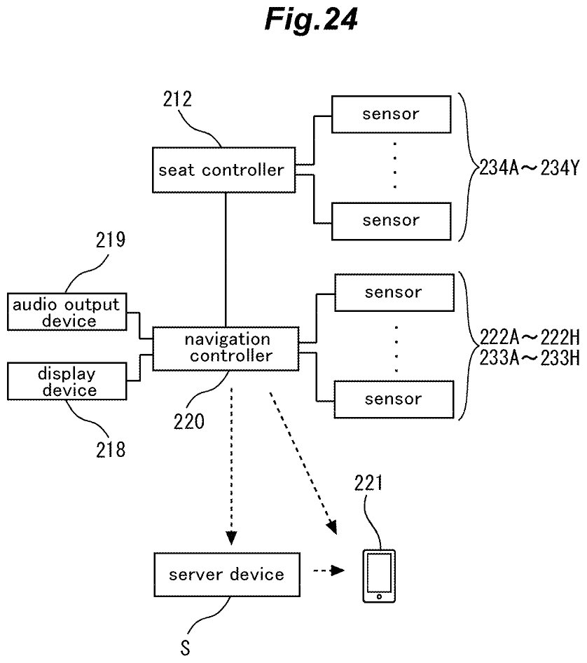

Next, the control action of the display device 218 and the audio output device 219 will be described in the following with reference to FIG. 24. The detection states of the sensors 222A-222H, 233A-233H are always maintained.

For example, when any one of the sensors 222A to 222H and 233A to 233H detects a virus, the navigation controller 220 causes the display device 218 to display information related to the virus detection, or causes the audio output device 219 to output corresponding audio. For example, when any one of the sensors 234A to 234Y detects a virus, the navigation controller 220 grasps the detection of the virus via the seat controller 212 and displays information regarding virus detection on the display device 218 and outputs this information by audio from the audio output device 219.

For example, when any one of the sensors 222A to 222H and 233A to 233H detects a virus, the navigation controller 220 transmits information on virus detection directly to the mobile terminal 221 located outside the vehicle via a wireless link. For example, when any one of the sensors 234A to 234Y detects a virus, the navigation controller 220 grasps the detection of the virus via the seat controller 212 and notifies the information regarding virus detection directly to the mobile terminal 221 via a wireless link.

For example, when any one of the sensors 222A to 222H and 233A to 233H detects a virus, the navigation controller 220 transmits information regarding virus detection to a mobile terminal 221 by using a server device S located outside the vehicle via a mobile communication network. For example, when any one of the sensors 234A to 234Y detects a virus, the navigation controller 220 grasps the detection of the virus by using the seat controller 212 and notifies the information regarding the detection of the virus by using a server device S located outside the vehicle via a mobile communication network.

The information to be presented at this time may be appropriately selected. For example, information about the presence or absence of viruses is presented. For example, information about the amount of the virus is presented in such a manner as “There is a high risk because a large amount of viruses is detected.” For example, information regarding types of viruses may be presented.

According to the sixth embodiment described above, when the sensor 222A or the like detects a virus, information regarding virus detection is notified in the vehicle. Therefore, in the vehicle, the occupant is prevented from being infected with the virus. Moreover, the sensor 222A may be provided on the steering wheel 213.

Therefore, the virus can be detected in places that are likely to be touched by the occupant. As a result, the occupant is prevented from being infected with the virus in a more reliable manner.

The sensor 222B may also be provided on the instrument panel 214. Therefore, the virus can be detected in places that are likely to be touched by the occupant. As a result, the occupant is prevented from being infected with the virus in a more reliable manner.

Moreover, the sensor 233A and the like may be provided on the door trim 227. Therefore, the virus can be detected in places that are likely to be touched by the occupant. As a result, the occupant is prevented from being infected with the virus in a more reliable manner.

Also, the sensor 234 A and the like may be provided on the seat 202. Therefore, the virus can be detected in the vicinity of the occupant. As a result, the occupant is prevented from being infected with the virus in a more reliable manner.

Moreover, the sensor 234P and the like may be provided on the headrest 209. Therefore, the virus can be detected in the vicinity of the occupant's mouth. As a result, the occupant is prevented from being infected with the virus in a more reliable manner.

Also, the sensor 234A and the like of the first example may be provided on the back side of the skin 236. The sensor 234A and the like of the first example can detect viruses that migrate from the front side of the skin 236 toward the back side of the skin 236 through the virus detection hole 236A. Therefore, even if the sensor 234A or the like is provided on the back side of the skin 236, the virus can be reliably detected.

In addition, in the sensor 234A and the like of the second example, the wire harness 238 is received on the surface side of the pad 235 along the wire harness hole 235B. Therefore, the wire harness 238 can be easily routed when mounting the sensor 234A and the like in the recess 235A of the pad 235.

Also, the sensor 234A and the like of the third example may be provided on the front side of the skin 236. Thereby, viruses can be detected more reliably than in the cases of the sensor 234A and the like of the first example and the sensor 234A and the like of the second example.

In addition, information about virus detection may be sent to the mobile terminal 221 located outside the vehicle. Therefore, the prospective user who possesses the mobile terminal 221 can be notified of the virus detection. As a result, virus infection can be prevented in a more reliable manner. In particular, when the vehicle is used for car sharing, the spread of virus infection can be restricted by notifying the virus detection to various prospective users via the application software for the mobile terminals 221.

In addition, information on virus detection may be notified to the mobile terminal 221 via the server device S. Thereby, the server device S can identify the vehicle in which the virus has been detected. At this time, by acquiring the location information of the vehicle in the server device S, it is possible to specify the area where the virus was detected.

Note that a fail-safe function may be applied in case of a failure of the sensor 222A or the like. More specifically, when a failure such as wire breakage is detected in the sensor 222A or the like, the function of notifying information regarding virus detection may be stopped. In this case, it may be notified to the users that the notification function related to virus detection is stopped.

Further, the detection state of the sensor 222A or the like may be maintained only when the power source of the vehicle is supporting the output state.

Also, the method of notifying information about virus detection is not limited to those mentioned above. For example, information about virus detection may be notified by blinking light or the like. For example, vibrations may be used to notify information about virus detection.

Also, if a partition wall is provided around the seat 202, the partition wall may be provided with a sensor.

Also, if there is a sunroof, the sensor may be provided on the sunroof.

### Seventh Embodiment

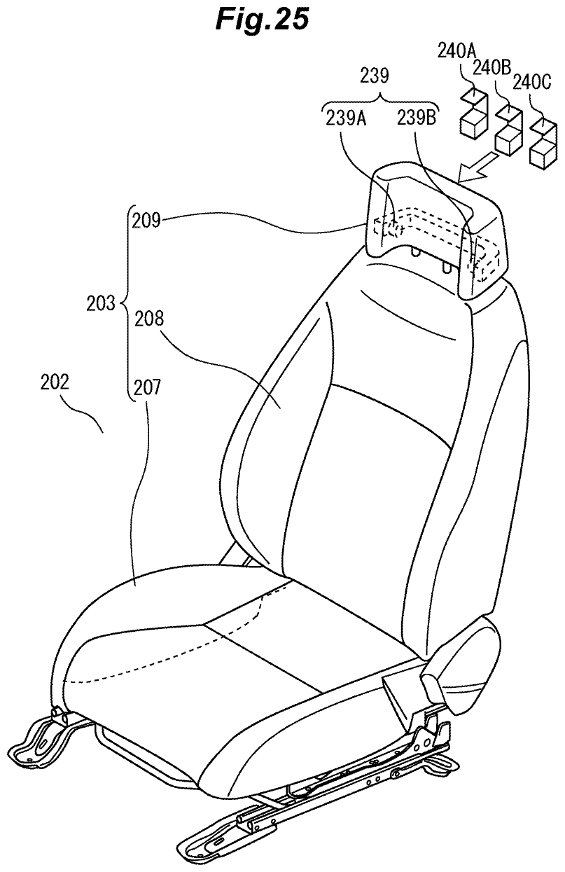

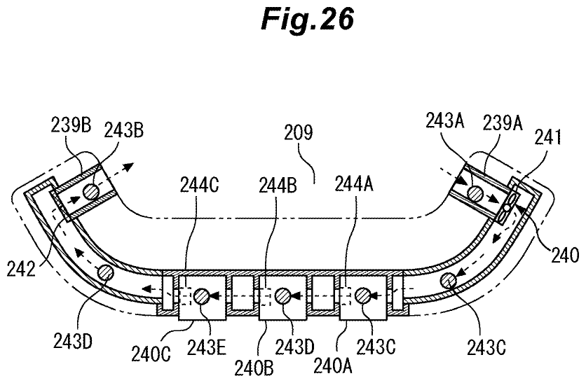

In FIGS. 25 and 26, parts corresponding to those in FIG. 21 are denoted with the same reference numerals, and description of similar parts will be simplified or omitted as appropriate in the following description.

As shown in FIG. 25, a duct 239 may be received in the headrest 209. The duct 239 extends horizontally. An inlet 239A is connected to the right end of the duct 239. The inlet 239A opens toward the outside. An outlet 239B is connected to the left end of duct 239. The outlet 239B opens toward the outside.

A first cartridge 240A is detachably fitted to the duct 239 at a part thereof adjacent to the inlet 239A thereof from the back side of the headrest 209. A second cartridge 240B is detachably fitted to the duct 239 at a lengthwise middle part thereof from the back side of the headrest 209. A third cartridge 240C is detachably fitted to the duct 239 at a part thereof adjacent to the outlet 239B thereof from the back side of the headrest 209.

As shown in FIG. 26, a blower 241 may be provided at the junction between the duct 239 and the inlet 239A. The blower 241 has the function of creating an airflow directed from the inlet 239A to the outlet 239B. A filter 242 may be provided at the junction between the duct 239 and the outlet 239B. The filter 242 has the function of capturing various viruses.

A sensor 243A may be provided inside the inlet 239A. Another sensor 243B may be provided inside the outlet 239B. A sensor 243C may be provided inside the first cartridge 240A. A sensor 243D may be provided inside the second cartridge 240B. A sensor 243E may be provided inside the third cartridge 240C.

The sensors 243C to 243E are thus arranged inside the duct 239 along the length thereof. The sensors 243C to 243E are provided with detectors (not shown in the drawings), respectively, that have the function of detecting viruses different from each other. For example, the detector of the sensor 243C has the function of detecting a first virus. The detector of the sensor 243D has the function of detecting a second virus. The detector of the sensor 243E has the function of detecting a third virus.

A first photocatalyst 244A may be provided downstream of and adjacent to the sensor 243C in the first cartridge 240A. The first photocatalyst 244A has the function of killing the first virus. The second photocatalyst 244B is provided downstream of and adjacent to the sensor 243D in the second cartridge 240B. The second photocatalyst 244B has the function of killing the second virus. The third photocatalyst 244C is provided downstream of and adjacent to the sensor 243E in the third cartridge 240C. The third photocatalyst 244C has the function of killing the third virus.

According to the seventh embodiment described above, air flows inside the duct 239. The sensors 243C-243E are provided inside the duct 239 between the inlet 239A and outlet 239B. The sensors 243C-243E detect viruses in the air flowing through the duct 239. Therefore, viruses can be detected in a reliable manner.

Also, sensors 243C to 243E are provided one next to the other inside the duct 239. The sensors detect different viruses. Therefore, various viruses can be detected.

Also, a filter 242 may be provided inside the duct 239 between the sensor 234E and the outlet 239B. Filter 242 captures viruses. Therefore, the floating amount of viruses inside the cabin can be reduced.

Moreover, the sensors 243C to 243E are detachably mounted to the duct 239. Therefore, the sensors 243C-243E can be easily replaced. As a result, the sensors 243C-243E may be tailored to the prevalent viruses with ease.

Also, a first photocatalyst 244A may be provided adjacent to the sensor 243C. A second photocatalyst 244B may be provided adjacent to the sensor 243D. A third photocatalyst 244C may be provided adjacent to the sensor 243E. Thereby, the floating amount of viruses inside the cabin can be reduced.

At least one of the first cartridge 240A, the second cartridge 240B, and the third cartridge 240C may be filled with fragrance or deodorant.

The present invention has been described above in terms of specific embodiments and modifications thereof, but can be worked in various different ways without being limited to the sixth and seventh embodiments. For instance, the features of the sixth and seventh embodiments may be combined in the seat main body 203 to detect viruses.

### <<Vehicle Interior Material>>

Next, an embodiment in which the vehicle interior material according to the present invention is applied to an automobile will be described in the following with reference to the drawings.

### Eighth Embodiment

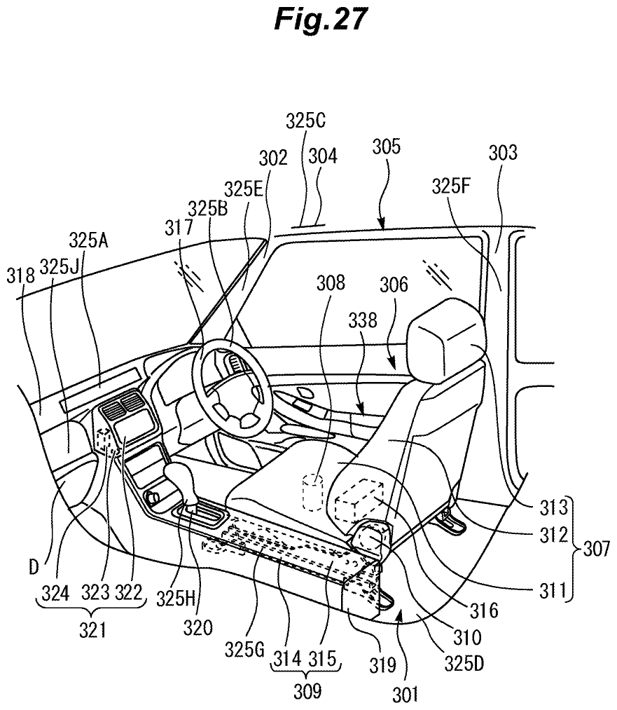

In FIG. 27, a floor 301 defines the floor surface of the vehicle. A front pillar 302 is the right pillar at the front of the vehicle. A center pillar 303 is a pillar on a central part of the vehicle on the right side. A roof 304 is a roof member that covers the top of the vehicle. A door 305 on the driver's seat side is provided so as to be opened and closed in a front part of the vehicle on the right side. The driver's seat 306 is provided in a front part of the cabin on the right side. The seat 306 includes a seat main body 307, a rotation device 308, a slide device 309 and a reclining device 310.

The seat main body 307 includes a seat cushion 311, a seat back 312 and a headrest 313. The seat back 312 is provided in a rear part of the seat cushion 311. A headrest 313 is provided in an upper part of the seat back 312.

The slide device 309 includes a pair of lower rails 314 and a pair of upper rails 315. The lower rails 314 are provided such that the longitudinal direction thereof extends in the fore and aft direction. The upper rails 315 are provided on the lower surface of the seat cushion 311 with the longitudinal direction thereof extending in the fore and aft direction. The upper rails 315 are guided in the fore and aft direction by the corresponding lower rails 314.

The rotation device 308 is provided between the upper rails 315 of the slide device 309 and the seat cushion 311. The rotation device 308 supports the seat cushion 311 so as to be rotatable around a vertical axis with respect to the upper rails 315.

The reclining device 310 connects the rear part of the seat cushion 311 and the lower part of the seat back 312. The reclining device 310 supports the seat back 312 rotatably around a horizontal axis with respect to the seat cushion 311. The reclining device 310 supports the seat back 312 at any desired angle with respect to the seat cushion 311.

The seat controller 316 is provided under the seat cushion 311. The seat controller 316 has the function of controlling the operation of the seat main body 307.

A steering wheel 317 is provided in front of the seat 306 on the right side of the front part of the vehicle compartment. An instrument panel 318 is provided in the front part of the cabin. A center console 319 is provided on the left side of the seat 306 in the vehicle cabin. A shift lever 320 is provided in a front part of the center console 319. A dashboard D is provided under the instrument panel 318 on the side of the assistant's seat.

A navigation system 321 is housed in the instrument panel 318. The navigation system 321 includes a display device 322, an audio output device 323 and a navigation controller 324.

The display device 322 has the function of displaying information. The audio output device 323 has the function of outputting information by audio. The navigation controller 324 has the function of controlling the display device 322 and the audio output device 323.

For example, the navigation controller 324 receives positioning signals such as GPS (Global Positioning System) signals using artificial satellites to detect the current position of the vehicle. The navigation controller 324 searches for a route from the current position to the destination. The navigation controller 324 causes the display device 322 to display information about the route from the current position to the destination, and causes the audio output device 323 to output the relevant information by audio.

In FIG. 27, a plurality of structures 325A-325J are provided on at least a part of the interior members. At least a part of the surface of each structure 325A to 325J is made of self-healing resin.

For example, the structure 325A is provided in a central part of the instrument panel 318. For example, the structure 325B is provided over the entire steering wheel 317. For example, the structure 325C is provided over the entire roof 304. For example, the structure 325D is provided over the entire floor 301. For example, the structure 325E is provided over the entire front pillar 302. For example, the structure 325F is provided over the entire center pillar 303. For example, the structure 325G is provided over the entire top part of the center console 319. The structure 325H is provided over the entire grip part of the shift lever 320. The structure 325J is provided over the entire dashboard D.

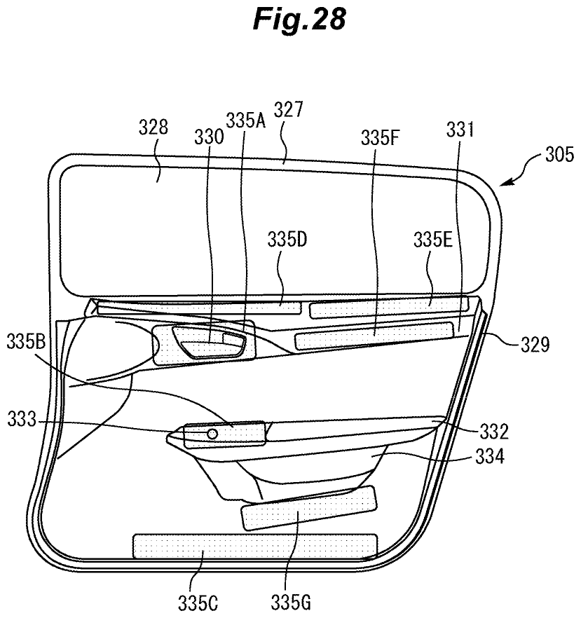

In FIG. 28, the outer panel (not shown in the drawing) defines the outer surface of the door 305. The upper part of the outer panel is open. The inner panel 327 is provided on the vehicle interior side of the outer panel. An upper part of the inner panel 327 is open. A window glass sheet 328 is provided between the outer panel and the inner panel 327. The window glass sheet 328 is provided so as to open and close the opening defined by the outer panel and the inner panel 327. A door trim 329 is provided in a lower part of the inner panel 327 on the cabin side. The door trim 329 defines a side of the cabin.

A door handle 330 is provided in a front upper part of the door trim 329. An ornament 331 is provided in an upper rear part of the door trim 329. An armrest 332 is provided in a vertically middle part of the door trim 329. The armrest 332 protrudes from the door trim 329 toward the cabin. The armrest 332 extends along the fore and aft direction. A switch 333 is provided on the upper surface of a front part of the armrest 332. The switch 333 is used for moving the window glass sheet 328 up and down. A door pocket 334 is provided in a lower part of the door trim 329 below the armrest 332. The door pocket 334 has an opening facing upward.

In FIG. 28, a plurality of structures 335A-335G are provided on at least a part of the interior members. At least a part of the surface of each structure 335A to 335G is made of self-healing resin. In FIG. 28, regions where structures 335A to 335G are positioned are schematically indicated.

For example, the structure 335A is provided around the door handle 330. For example, the structure 335B is provided around the switch 333 in the armrest 332. For example, the structure 335C is provided along the lower edge of the door trim 329. For example, the structure 335D is provided along a front part of the top edge of the door trim 329. For example, the structure 335E is provided along a rear part of the upper edge of the door trim 329. For example, the structure 335F is provided on the ornament 331. For example, the structure 335G is provided on the door pocket 334.

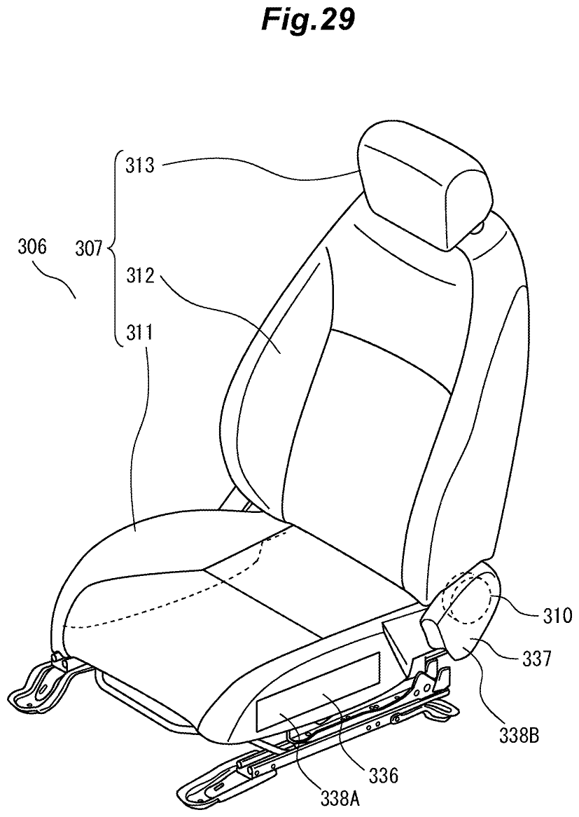

As shown in FIG. 29, the seat 306 includes a side cover 336 and a recliner cover 337. The side cover 336 covers a right side part of the seat cushion 311. The recliner cover 337 covers the right end of the reclining device 310.

In FIG. 29, a plurality of structures 338A, 338B are provided on at least a part of the interior members. At least a part of the surface of each structure 338A, 338B is made of self-healing resin.

For example, the structure 338A is provided over the entire side cover 336. For example, the structure 338 B is provided over the entire recliner cover 337.

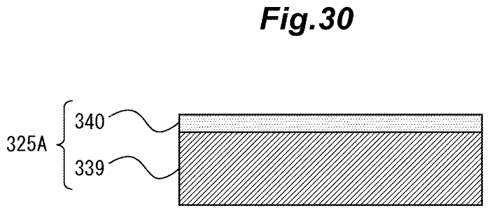

FIG. 30 shows an example of the details of the structure 325A. The structure 325A comprises a substrate 339 and a coating 340. The substrate 339 is made of resin such as polypropylene. The surface of the coating 340 is made of a self-healing resin different from the resin of the substrate 339. The coating 340 covers the surface of the substrate 339.

For example, the self-healing resin is a resin obtained by curing an energy-curable composition by irradiation of an active energy ray. The active energy ray in this case is ultraviolet light, visible light, infrared light, electron beams, β ray, y ray, and the like. For example, the self-healing resin is a resin formed from a polyamide compound.

A known composition can be applied to the energy-curable composition. The energy-curable compounds may consist of, for example, compounds (monomers and oligomers) containing polymerizable double bond groups in the molecule. Here, the polymerizable double bond group may be an acryloyl group, a methacryloyl group, an acryloyloxy group, a methacryloyloxy group, an allyl group, a vinyl group or the like.

The energy-curable composition contains at least one selected from the group consisting of a urethane (meth)acrylate compound having a polyether skeletal structure, a urethane (meth)acrylate compound having a polycaprolactone skeletal structure, and a urethane (meth)acrylate compound having a polycarbonate skeletal structure. The compound preferably contains at least a urethane (meth)acrylate compound having a polyether skeletal structure. Moreover, from the viewpoint of improving the crack elongation property of the self-healing laminate described later, the energy-curable composition preferably contains a urethane (meth)acrylate compound having a polycarbonate skeletal structure.

The energy-curable composition may contain, for example, a polyfunctional urethane (meth)acrylate, a monofunctional ethylenically unsaturated monomer, resin fine particles, and a photopolymerization initiator. Further, the energy-curable composition may contain, for example, a compound produced by a reaction between a compound having a hydroxyl group and an energy-curable cyclic imide group in the same molecule, and an epoxy compound having a half ester of an acid anhydride and one or more glycidyl compounds in the molecule.

For example, the coating 340 may comprise a plurality of layers. In this case, the outermost layer is a self-healing resin layer. The coating 340 may be integrated with the substrate 339 by film insert molding. For example, the coating 340 is formed by applying an energy-curable composition to the substrate 339 and curing it by irradiating it with an active energy ray.

The structures 325B-325J, 335A-335G, 338A and 338B also have a similar structure as the structure 325A.

According to the vehicle interior members described above, at least a part of the surface of the structure 325A or the like is formed of the self-healing resin. When the occupant touches the surface of the structure 325A or the like and damages the surface of the structure, the damage is repaired by the function of the self-healing resin. Therefore, the state of the design surface of the interior member can be maintained. As a result, the appearance of the interior member can be maintained.

Also, the coating 340 covers the surface of the substrate 339. Therefore, the state of the design surface of the interior member can be maintained while the strength necessary for the interior member is ensured by the substrate 339.

For example, the structure 335A and the like may be provided on the door trim 329. Therefore, the state of the design surface of the interior member at a location that is likely to be touched by the occupant can be maintained.

For example, the structure 335A is provided around the door handle 330. Therefore, the state of the design surface of the interior member at a location that is likely to be touched by the occupant can be maintained.

For example, the structure 335B is provided around the switch 333. Therefore, the state of the design surface of the interior member at a location that is likely to be touched by the occupant can be maintained.

For example, the structure 335C is provided in a lower part of the door trim 329. Therefore, the state of the design surface of the interior member at a location that is likely to be touched by the occupant's feet can be maintained.

For example, the structures 335D, 335E are provided in an upper part of the door trim 329. Therefore, the state of the design surface of the interior member at a location that is likely to be touched by the occupant's hands can be maintained.

For example, the structure 335F is provided on the ornament 331. Therefore, the state of the design surface of the interior member at a location that is likely to be touched by the occupant's hands can be maintained.

For example, the structure 335B is provided on the armrest 332. Therefore, the state of the design surface of the interior member at a location that is likely to be touched by the occupant's hand can be maintained.

For example, the structure 335G is provided in the door pocket 334. Therefore, the state of the design surface of the interior member at a location that is likely to be touched by the occupant's hand can be maintained.

For example, the structure 325A is provided on the instrument panel 318. Therefore, the state of the design surface of the interior member at a location that is likely to be touched by the occupant's hand can be maintained.

For example, the structure 325B is provided on the steering wheel 317. Therefore, the state of the design surface of the interior member at a location that is likely to be touched by the occupant's hand can be maintained.

For example, the structure 325C is provided on the roof 304. Therefore, the state of the design surface of the interior member at a location that is likely to be touched by the occupant's hand can be maintained.

For example, the structure 325D is provided on the floor 301. Therefore, the state of the design surface of the interior member at a location that is likely to be touched by the occupant's feet can be maintained.

For example, the structure 325E is provided on the front pillar 302. The structure 325F is provided on the center pillar 303. Therefore, the state of the design surface of the interior member at a location that is likely to be touched by the occupant's hand can be maintained.

For example, the structure 325G is provided on the center console 319. Therefore, the state of the design surface of the interior member at a location that is likely to be touched by the occupant's hand can be maintained.

For example, the structure 325H is provided on the shift lever 320. Therefore, the state of the design surface of the interior member at a location that is likely to be touched by the occupant's hand can be maintained.

For example, the structure 338A is provided on the seat 306. Therefore, the state of the design surface of the interior member at a location that is likely to be touched by the occupant can be maintained.

For example, the structure 338A is provided on the side cover 336. Therefore, the state of the design surface of the interior member at a location that is likely to be touched by the occupant's hand can be maintained.

For example, the structure 338B is provided on the recliner cover 337. Therefore, the state of the design surface of the interior member at a location that is likely to be touched by the occupant's hand can be maintained.

It is preferable that the self-healing resin is protected from deterioration due to ultraviolet light. For this reason, it is preferred to use the structure in a part of the vehicle that is less likely to be exposed to direct sunlight. In this embodiment, the area around the door handle 330, the area around the switch 333, the lower part of the door trim 329, the armrest 332, the door pocket 334, the side cover 336, and the recliner cover 337 are not likely to be exposed to direct sunlight. Thereby, degradation of the structure 335A and the like due to ultraviolet light can be minimized in these locations.

The present invention has been described above in terms of specific embodiments and modifications thereof, but can be worked in various different ways without being limited to the sixth and seventh embodiments. For example, if the self-healing resin can provide the necessary strength, the interior member may be manufactured only with the self-healing resin.

### <<Seat>>

An embodiment of a seat according to the present invention will be described in the following with reference to the drawings. The embodiment of the present invention is described in the following as applied to a front seat, in particular a driver's seat of a passenger car. However, the present invention can be equally applied to other seats such as a rear seat. In the following description, the front, back, left, right, up, and down directions are defined with reference to an occupant seated on the seat, or the seated occupant.

### Ninth Embodiment

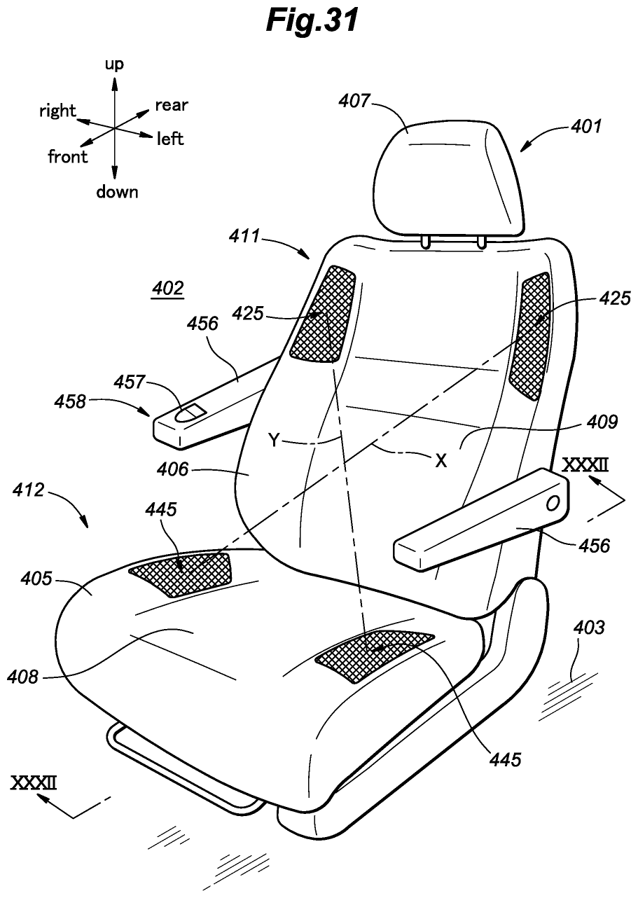

As shown in FIG. 31, a seat 401 is placed on a floor 403 that defines the lower portion of a vehicle cabin 402. The seat 401 includes a seat cushion 405 and a seat back 406 supported by a rear part of the seat cushion 405. The seat cushion 405 supports the buttocks of an occupant seated on the seat 401 from below. The seat back 406 is positioned behind the back of the seated occupant and functions as a backrest. A headrest 407 is provided at the upper end of the seat back 406.

Hereinafter, the upper surface of the seat cushion 405 will be referred to as a seat surface 408 and the front surface of the seat back 406 will be referred to as a backrest surface 409.

Further, the seat back 406 and the headrest 407 are collectively referred to as a seat upper part 411 and the seat cushion 405 is referred to as a seat lower part 412 as appropriate. The seat upper part 411 corresponds to a part configured to support the upper body (back and head) of the occupant seated on the seat 401, and the seat lower part 412 corresponds to a part configured to support the lower body (buttocks and thighs) of the occupant seated on the seat 401.

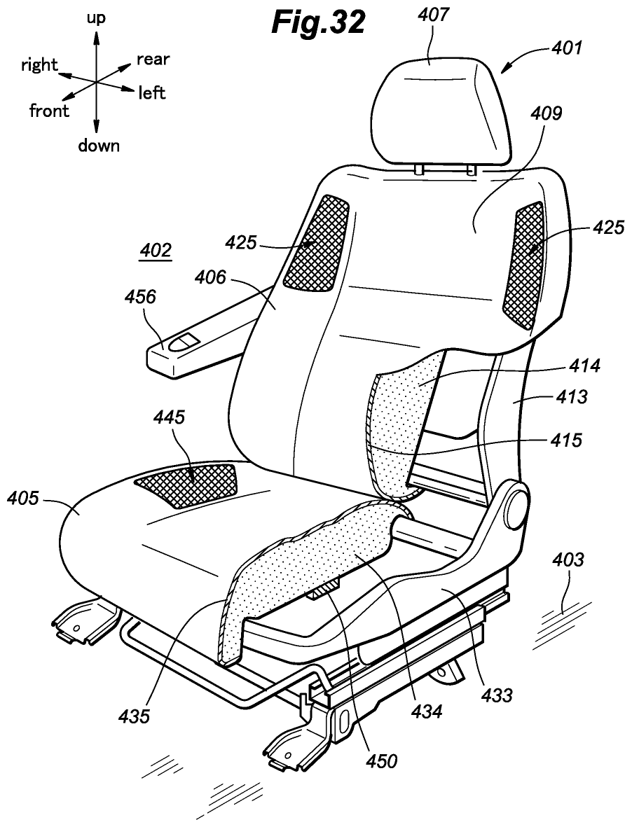

As shown in FIG. 32, the seat back 406 has a seat back frame 413 forming a structural framework, a pad 414 supported by the seat back frame 413, and a skin 415 covering the pad 414.

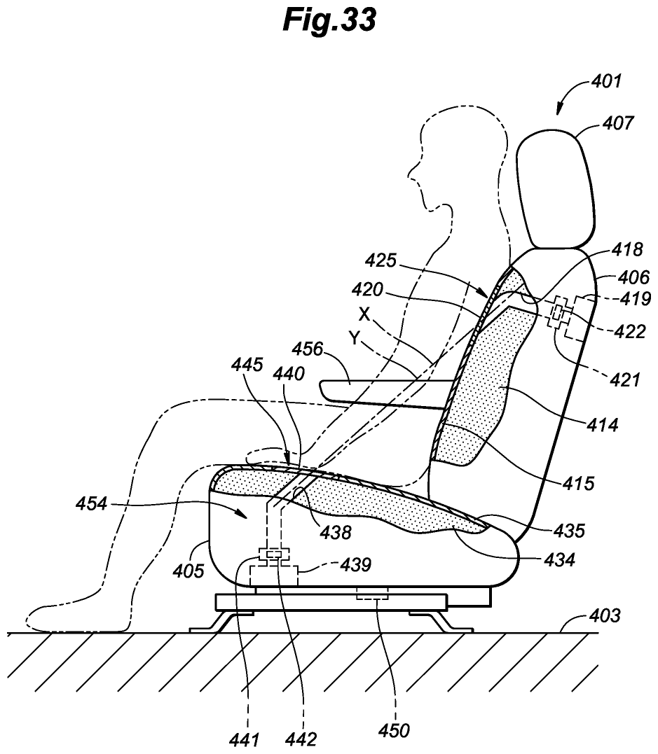

As shown in FIG. 33, the pad 414 forming the seat back 406 is provided with a pair of air holes 418 extending rearward from the front surface thereof.

A front end part of one of the air holes 418 extends along an axis X passing through the upper left part of the front surface of the pad 414. The front end part of the one air hole 418 opens at the upper left part of the front surface of the pad 414. The other air hole 418 extends along an axis Y passing through the upper right part of the front surface of the pad 414. The other air hole 418 opens at the upper right part of the front surface of the pad 414. The front end opening parts of the two air holes 418 are provided at positions corresponding to the left and right shoulders, respectively, of a seated occupant of a standard build.

As shown in FIG. 31, the axis X passes through the upper left part of the front surface (backrest surface 409) of the seat back 406 and the right front part of the upper surface of the seat cushion 405 (seat surface 408). The axis Y passes through the front upper right part of the seat back 406 and the left front part of the upper surface of the seat cushion 405.

As shown in FIG. 33, a fan 419 is provided at the rear end of each air hole 418. The fan 419 can push (that is, blow air outward) air into the interior of the air hole 418. Also, the fan 419 can draw or pull air from inside the air hole 418 to the rear of the seat back 406 (that is, draw air inward). The fans 419 may be composed of, for example, a sirocco fan, or may be composed of a blade fan. It is preferable that the fans 419 can switch between supplying air (also referred to as air blowing) to the inside of the air hole 418 and drawing air from the inside of the air hole 418 according to the rotational direction of the respective fans 419.

The skin 415 forming the seat back 406 is provided with air passing portions 420 at positions overlapping with the openings of the air holes 418. The air passing portions 420 each consist of a part of the skin 415 with higher air permeability than other parts, and is preferably made of a mesh-like woven cloth material. In addition, the air passing portion 420 may be formed by forming a plurality of holes passed through the skin 415 in the thickness direction.

A heating unit 421 (heater) is provided inside each of the air holes 418 of the seat back 406. The heating unit 421 is composed of a heating wire 422. However, the heating unit 421 is not limited to the heating wire 422, and may be, for example, a heating device that performs heating by circulating a predetermined medium in a tube.

When the fan 419 sends air into the air hole 418, the air is sent toward the vicinity of the shoulder of the seated occupant positioned in front of the seat back 406 via the air passing portion 420 and the air hole 418. At this time, the fan 419 functions as an air blower or air pusher that sends air to the seated occupant. When the fan 419 draws air from the inside of the air hole 418, the air is drawn from the vicinity of the shoulder of the seated occupant positioned in front of the seat back 406 via the air passing portion 420 and the air hole 418. At this time, the fan 419 functions as an air puller that draws air from the seat surface 408.

The front surface of the seat back 406 (the backrest surface 409) is thus provided with a pair of air openings 425 each formed jointly by the air passing portion 420 and the air holes 418 to send or push air to the front side of the seat back 406 and to draw or pull air (that is, to pass the air along the front side of the seat back 406). In this embodiment, the backrest surface 409 is formed with a pair of air openings 425 located on either side part thereof.

As shown in FIG. 32, the seat cushion 405 also includes a seat cushion frame 433 forming a skeletal structure, a pad 434 supported by the seat cushion frame 433, and a skin 435 covering the pad 434, similarly to the seat back 406.

As shown in FIG. 33, a pad 434 forming the seat cushion 405 is provided with a pair of air holes 438 extending downward from the upper surface thereof.

The upper end part of one of the air holes 438 is open at the left front part of the upper surface of the pad 434 and extends along the Y axis. The upper end part of the other air hole 438 opens at the right front portion of the upper surface of the pad 434 and extends along the axis X. The upper end openings of the air holes 438 are located so as to the correspond to the thighs of a seated occupant of a standard build.

A fan 439 is provided at the lower end of each air hole 438. The fan 439 is configured to push air into (that is, send air into) the interior of the air hole 438. Further, the fan 439 can draw air from (that is, draw air from) inside the air hole 438 or from a lower part of the seat cushion 405. The fan 439 may be composed of, for example, a sirocco fan, or may be composed of a blade fan. It is preferable that the fan 439 can switch between supplying air (also referred to as air blowing) to the inside of the air hole 438 and drawing air from the inside of the air hole 438 according to the rotational direction thereof.

The skin 435 forming the seat cushion 405 is provided with air passing portions 440 at positions overlapping with the openings of the air holes 438. The air passing portion 440 is a part with higher air permeability than other parts of the skin 435, and is preferably made of a mesh-like woven cloth material or the like. In addition, the air passing portion 440 may be configured by providing a plurality of holes penetrating through the skin 435 in the thickness direction.

A cooling unit 441 (cooler) is provided inside each air hole 438 of the seat cushion 405. The cooling unit 441 is composed of a Peltier device 442. However, the cooling unit 441 is not limited to one composed of a Peltier device 442, and may be composed of, for example, a cooling device that performs cooling by circulating a predetermined medium in a tube.

When the fan 439 sends air into the air hole 438, the air is sent through the air passing portion 440 and the air hole 438 toward the thighs of the seated occupant positioned above the seat cushion 405. At this time, the fan 439 functions as an air blower that sends air to the seated occupant. When the fan 439 draws air from inside the air hole 438 to a lower part of the seat cushion 405, the air is drawn from the vicinity of the thigh located above the seat cushion 405 via the air passing portion 440 and the air hole 438. At this time, the fan 439 functions as an air puller that draws air from the seat surface 408.

The upper surface (seat surface 408) of the seat cushion 405 is provided with the air passing portion 440 and the air hole 438 for sending air to the upper side of the seat cushion 405 and for drawing air (that is, ventilating the upper side of the seat cushion 405). In this embodiment, the seat surface 408 is formed with a pair of air openings 445 on either side part.

The front end part of the left air hole 418 provided in the seat back 406 and the upper end part of the right air hole 438 provided in the seat cushion 405 extend along the axis X. In other words, the left air opening 425 provided in the seat back 406 and the right air opening 445 of the seat cushion 405 face each other. The right air hole 418 provided in the seat back 406 and the left air hole 438 provided in the seat cushion 405 extend along the axis Y. In other words, the right air opening 425 provided in the seat back 406 and the left air opening 445 provided in the seat cushion 405 face each other.

In the present embodiment, the extending direction of the front end portion of the air hole 418 of the seat back 406 and the extending direction of the upper end portion of the air hole 438 of the seat cushion 405 are determined in the state of the seat 401 where nobody is seated. However, the extending direction may also be based on the state of the seat 401 where a person having a standard build is seated.

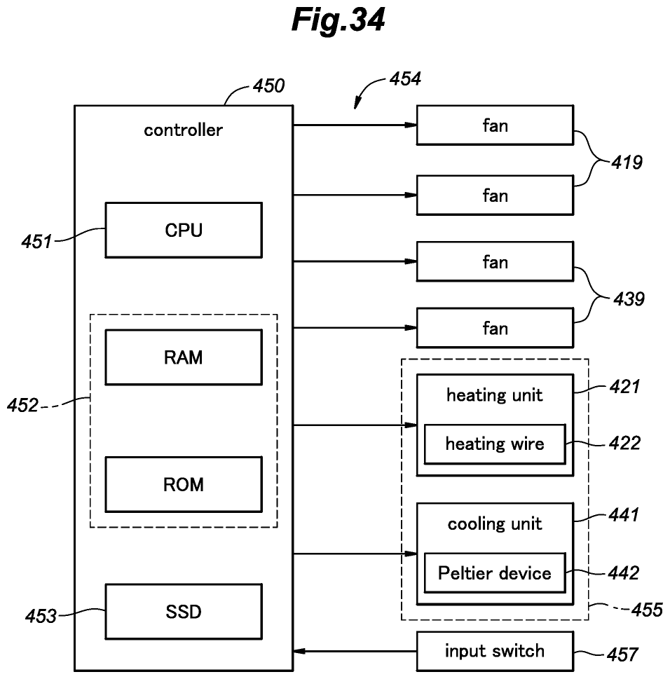

The seat 401 is provided with a controller 450 that controls the two fans 419 provided on the seat back 406 and the two fans 439 provided on the seat cushion 405. As shown in FIG. 34, the controller 450 includes a processor 451 such as a central processing unit (CPU), memory 452 such as a volatile memory (RAM) or a nonvolatile memory (ROM), and a storage device 453 such as a hard disk drive (HDD) and an SSD (solid state drive). The controller 450 may be provided on the back surface of the seat back 406 or the bottom surface of the seat cushion 405, or may be provided inside the seat back 406 or the seat cushion 405. In this embodiment, the controller 450 is provided on the lower surface of the seat cushion 405 at a position that does not overlap with the fans 439 or the air holes 438.

The controller 450 drives the fans 419 and 439 provided on one of the seat cushion 405 and the seat back 406 to send air out of the corresponding air openings 425, 445. At the same time, the controller 450 drives the fans 419 and 439 provided on the other of the seat cushion 405 and the seat back 406 to draw air from the air openings 425 and 445. As a result, an air current is created that flows between the vicinity of the upper half of the body and the vicinity of the lower half of the seated occupant's body on the front surface of the seat 401. In other words, the air openings 425 and 445, the fans 419 and 439 and the controller 450 constitute an airflow generation unit 454 (airflow generation device) that generates an airflow in front of the seat 401.

The controller 450 is connected to the heating unit 421 and the cooling unit 441 and can control the operation of the heating unit 421 and the cooling unit 441.

In this embodiment, an armrest 456 is provided on a lateral side of the seat back 406. An input device 458 including at least one input switch 457 is provided on the upper surface of the armrest 456. The controller 450 (processor 451) controls the fans 419 and 439, the heating unit 421 and the cooling unit 441 by executing a predetermined program based on the input to the input device 458. In this embodiment, the input switch 457 is configured as, for example, a touch panel, a membrane switch, or the like, and can receive inputs corresponding to the heating and cooling processes. The controller 450 performs a heating process upon detecting an input corresponding to heating, and performs a cooling process upon detecting an input corresponding to cooling.

In the cooling process, the controller 450 drives the cooling unit 441 and also drives the fan 439 of the seat cushion 405 to send out air from the air opening 445 provided in the seat cushion 405. At this time, the air sent out from the air opening 445 provided in the seat cushion 405 is cooled by the cooling unit 441 and becomes cool air. At the same time, the controller 450 drives the fan 419 of the seat back 406 to draw air from the air opening 425 provided in the seat back 406.

In the heating process, the controller 450 drives the heating unit 421 and drives the fan 419 of the seat back 406 to send out air from the air opening 425 provided in the seat back 406. At this time, the air sent out from the air opening 425 provided in the seat back 406 is heated by the heating unit 421 to become warm air. At the same time, the controller 450 drives the fan 439 of the seat cushion 405 to draw air from the air opening 445 provided in the seat cushion 405.

Thus, the heating unit 421 and the cooling unit 441 constitute a temperature control unit 455 for controlling the temperature of the air sent out from the air openings 425 and 445.

Next, a method for manufacturing the seat 401 configured in this manner will be described in the following. An operator who assembles the seat 401 first prepares the frame of the seat 401 including the seat back frame 413 and the seat cushion frame 433, places the pads 414 and 434 on the seat back frame 413 and the seat cushion 405, respectively. After that, the operator installs the fan 419 and the heating unit 421 at corresponding positions in the air hole 418 of the seat back 406, and the fan 439 and the cooling unit 441 at corresponding positions in the air hole 438 of the seat cushion 405. Further, the operator installs the controller 450 on the lower surface of the seat cushion 405 at a position that does not overlap the fan 439 or the air hole 438, and electrically connects the fans 419 and 439, the heating unit 421 and the cooling unit 441 to the controller 450. Thereafter, the worker covers the pads 414 and 434 with the skin 415 and 435 and connects the headrest 407 to the seat back 406 to complete the manufacturing of the seat 401.

Next, the effect of the seat 401 configured in this manner will be discussed in the following.

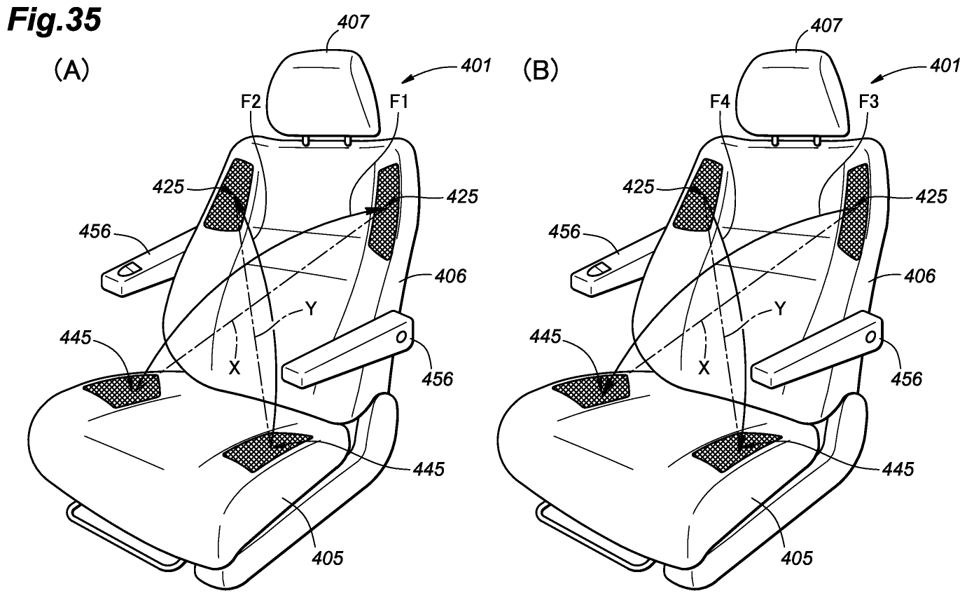

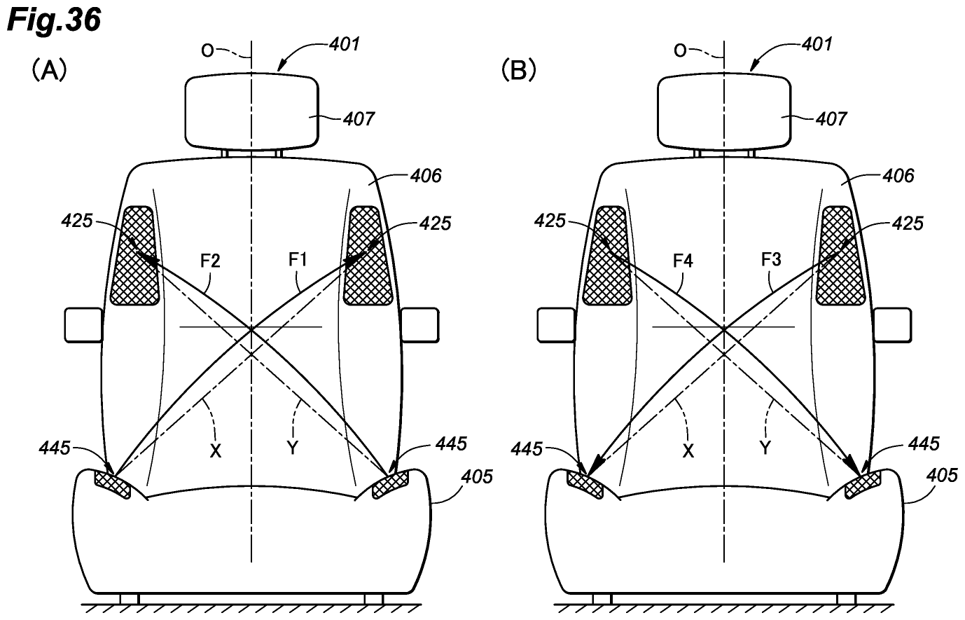

During the cooling process, the air is cooled by the cooling unit 441 and sent out from the air opening 445 provided in the seat cushion 405. Since the upper end portion of the right front air hole 438 provided in the seat cushion 405 extends along the axis X, the direction of the air (blowing direction) from the air opening 445 is generally along the axis X, and is aligned with the air hole 418 of the seat back 406 on the left hand side. Since the fan 419 provided in the seat back 406 is controlled by the controller 450 to draw air from the corresponding air hole 418, as shown in FIGS. 35(A) and 36(A), an airflow F1 consisting of cool air that crosses the center line O of the seat 401 (see FIG. 36(A)) and directed from the lower right to the upper left is generated.

Similarly, since the upper end portion of the left front air hole 438 provided in the seat cushion 405 extends along the axis Y, the direction of the airflow from the air hole 438 is along the axis Y and directed to the air hole 418 on the right side of the seat back 406. Since the fan 419 provided in the seat back 406 is controlled by the controller 450 to draw air from the corresponding air hole 418, as shown in FIGS. 35(A) and 36(A), an airflow F2 consisting of cold air that crosses the center line O of the seat 401 (see FIG. 36A) and directed from the lower left to the upper right is generated. Therefore, during cooling and heating, two airflows F1 and F2 directed each from one of the lower lateral sides of the seat 401 to the other of the upper lateral sides in front view are generated so as to cross the center line O of the seat 401 and collide with each other.

During the heating process, the air is heated by the heating unit 421 and sent out from the air hole 418 provided in the seat back 406. Since the front end portion of the left air hole 418 provided in the seat back 406 extends along the axis X, the direction of the air (blowing direction) therefrom is along the axis X and reaches the right front portion of the seat cushion 405. Since the fan 439 provided in the seat cushion 405 is controlled by the controller 450 to draw air from the corresponding air hole 438, as shown in FIGS. 35(B) and 36(B), an airflow F3 consisting of warm air that crosses the center line O of the seat 401 (see FIG. 36(B)) and is directed from the upper left to the lower right is generated.

Similarly, since the front end portion of the right air hole 418 provided in the seat back 406 extends along the axis Y, the airflow direction therefrom is along the axis Y and directed to the left front air hole 438 of the seat cushion 405. Since the fan 439 provided in the seat cushion 405 is controlled by the controller 450 to draw air from the corresponding air hole 438, as shown in FIGS. 35(B) and 36(B), an airflow F4 consisting of warm air that intersects the center line O of the seat 401 (see FIG. 36(B)) and is directed from the upper right to the lower left is generated. Therefore, during the heating process, the two airflows F3 and F4 each directed from one of the upper lateral sides of the seat 401 to the other of the lower lateral sides in front view are generated so as to cross the center line O of the seat 401 and collide with each other.

In this manner, two airflows F1 to F4 directed in diagonal directions when viewed from the front are generated both during the cooling process and during the heating process. Since the airflows F1 to F4 are formed so as to cross the center line O of the seat 401, they can be effectively blown to the seated occupant. Also, during both the cooling process and the heating process, the two airflows F1 to F4 are formed that are oriented diagonally and envelop the body of the seated occupant. As a result, the region surrounding the seated occupant can be efficiently cooled during the cooling process, and the region surrounding the seated occupant can be efficiently warmed during the heating process. Therefore, the comfort of the seat 401 is enhanced.

During the cooling process, the airflows F1 and F2 are formed so as to face upward from the bottom, so that cold air is less likely to stay in the lower part of the cabin 402. Further, during the heating process, the airflows F3 and F4 are formed so as to be directed from top to bottom, so that the warmed air is less likely to stay in the upper part of the cabin 402. Therefore, cooling and heating efficiency can be improved, and power consumption can be minimized.

Also, the air openings 425 of the seat back 406 are provided in the left and right side portions of the upper front part of the seat back 406, near the shoulders of the seated occupant. Therefore, compared with the case where the air openings 425 are provided in the lower front part of the seat back 406, the air openings 425 are less likely to be blocked by the upper body of the seated occupant. Also, the air openings 445 of the seat cushion 405 are provided in the front portion of the upper surface of the seat cushion 405 (more specifically, on the left and right sides of the front portion of the upper surface). Therefore, compared with the case where the air openings 445 are provided in the rear part of the upper surface of the seat cushion 405, the air openings 445 are less likely to be blocked by the seated occupant's body. Therefore, air pushing/pulling is less likely to be hindered by the body of the seated occupant so that the air pushing/pulling can be performed satisfactorily.

### (Modifications)

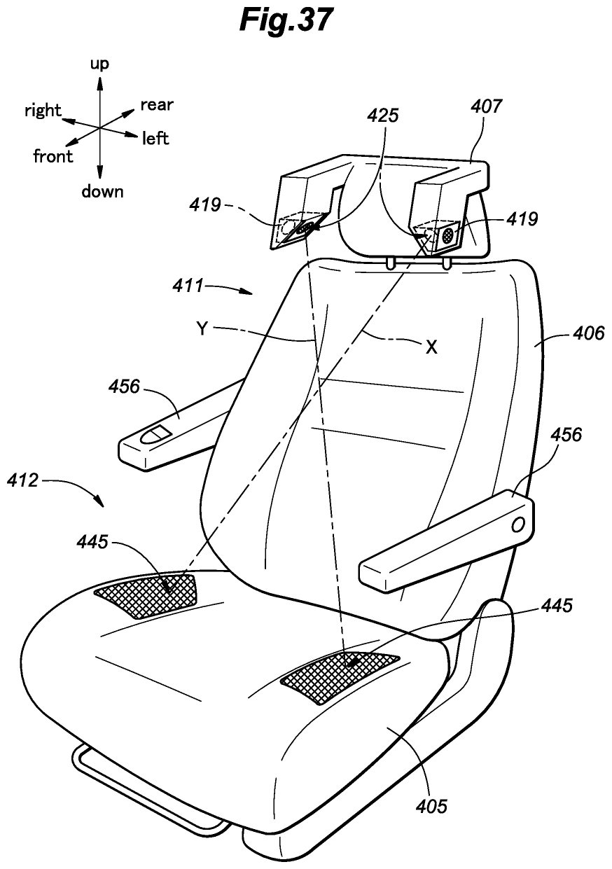

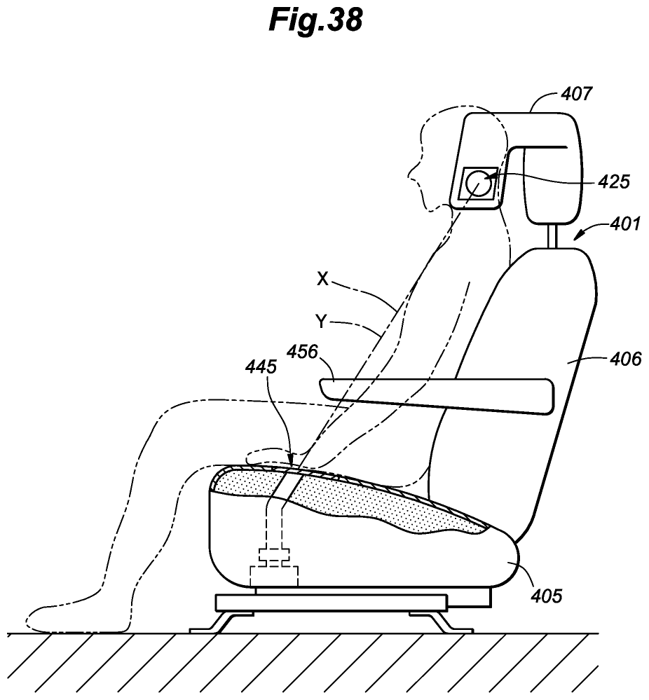

In the above embodiment, the seat back 406 is provided with the air openings 425, but it suffices if the air openings 425 are provided in each of the seat upper part 411 and the seat lower part 412. More specifically, for example, as shown in FIGS. 37 and 38, the air opening 425 may be provided in the headrest 407 instead of the seat back 406. In this case also, as shown in FIG. 38, it is preferable that the air openings 425 provided in the headrest 407 and the air openings 445 provided in the seat cushion 405 are configured to face each other.

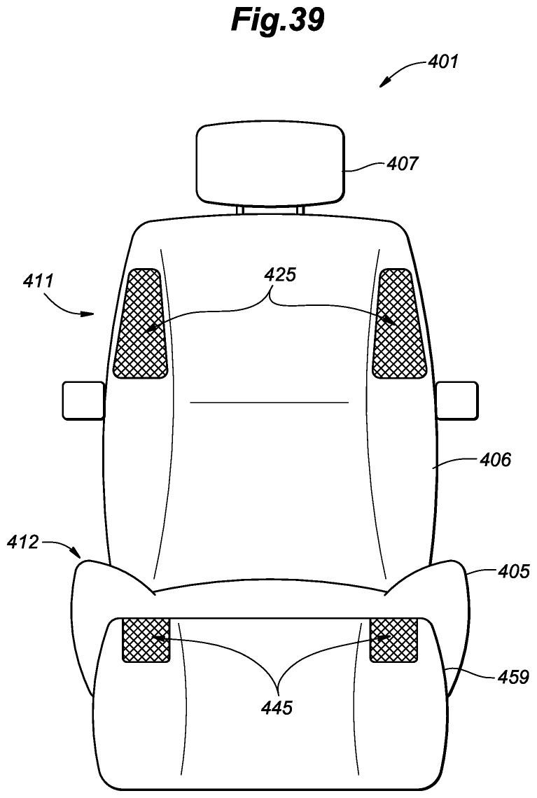

As shown in FIG. 39, an ottoman 459 serving as a footrest may be provided at the front end of the seat cushion 405. The seat cushion 405 and the ottoman 459 constitute a seat lower part 412 that supports the lower body of the seated occupant. In that case, the air openings 445 may be provided at any position of the seat lower part 412. More specifically, the air openings 445 may be provided in the ottoman 459 instead of the seat cushion 405.

When the ottoman 459 is provided with the air openings 445, they may be provided at both left and right edges of the surface of the ottoman 459 facing the seated occupant. When the surface of the ottoman 459 facing the seated occupant is provided with a pair of shoulder parts that protrude toward the seated occupant, the air openings 445 may be provided in the shoulder parts.

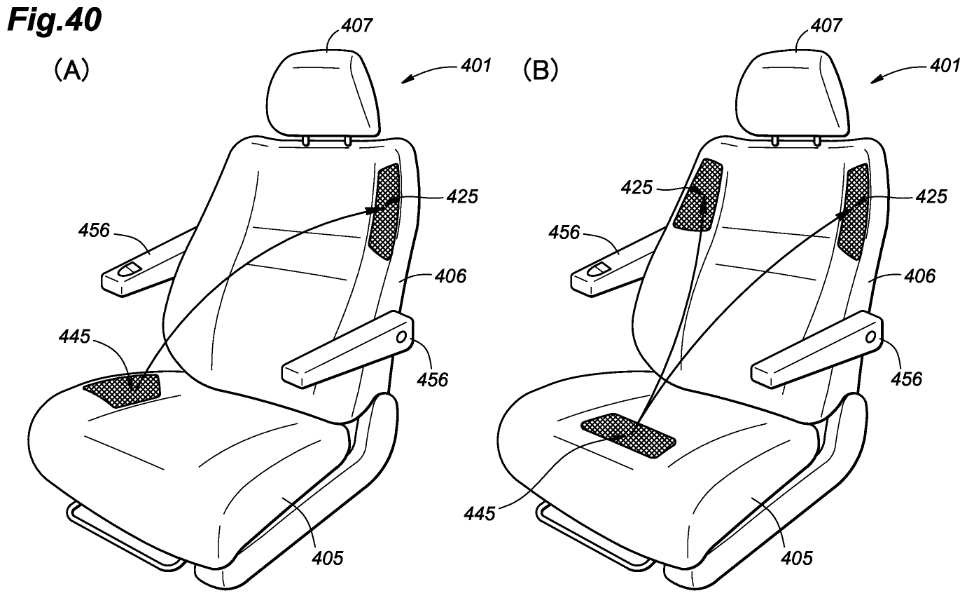

In the above embodiment, the seat upper part 411 (seat back 406) is provided with the air openings 425 on either side, and the seat lower part 412 (seat cushion 405) is provided with air openings 445 on either side. The present invention is not limited to this mode. As shown in FIGS. 40(A) and 40(B), an air opening 425 may be provided in one of the right and left sides of the seat upper part 411 or in a laterally central portion of the seat upper part 411, while another air opening 445 is provided in one of the left and right sides of the seat lower part 412 or in a central portion of the seat lower part 412. As shown in FIG. 40(B), when the air opening 445 is provided in a laterally central portion of the seat cushion 405, the shape (size, width, etc.) of the two air openings 425 of the seat back 406 may be adjusted so that the two air openings 425 may be positioned in the air blowing area.

In the above-described embodiment, the air holes 418 of the seat back 406 and the air holes 438 of the seat cushion 405 are formed so that the end portions thereof extend along the axis X and the axis Y extending in the diagonal direction of the seat 401 when viewed from the front, respectively. However, the present invention is not limited to this mode. The front end portions of the air holes 418 of the seat back 406 and the upper end portions of the air holes 438 of the seat cushion 405 may be formed so as to extend along the axis L and the axis M extending parallel to the center line O of the seat 401 when viewed from the front, respectively.

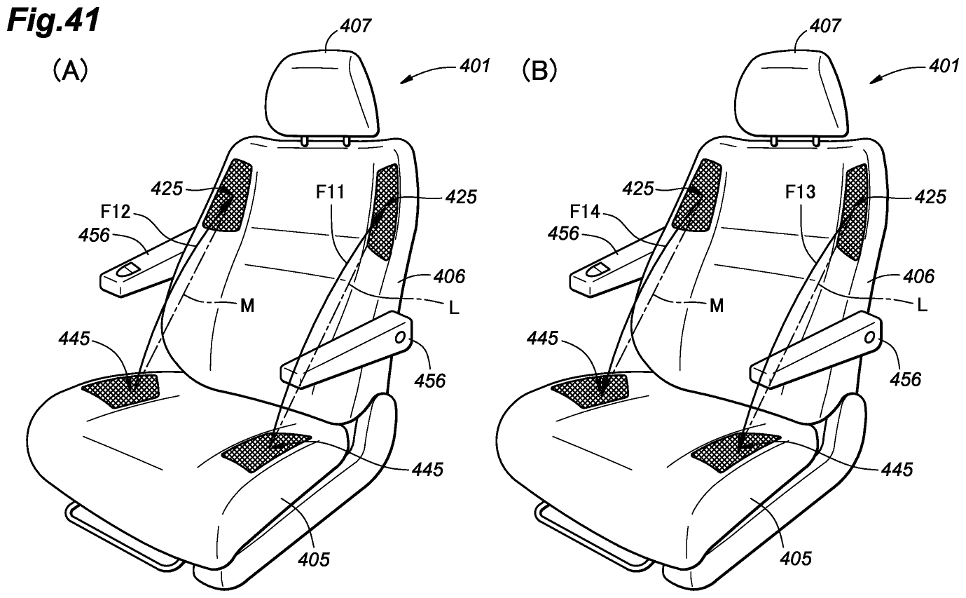

In this case, during the cooling process, as shown in FIG. 41(A), two parallel air flows consisting of a cool airflow F11 directed from the lower left to the upper left and another cool airflow F12 directed from the lower right to the upper right are generated on either side of the center line O of the seat 401 in front view. During the heating process, as shown in FIG. 41(B), two parallel air flows consisting of a warm airflow F13 directed from the upper left to the lower left and another warm airflow F14 directed from the upper right to the lower right are generated on either side of the center line O of the seat 401 in front view.

Thus, the two airflows F11-F14 along the sides of the seated occupant and enveloping the body of the seated occupant are created. Therefore, the surrounding area of the seated occupant can be effectively cooled during the cooling process, and the surrounding area of the seated occupant can be effectively warmed during the heating process. Therefore, the comfort of the seat 401 is enhanced.

However, the present invention is not limited to this aspect. In an alternate aspect, an airflow parallel to the center line O in front view is generated only on one of the left and right sides. In this case as well, since the airflow is generated on one of the left and right sides of the seated occupant, the airflow is favorably blown to the seated occupant than in the case where no airflow is generated.

### Tenth Embodiment

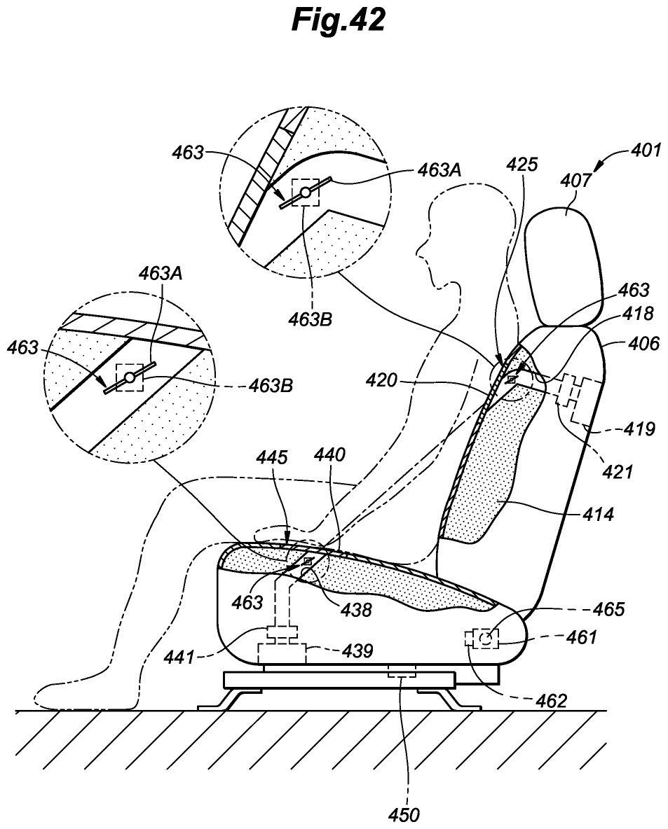

As shown in FIG. 42, the seat 401 according to the tenth embodiment includes a displacement mechanism 461 for changing the position and/or shape of the seat 401, a seat state sensor 462 for detecting the state of the seat 401, and a louver 463 provided in each air hole 418.

The displacement mechanism 461 is provided between the seat back 406 and the seat cushion 405 and includes a reclining device 465 that tilts the seat back 406 with respect to the seat cushion 405. The displacement mechanism 461 may also consist of a device that moves the seat cushion 405 and seat back 406 in the fore and aft direction with respect to the floor 403.

The seat state sensor 462 is an angle sensor that detects the tilt angle (reclining angle) of the seat back 406.

The louver 463 is provided with a plurality of slats 463A arranged in parallel to one another and a motor 463B for changing the angle of the major plane of the slats 463A. A motor 463B is connected to a controller 450. The controller 450 controls the driving of the motor 463B so as to change the angle of the major plane of the slats 463A. In this embodiment, the controller 450 changes the orientation of the slats 463A based on the angle acquired by an angle sensor so that the air blown out from the air hole 418 is directed toward the air hole 438 that draws air.

In the cooling process, the controller 450 controls the louver 463 provided in the air hole 438 in the left front portion of the seat cushion 405 so that the air blowing direction from the air hole 418 in the left front portion of the seat cushion 405 is directed to the air hole 418 on the right side of the seat back 406. In the cooling process, the controller 450 also controls the louver 463 provided in the air hole 438 in the front right portion of the seat cushion 405 so that the air blowing direction from the air hole 438 in the front right portion of the seat cushion 405 is directed toward the air hole 418 on the left side of the seat back 406.

In the heating process, the controller 450 controls the louver 463 provided in the left air hole 418 of the seat back 406 so that the direction of air blowing from the left air hole 418 of the seat back 406 is directed to the air hole 438 on the right front part of the seat cushion 405. In the heating process, the controller 450 also controls the louver 463 provided in the right air hole 418 of the seat back 406 so that the direction of the air blowing from the right air hole 418 of the seat back 406 is directed to the air hole 438 on the left front part of the seat cushion 405.

Next, the effect of the seat 401 configured in this manner will be discussed in the following. The controller 450 controls the louvers 463 of the air openings 425 and 445 through which air is blown toward the seated occupant so that the direction of the air blow is directed to the air openings 425 and 445 through which air is drawn. Therefore, two air currents can be favorably generated in the vicinity of the seated occupant.

### (Modification)

When the controller 450 detects that the reclining angle detected by the seat state sensor 462 is equal to or greater than a predetermined threshold during at least one of the heating process and the cooling process, the fans 419 and 439 may be controlled so as to stop the air intake from the air openings 425 and 445, and only blow air from the air opening 445. The threshold value may be set based on the range of the reclining angle which allows the airflow to be directed to the air openings 425 and 445 by the control of the louvers 463. As a result, the fans 419 and 439 for drawing air are stopped when the seat back 406 is in the relax mode in which the seat back 406 is tilted backward from the normal position and it is difficult to generate the airflow. Thereby, power consumption can be reduced.

The seat state sensor 462 is not limited to a sensor that detects the reclining angle. For example, the seat state sensor 462 may be configured to detect the presence or absence of displacement of the seat 401 with respect to the floor 403. The displacement of the seat 401 can include, for example, the fore and aft movement, lateral movement, rotation, reclining movement, height adjustment (vertical movement of the seat cushion 405 with respect to the floor 403), and tilt movement (angular movement of the seat cushion 405 with respect to the floor 403). Alternatively, the seat state sensor 462 may detect the presence or absence of displacement of a part of the seat 401 (for example, the armrest 456).

At this time, the controller 450 may be configured to control at least one of the fans 419 and 439, the cooling unit 441, and the heating unit 421 based on the presence or absence of the displacement detected by the seat state sensor 462. More specifically, the controller 450 may be configured to interrupt (or prohibit) the cooling process or the heating process when the seat state sensor 462 detects the displacement of the seat 401. As a result, when the seat 401 is being displaced, consumption of electric power can be avoided by stopping (prohibiting) the driving of the air conditioning devices such as the fans 419 and 439, the cooling unit 441, and the heating unit 421.

When a plurality of air openings 425 and 445 are provided in the seat upper part 411 and the seat lower part 412, the controller 450 may be configured to select the air openings 425 and 445 for air blowing or air drawing based on the detection result of the seat state sensor 462. For example, when the seat 401 is rotatable about a vertically extending axis with respect to the floor 403, the controller 450 may select the air openings 425, 445 for air blowing or air drawing based on the rotational angle of the seat 401 with respect to the longitudinal direction of the vehicle.

In the heating process and the cooling process, the controller 450 may control the fans 419, 439 to generate only the airflow directed toward the outside of the vehicle, out of the two airflows flowing in the diagonal directions, depending on the rotational angle detected by the seat state sensor 462. As a result, an airflow that is not likely to affect the seated occupant on the adjacent seat 401 can be generated.

More specifically, in the heating process and the cooling process, the controller 450 may select only one of the left and right air openings 425 of the seat back 406 and a corresponding one of the left and right air openings 445 of the seat cushion 405 to generate an airflow directed only to the outer side of the vehicle. In that case, the controller 450 may be configured to replace (reverse) the selection when the rotational angle detected by the seat state sensor 462 is equal to or greater than a threshold.

### Eleventh Embodiment

The seat 401 according to the eleventh embodiment differs from the ninth embodiment in being equipped with an occupant sensor 470 that acquires information about the occupant and operating the cooling unit 441 and the heating unit 421 according to detection result of the occupant sensor 470, but is otherwise similar in structure to that of the ninth embodiment. Therefore, description of other features is omitted in the following description.

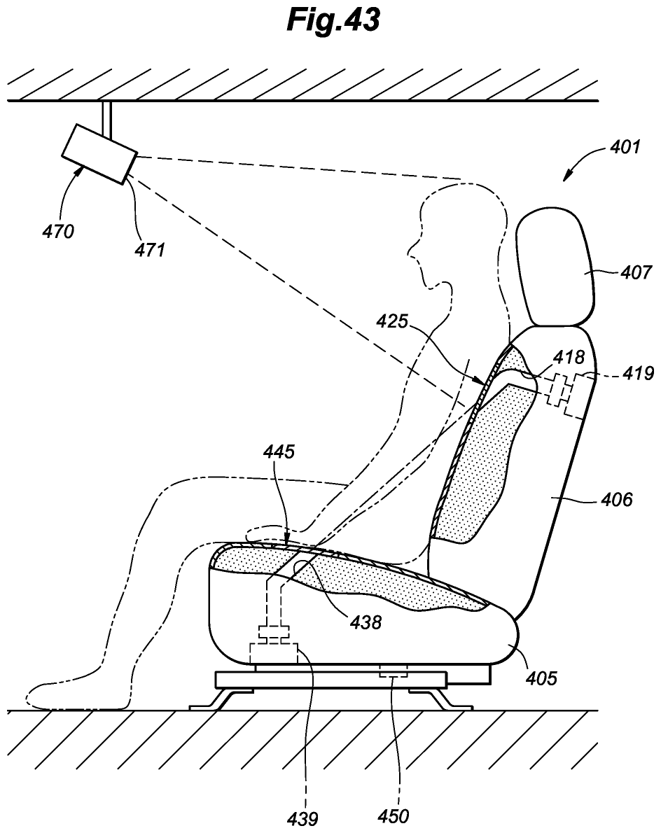

In this embodiment, as shown in FIG. 43, the seat occupant sensor 470 is provided in front of the seat back 406 and is composed of a camera 471 that acquires the image of the seated occupant. FIG. 43 shows an example in which the camera 471 is coupled to and supported by the ceiling (roof) that defines the upper edge of the cabin 402, but the mode of mounting the camera 471 is not limited to this aspect. For instance, the camera 471 may be coupled to and supported by the seat back 406 or the headrest 407. Based on the image (image) acquired by the seat occupant sensor 470, the controller 450 may estimate the characteristics, motions, states, etc. of the seated occupant, and controls the fans 419, 439 based on the estimated characteristics, motions, states, etc., may control the driving of the cooling unit 441 and the heating unit 421.

In a certain embodiment, the controller 450 estimates the gender of the occupant based on images acquired by the occupant sensor 470. The controller 450 sets the rotational speed of the fans 419 and 439 based on the estimated gender of the seated occupant. The controller 450 is configured to reduce the rotational speed of the fans 419 and 439 in the cooling process when the gender of the seated occupant is estimated to be female. In addition, in the cooling process, when the gender of the seated occupant is estimated to be female, the controller 450 lowers the intensity of the cooling unit 441 and slightly increases the temperature of the air that is produced (weaken the cooling action) as compared to other cases.

Next, the effect of the seat 401 configured in this manner will be discussed in the following. The controller 450 controls the operation of the fans 419 and 439, the cooling unit 441 and the heating unit 421 based on the information regarding the seated occupant acquired by the seat occupant sensor 470. Therefore, it is possible to appropriately set the temperature based on the characteristics, motions, conditions, etc., of the seated occupant, and to generate an airflow that suits the characteristics, motions, conditions, etc., of the seated occupant.

In the above embodiment, the controller 450 is configured to reduce the rotational speed of the fans 419 and 439 in the cooling process when the gender of the seated occupant is estimated to be female. This prevents the seated occupant from feeling cold while the cooling process is being performed.

### (Modification)

The embodiment described above consisted of a case in which the occupant sensor 470 is configured as a camera 471 that detects the image of the occupant, but the present invention is not limited to this aspect. When the seat 401 constitutes the driver's seat, the occupant sensor 470 may be configured as a sensor that detects the driving operation of the driver (driving detection). The driving operation detected by the seat occupant sensor 470 may include the presence or absence of operation of the accelerator pedal, the brake pedal, or the steering wheel.

The controller 450 may be configured to increase the rotational speed of the fans 419 and 439 when the seat occupant sensor 470 detects that a driving operation is being performed during the cooling process. As a result, the flow velocity of the cooled airflow generated around the seated occupant can be increased so that the mental concentration of the seated occupant can be increased. At this time, the controller 450 may be configured to acquire information regarding the driving operation from a travel controller (computer) that controls the traveling mode of the vehicle, and based on the acquired information, detect the presence or absence of the driver's driving operation.

The controller 450 may determine if the seated occupant is driving or not based on the presence or absence of the driving operation detected by the seat occupant sensor 470. The controller 450 may select the air openings 425 and 445 for air blowing and air drawing based on the determination result. Further, the controller 450 may set the temperature of the blown air and control the driving of the cooling unit 441 and the heating unit 421 so as to achieve the set temperature based on the determination result.

The controller 450 may set the temperature of the blown air to be lower when the seated occupant is driving than when the seated occupant is not driving (for example, during rest). Thereby, the seated occupant can be warmed while preventing the metal concentration of the seated occupant from dropping.

Further, in the heating process, when the controller 450 determines that the seated occupant is driving based on the detection result of the seat occupant sensor 470, the airflow direction from the air opening 445 is slightly shifted toward the lower body (more toward the side of the feet than toward the side of the upper body). In addition, when the controller 450 determines in the heating process that the seated occupant is performing driving operation, the controller 450 may be configured to control the fan 439 and cooling unit 441 such that warm air is blown from the air opening 445 provided in the ottoman 459 when the seated occupant is driving and warm air is blown from the air opening 445 provided in the seat cushion 405 when the seated occupant is not driving. Thereby, warm air can be blown to a part of the seated occupant remote from the head of the seated occupant so that the seated occupant can be warmed while preventing a drop in the metal concentration of the seated occupant.

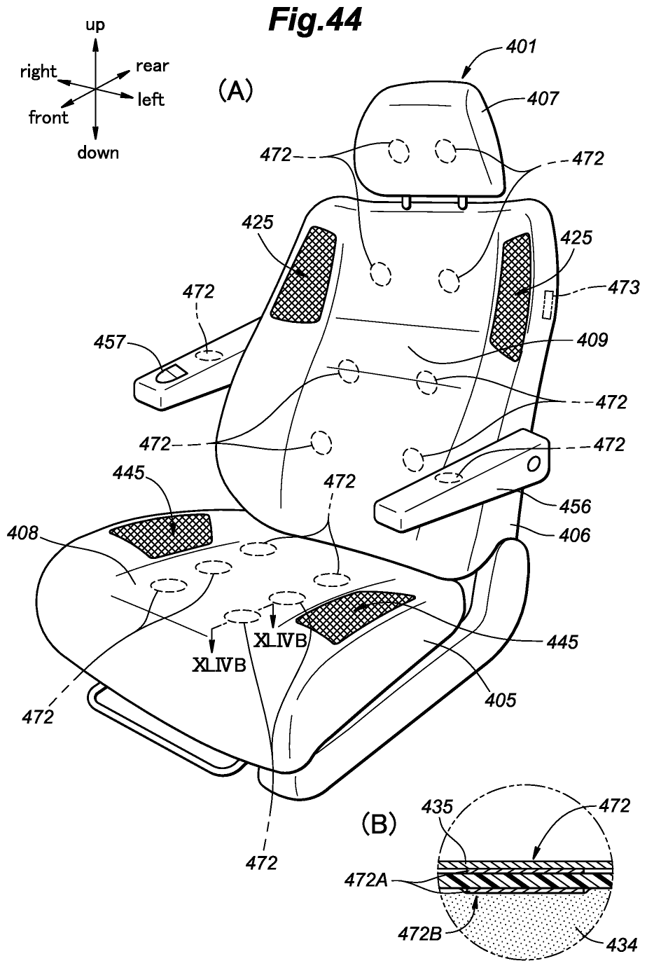

The seat occupant sensor 470 may consist of one or more pressure sensors 472 that are provided on the seat 401 and configured to detect the pressure of the corresponding portions (hereinafter referred to as the detection unit). As shown in FIG. 44(A), the pressure sensors 472 (more specifically, detection units for detecting pressure) are provided at suitable locations on the seat back 406 and the seat cushion 405, avoiding the air openings 425 and 445. The pressure sensors 472 (more specifically, the electrode plates each serving as a detection unit) may be provided on the seat surface 408 or the backrest surface 409 of the seat 401 at positions other than the air openings 425 and 445. As shown in the enlarged cross sectional view of FIG. 44(B), each pressure sensor 472 includes, for example, a pair of disc-shaped metal thin films 472A (electrode plates) serving as a detection unit. It may be formed by a capacitance sensor 472B in which the capacitance between the metal thin films 472A changes in dependence on the pressure applied thereto. Moreover, the pressure sensor 472 may be a sensor in which the resistance value between the metal thin films 472A changes in dependence on the pressure applied thereto.

The controller 450 may be configured to determine the presence or absence of a seated occupant based on the pressure detected by the seat occupant sensor 470 (pressure sensor 472), and permits the execution of the cooling process or the heating process when it is determined that there is a seated occupant.

For example, the seat 401 is provided with a temperature sensor 473 that detects the temperature inside the vehicle (the temperature inside the vehicle cabin 402), and the controller 450 is configured to execute the cooling process when the temperature detected by the temperature sensor 473 is equal to or higher than a predetermined threshold and the pressure detected by the seating sensor is equal to or higher than a predetermined threshold.

The seat occupant sensor 470 may include a plurality of pressure sensors 472, and the controller 450 may be configured to acquire the distribution of the pressure applied to the seat surface 408 and the backrest surface 409 based on the pressure detected by the pressure sensors 472 and estimate the build and posture of the seated occupant according to the acquired pressure distribution. When the seat upper part 411 and the seat lower part 412 are provided with a plurality of air openings 425 and 445, the controller 450 may select the air openings for supplying and drawing air and operate the fans 419, 439 corresponding to the selected air openings 425, 445 according to the estimated build and posture of the seated occupant.

The seat occupant sensor 470 may be configured as a pressure sensor 472, a radio wave sensor, or the like that acquires biological information of the seated occupant such as a heart rate, pulse, and blood pressure. The controller 450 may be configured to estimate the physical condition of the seated occupant based on the biological information acquired by the seat occupant sensor, and control at least one of the fans 419 and 439, the cooling unit 441, and the heating unit 421 according to the estimated physical condition.

The controller 450 may determine the presence or absence of motion sickness of the seated occupant based on the biological information acquired by the seat sensor. The controller 450 may determine the presence or absence of motion sickness of the seated occupant based on the image of the seated occupant acquired by the camera 471. The controller 450 preferably increases the rotational speed of the fans 419 and 439 and the intensity of the heating unit 421 when motion thickness is detected as compared to the case where no motion sickness is detected. As a result, the surrounding environment of the seated occupant can be further cooled when motion sickness is detected so that the symptoms of motion sickness can be alleviated.

The controller 450 may acquire the alertness level of the seated occupant based on the biological information acquired by the seat sensor and the image of the seated occupant acquired by the camera 471. When the alertness level is lower than a predetermined value, the controller 450 may reduce the rotational speed of the fans 419 and 439 to reduce the amount of air supply or the amount of air drawing. In addition, when the alertness level is lower than a predetermined value, the controller 450 may set the air openings 425 and 445 for supplying air closer to the feet of the seated occupant than when the alertness level is equal to or higher than the predetermined value, and operate the corresponding fans 419 and 439.

Although the specific embodiments of the seat 401 have been described above, the present invention can be widely modified without being limited to the above embodiments. In the ninth to eleventh embodiments, the temperature control unit 455 includes both the heating unit 421 and the cooling unit 441, but is not limited to this aspect. The temperature control unit 455 may include at least one of the heating unit 421 and the cooling unit 441, and may have any configuration as long as it is capable of adjusting the temperature of the air to be blown out.

In the above embodiment, the airflow is generated in the diagonal direction in front view during both the cooling process and the heating process, or the airflow is generated in the direction parallel to the center line O in front view during both the cooling process and the heating process, but the present invention is not limited to these examples. For instance, the airflow may be generated in the diagonal direction in front view during one of the cooling process and the heating process, and an airflow may be generated in a direction parallel to the center line O in front view during the other. For example, by controlling the louver 463, the controller 450 may generate the airflow F1 and F2 in the diagonal direction with respect to the center line O of the seat 401 in front view during the cooling process, and the parallel airflow F13, F14 with respect to the centerline O of the seat 401 in front view during heating process. In addition, the controller 450 may change the direction of the airflow (for example, from the diagonal direction to the parallel direction) upon elapsing a certain time period after the start of the cooling process (or the heating process).

At this time, the slats 463A are preferably supported by the seat back frame 413 and the seat cushion frame 433 so as to be rotatable about axes extending in the vertical direction and the horizontal direction, respectively. As a result, the louver 463 can adjust the direction of the air blown in the vertical direction and the horizontal direction, and can switch the airflow between the diagonal direction and the parallel direction with respect to the center line O.

In the examples of the ninth to eleventh embodiments, the seat 401 provided in a passenger vehicle such as a four-wheeled vehicle is described, but the present invention is not limited to this aspect. The present invention can also be applied to seats 401 mounted on vehicles such as buses, trucks, ships, railroad cars, and airplanes.

### REFERENCE NUMERALS

2 seat
3 seat main body
6a-6c drive device
7a-7p sensor
9 controller
10 seat cushion
11 seat back
12 headrest
16 skin
16a detection light hole
17a proximity detection unit
17b contact detection unit

1. A vehicle seat, comprising:
a seat main body;
a drive device for moving the seat main body;
a sensor provided in the seat main body to detect approach and contact of an object; and
a controller for stopping a movement of the seat main body caused by the drive device when approach or contact of an object is detected by the sensor.

2. The vehicle seat according to claim 1, wherein the controller controls the drive device in such a manner that when the sensor detects that a distance to the object has come to be a predetermined first distance while the drive device is moving the seat main body, the controller reduces a moving speed of the seat main body caused by the drive device, and stops a movement of the seat main body when the sensor has detected that the distance to the object has come to be a second distance smaller than the first distance.

3. The vehicle seat according to claim 1, wherein the controller is configured to reduce a moving speed of the seat main body by the drive device when the sensor detects an approach of an object thereto while the drive device is moving the seat main body and stops a movement of the seat main body by the drive device when the sensor detects contact of the object thereto.

4. The vehicle seat according to claim 1, wherein the seat main body includes a skin exposed to outside and having a detection light hole formed in a part thereof, and the sensor is provided on a back side of the skin so that the sensor emits detection light via the detection light hole and receives the detection light that is reflected by the object and has come back via the detection light hole to detect approach of the object.

5. The vehicle seat according to claim 1, wherein the seat main body includes a skin exposed to outside, and the sensor is positioned behind the skin so as to emit detection radio wave to the outside of the skin through the skin and receive the detection radio wave reflected by the object and coming back via the skin to detect approach of the object.

6. The vehicle seat according to claim 1, wherein the sensor includes a plurality of proximity detection units arranged in a row each configured to detect approach of an object, and a plurality of contact detection units provided integrally with the corresponding proximity detection units to detect contact of an object.

7. The vehicle seat according to claim 1, wherein the sensor includes a plurality of proximity detection units arranged in a single row each configured to detect approach of an object and a contact detection unit retaining the proximity detection units together and configured to detect contact of an object.

8. The vehicle seat according to claim 1, wherein the seat main body includes:
a seat cushion,
a seat back provided pivotably in a rear part of the seat cushion and
a headrest provided at an upper part of the seat back, and
wherein the drive device is configured to move the seat cushion in a fore and aft direction while the sensor is provided in at least one of a lower part of the seat cushion, a rear end part of the seat cushion, and a rear part of the seat back,
the controller being configured to stop a rearward movement of the seat cushion caused by the drive device when approach or contact of an object is detected by the sensor.

9. The vehicle seat according to claim 1, wherein the seat main body includes:
a seat cushion,
a seat back provided pivotably in a rear part of the seat cushion and
a headrest provided at an upper part of the seat back,
wherein the drive device is configured to rotate the seat cushion, the sensor is provided in at least one of a corner of the seat cushion, a side of the seat cushion and a shoulder part of the seat back, and the controller is configured to stop a rotational movement of the seat cushion caused by the drive device when approach or contact of an object is detected by the sensor.

10. The vehicle seat according to claim 1, wherein the seat main body includes:
a seat cushion,
a seat back provided pivotably in a rear part of the seat cushion and
a headrest provided in an upper part of the seat back, and
wherein the drive device is configured to pivot the seat back relative to the seat cushion, the sensor is provided in at least one of a lower part of the seat cushion, a rear end part of the seat cushion, a rear part of the seat back and a rear part of the headrest, and the controller is configured to stop a rearward movement of the seat back caused by the drive device when approach or contact of an object is detected by the sensor.

11. The vehicle seat according to claim 1, wherein the seat main body includes:
a seat cushion,
a seat back provided pivotably in a rear part of the seat cushion and
a headrest provided in an upper part of the seat back, and
wherein the drive device is configured to move the seat cushion laterally, the sensor is provided in at least one of a lower part of the seat cushion, a side part of the seat cushion, a side part of the seat back and a side part of the headrest, and the controller is configured to stop a lateral movement of the seat back caused by the drive device when approach or contact of an object is detected by the sensor.
